(19) United States
(12) Patent Application Publication
(10) Pub. No.: US 2024/0152256 A1
(43) Pub. Date: May 9, 2024

(54) Devices, Methods, and Graphical User Interfaces for Tabbed Browsing in Three-Dimensional Environments

(71) Applicant: Apple Inc., Cupertino, CA (US)

(72) Inventors: Jonathan R. Dascola, San Francisco, CA (US); Nathan Gitter, Cupertino, CA (US); Jay Moon, San Francisco, CA (US); Stephen O. Lemay, Palo Alto, CA (US); Joseph M.W. Luxton, San Francisco, CA (US); Angel Suet Y. Cheung, San Francisco, CA (US); Danielle M. Price, Los Gatos, CA (US); Hugo D. Verweij, Portola Valley, CA (US); Kristi E.S. Bauerly, Los Altos, CA (US); Katherine W. Kolombatovich, San Francisco, CA (US); Jordan A. Cazamias, San Francico, CA (US)

(21) Appl. No.: 18/369,635

(22) Filed: Sep. 18, 2023

Related U.S. Application Data
(60) Provisional application No. 63/469,794, filed on May 30, 2023.
(60) Provisional application No. 63/409,747, filed on Sep. 24, 2022.

(51) Int. Cl. G06F 3/0483; G06F 3/01; G06F 3/04815

(52) U.S. Cl. CPC G06F 3/0483; G06F 3/013; G06F 3/017; G06F 3/04815

(57) ABSTRACT

A computer system concurrently displays, via a display generation component, a browser toolbar, for a browser that includes a plurality of tabs and a window including first content associated with a first tab of the plurality of tabs. The browser toolbar and the window are overlaying a view of a three-dimensional environment. While displaying the browser toolbar and the window that includes the first content overlaying the view of the three-dimensional environment, the computer system detects a first air gesture that meets first gesture criteria, the air gesture comprising a gaze input directed at a location in the view of the three-dimensional environment that is occupied by the browser toolbar and a hand movement. In response to detecting the first air gesture that meets the first gesture criteria, the computer system displays second content in the window, the second content associated with a second tab of the plurality of tabs.

### RELATED APPLICATIONS

This application claims priority to U.S. Provisional Application 63/469,794, filed May 30, 2023, and U.S. Provisional Application 63/409,747, filed Sep. 24, 2022, each of which is hereby incorporated by reference in its entirety.

### TECHNICAL FIELD

The present disclosure relates generally to computer systems that are in communication with a display generation component and, optionally, one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Methods and interfaces for browsing the Web or other content in a three-dimensional environment that includes at least some virtual elements (e.g., applications, augmented reality environments, mixed reality environments, and virtual reality environments) are cumbersome, inefficient, and limited. For example, browser applications in the three-dimensional environments require a series of inputs navigating complex menu options using physical equipment, such as remote controllers. Such systems provide insufficient feedback and are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for tabbed browsing that make interaction with browser applications in three-dimensional environments more efficient and intuitive for a user. Such methods and interfaces optionally complement or replace conventional methods for tabbed browsing. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

In accordance with some embodiments, a method is performed at a computer system that is in communication with a display generation component and one or more input devices. The method includes concurrently displaying, via the display generation component, a browser toolbar, for a browser that includes a plurality of tabs, and a window including first content associated with a first tab of the plurality of tabs. The browser toolbar and the window are overlaying a view of a three-dimensional environment. The method includes, while displaying the browser toolbar and the window that includes the first content overlaying the view of the three-dimensional environment, detecting a first air gesture that meets first gesture criteria, the first air gesture comprising a gaze input directed at a location in the view of the three-dimensional environment that is occupied by the browser toolbar and a hand movement. The method includes, in response to detecting the first air gesture that meets the first gesture criteria, displaying second content in the window, the second content associated with a second tab of the plurality of tabs.

In accordance with some embodiments, a method is performed at a computer system that is in communication with a display generation component and one or more input devices. The method includes concurrently displaying a browser toolbar at a first distance from a viewpoint of a user and a window including first content at a second distance from the viewpoint of the user. The first distance has a respective difference in depth from the second distance; the respective difference in depth is greater than zero; the browser toolbar and the window are overlaying a view of a three-dimensional environment; and the browser toolbar and the window are associated with a browser application. The method includes receiving, via the one or more input devices, an input corresponding to a request to change content in the window and, in response to receiving the input corresponding to the request to change content in the window, changing content displayed in the window from the first content to second content different from the first content while continuing to display the browser toolbar and the window overlaid on the view of the three-dimensional environment. The respective difference in depth between the browser toolbar and the window before and after the change in content in the window from the first content to the second content are the same.

In accordance with some embodiments, a method is performed at a computer system that is in communication with a display generation component and one or more input devices. The method includes displaying, via the display generation component, a first content item of a plurality of content items. The first content item is overlaying a view of a three-dimensional environment. The method includes, while the first content item is an active content item for an application, detecting a first air gesture that includes movement of a hand in a respective direction along a first axis of movement that is perpendicular to a second axis of movement away from a viewpoint of the user. The method includes, in response to detecting the first air gesture, in accordance with a determination that the first air gesture included movement of the hand in a direction along the second axis of movement that met respective criteria prior to detecting the movement of the hand in the respective direction along the first axis of movement, switching from the first content item being the active content item for the application to a second content item of the plurality of content items being the active content item for the application.

In accordance with some embodiments, a method is performed at a computer system that is in communication with a display generation component and one or more input devices. The method includes, while a view of a three-dimensional environment is visible via the display generation component, displaying a first content item of a plurality of content items at a first size in a first region in the view of the three-dimensional environment. The method includes, while the first content item is displayed in the first region at the first size, detecting a first gesture. The method includes, in response to detecting the first gesture: concurrently displaying the first content item and a first set of one or more content items of the plurality of content items, wherein the first content item and the first set of one or more content items are displayed as reduced scale representations; and visually deemphasizing one or more portions of the view of the three-dimensional environment, wherein the one or more portions of the view of the three-dimensional environment that are visually deemphasized are visible concurrently with the first content item and the first set of one or more content items.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7M3 illustrate example techniques for switching between tabbed windows in a three-dimensional environment, in accordance with some embodiments.

FIGS. 7A-7M3 illustrate example techniques for spatially positioning a browser toolbar while interacting with a browser application in a three-dimensional environment, in accordance with some embodiments.

FIGS. 7F-7H illustrate example techniques for viewing an overview of multiple content items of the same kind in a three-dimensional environment, in accordance with some embodiments.

FIGS. 7N-7Y3 illustrate example techniques for quick switching between tabbed windows in a three-dimensional environment, in accordance with some embodiments.

FIGS. 7N-7Y3 illustrate example techniques for viewing an overview of multiple content items of the same kind in a three-dimensional environment while reducing visual prominence of remaining portions of the view of the three-dimensional environment, in accordance with some embodiments.

FIG. 8 is a flow diagram of methods of switching between tabbed windows in a three-dimensional environment, in accordance with various embodiments.

FIG. 9 is a flow diagram of methods of spatially positioning a browser toolbar relative to a browser application in a three-dimensional environment, in accordance with various embodiments.

FIG. 10 is a flow diagram of methods of quick switching between tabbed windows in a three-dimensional environment, in accordance with various embodiments.

FIG. 11 is a flow diagram of methods of viewing an overview of multiple content items of the same kind in a three-dimensional environment while reducing visual prominence of remaining portions of the view of the three-dimensional environment, in accordance with various embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system allows a user to switch between tabbed windows in a three-dimensional environment (e.g., a virtual or mixed reality environment) in response to detecting an air gesture. A tab of interest is selected in response to a direct or indirect air gesture detected using cameras, e.g., as opposed to touch-sensitive surfaces or other physical controllers. For example, a tab of interest in a browser toolbar, for a browser application, is selected in response to a gaze input directed at the tab of interest in conjunction with an air pinch gesture (e.g., bringing into contact an index finger and a thumb finger), where the gaze input puts the tab of interest into focus and the air pinch gesture performs the selection. The browser toolbar includes tabs that correspond to tabbed windows (e.g., tabbed webpages or tabbed documents). Switching between the tabs in response to user inputs also switches between corresponding tabbed windows of the browser application. Switching between different tabs in response to an air gesture in the three-dimensional environment provides an ergonomic and efficient control over browsing tabbed windows in a three-dimensional environment without cluttering the three-dimensional environment with additional controls and without encumbering a user with physical input equipment.

In some embodiments, a browser toolbar and a webpage window of a browser application are overlaid on a view of the three-dimensional environment (e.g., a virtual or mixed reality environment) with respective difference in depth between the browser toolbar and the webpage window, where the browser toolbar floats over the webpage window, separated in a “z” dimension. The browser toolbar is displayed closer to a viewpoint of a user than the webpage window. The depth difference between the browser toolbar and the webpage window is optionally maintained when switching between tabbed windows or otherwise changing content displayed in the webpage window. The depth difference between the browser toolbar and the webpage window helps a user focus on the browser toolbar and, optionally, the tabs displayed therein, when switching between tabs and tabbed windows.

In some embodiments, an improved gesture mechanism is provided for quick switching of tabbed windows in a three-dimensional environment (e.g., a virtual or mixed reality environment). While a content item window (e.g., a webpage or a document) that is currently active for a browser application is visible in the three-dimensional environment, a fast tab switching mode is activated in response to detecting movement of a user's hand along a “z” axis (e.g., pushing forward or moving away from the user, optionally while maintaining an air pinch gesture) that satisfies respective gesture criteria (e.g., distance, velocity, configuration of the hand while performing the gesture, a direction of a gaze and/or other movement criteria). In the fast tab switching mode, content item windows are scrolled through quickly in response to subsequent movement of the hand along an “x” axis (e.g., laterally, or horizontally), where a scroll speed is optionally determined in accordance with magnitude of the hand movement and is optionally modified based on a direction or a location of the user's gaze. Using mid-air hand movement along two perpendicular axes to quickly scroll through tabbed windows provides an ergonomically improved input mechanism for efficiently navigating through a large number of tabbed windows in a three-dimensional environment without the need to directly interact with user interface elements, navigate complex menu options, or use physical equipment.

In some embodiments, while a content item (e.g., a webpage or a document), which is currently active or in focus, is visible in a three-dimensional environment (e.g., a virtual or mixed reality environment), an air gesture is detected that requests display of multiple content items of the same kind, e.g., a request to active an overview mode or a request to active a fast tab switching mode. In response to the air gesture, a size of the content item is reduced, and multiple other content items of the same kind are concurrently displayed in the three-dimensional environment while visual prominence of other portions of the three-dimensional environment is reduced (e.g., space in the three-dimensional environment not occupied by the content items I blurred, darkened, or completely hidden from view), thereby reducing unrelated distractions in the three-dimensional environment. The air gesture mechanism allows a user to switch to a different browsing or viewing mode without the need to navigate menus, use of hand-held controllers, or directly interact with user interface elements.

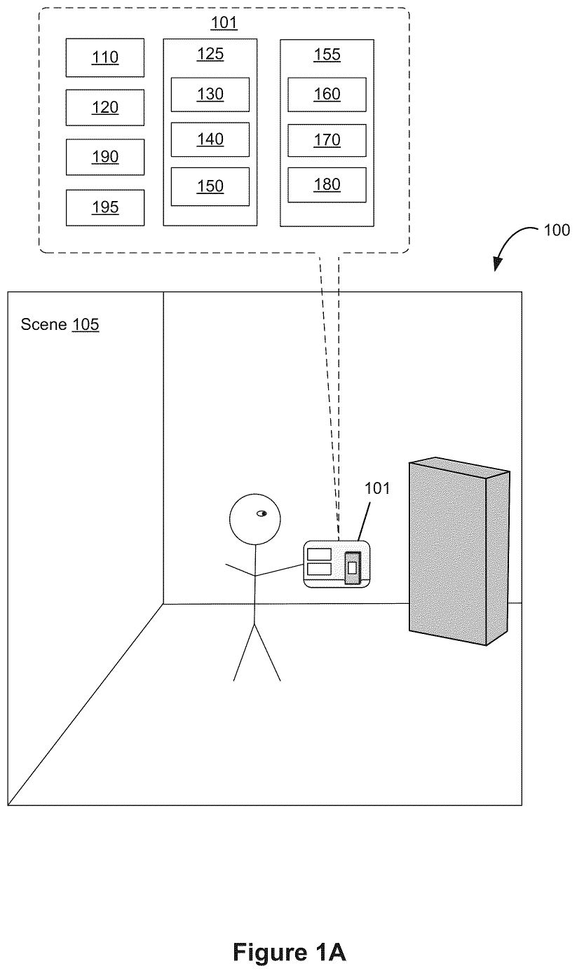

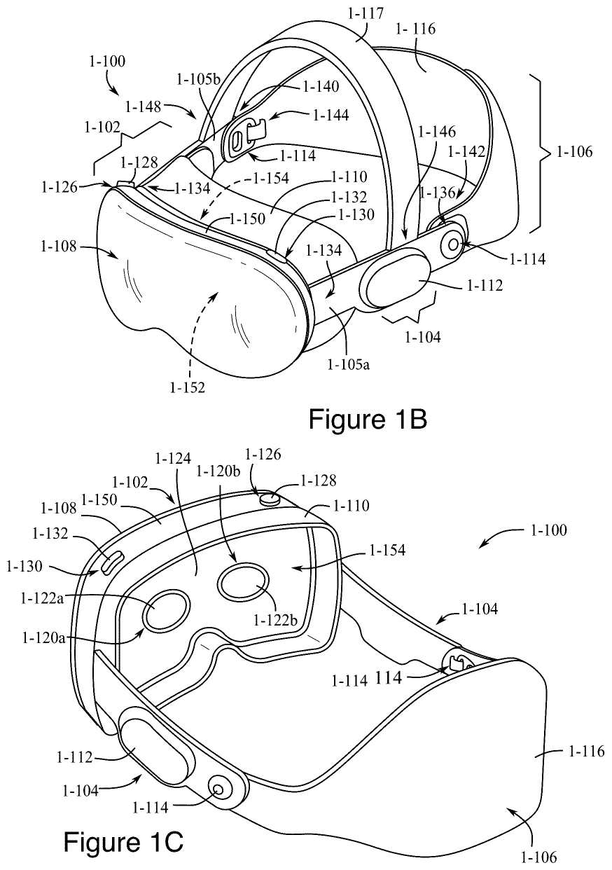

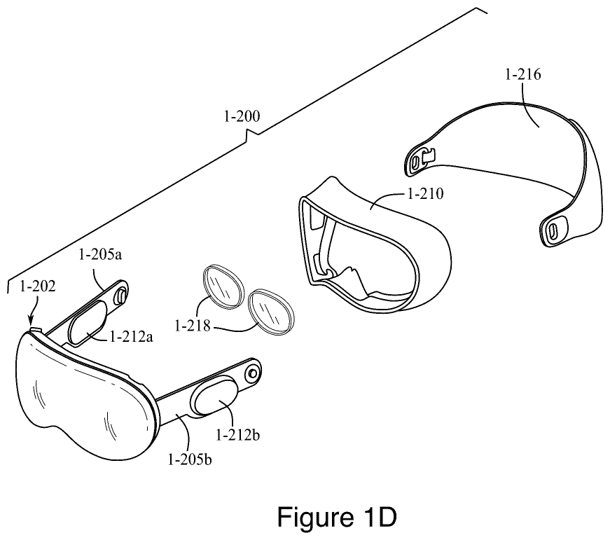

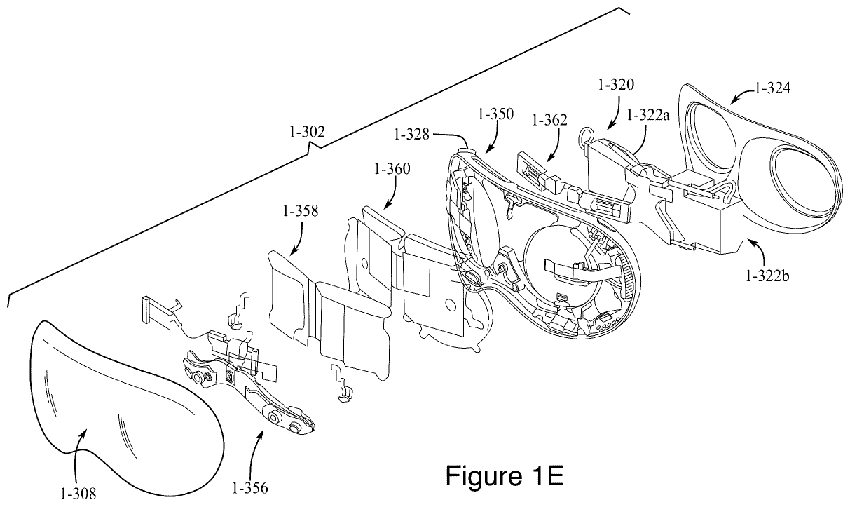

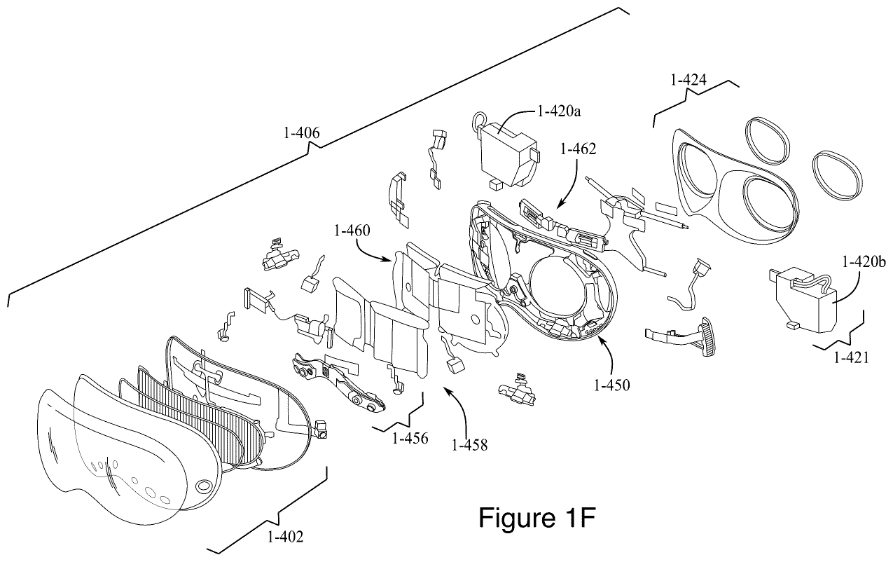

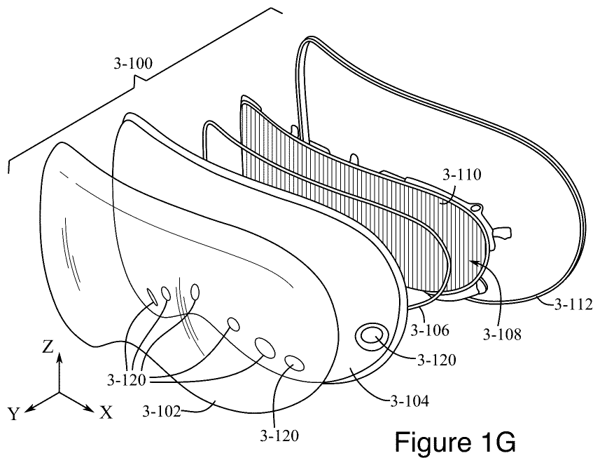

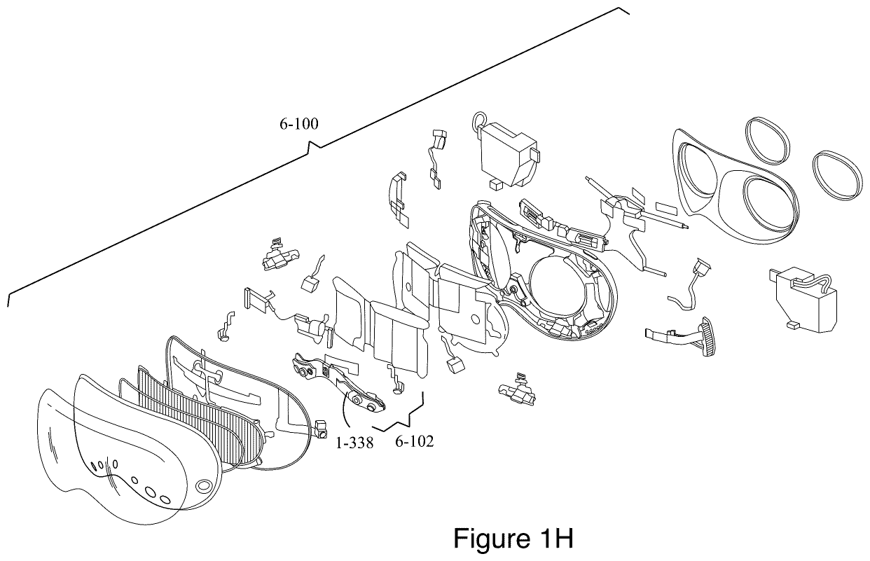

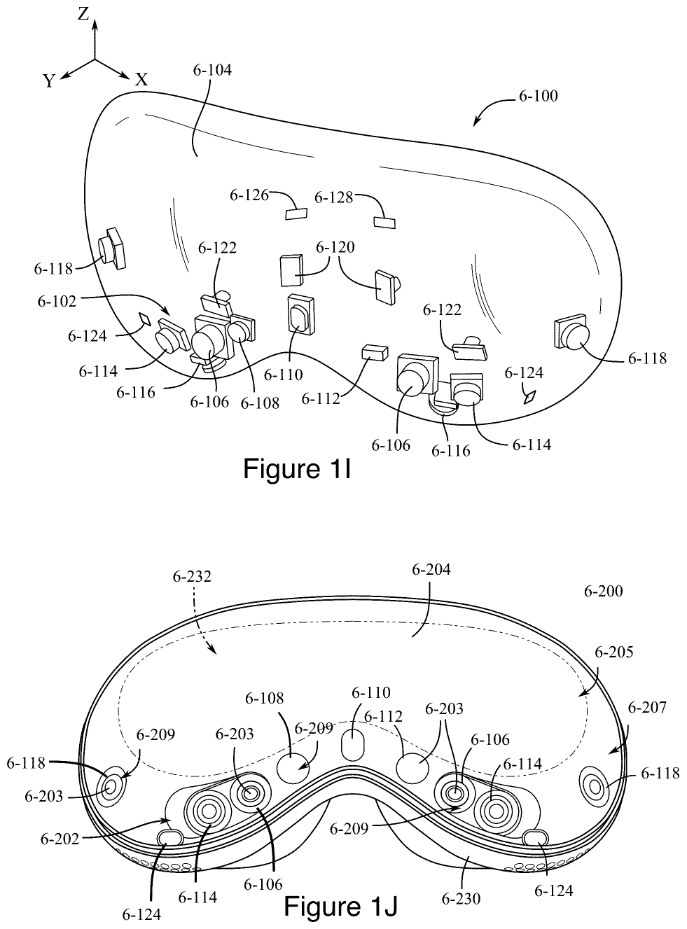

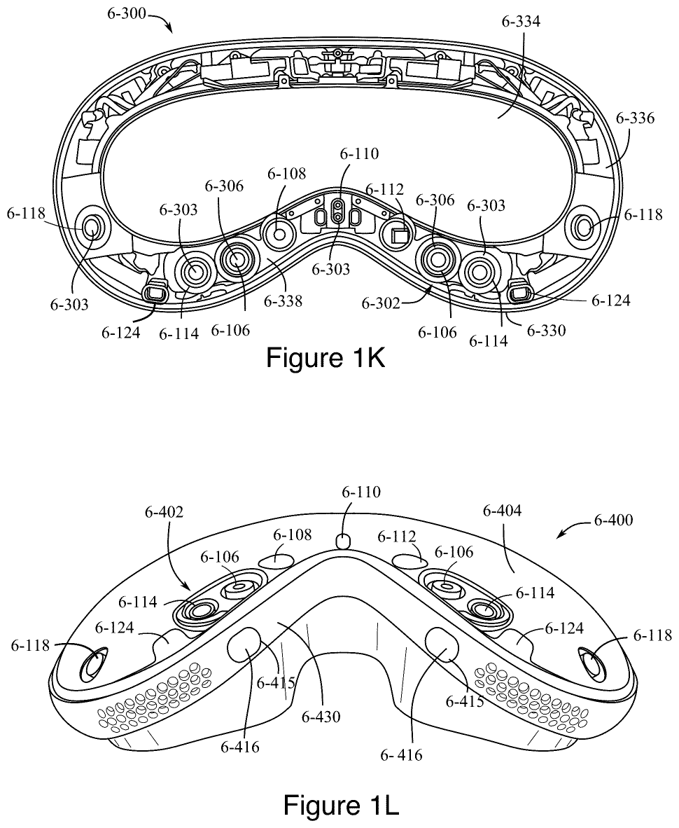

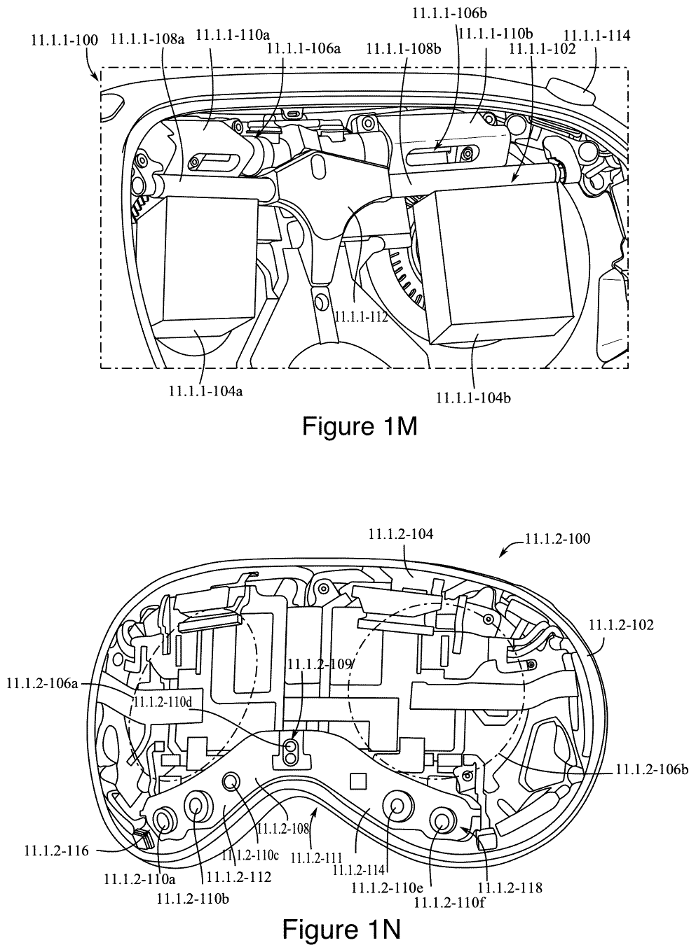

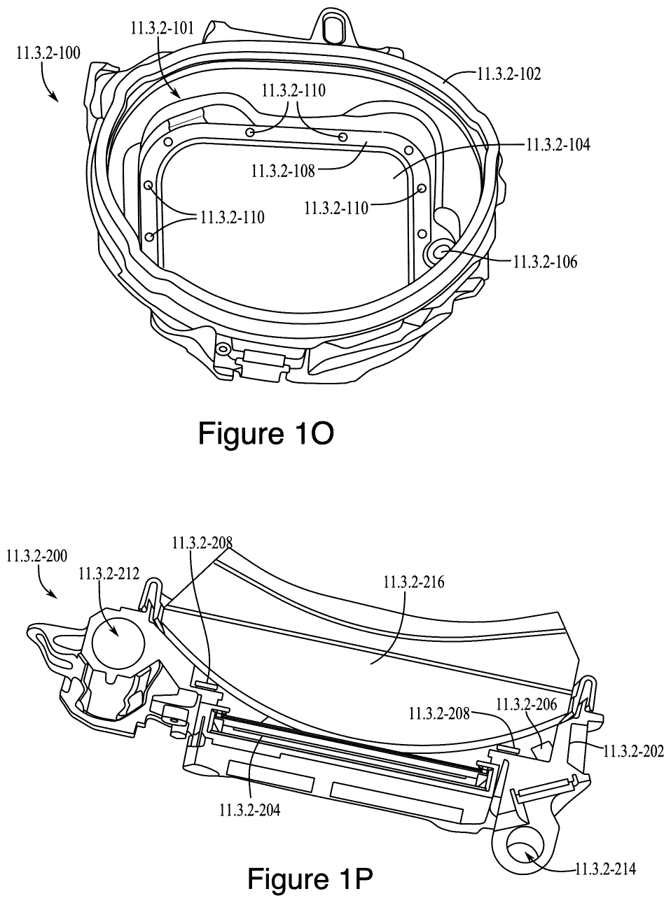

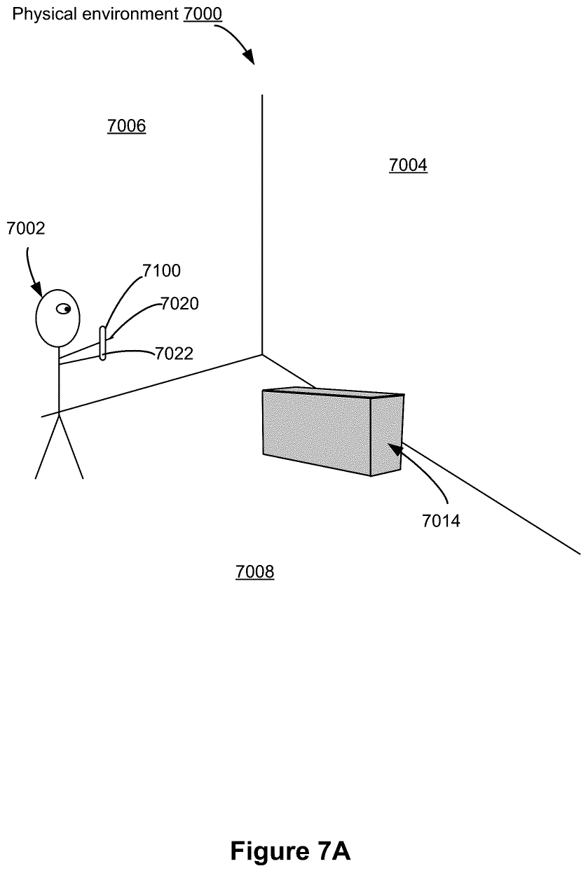

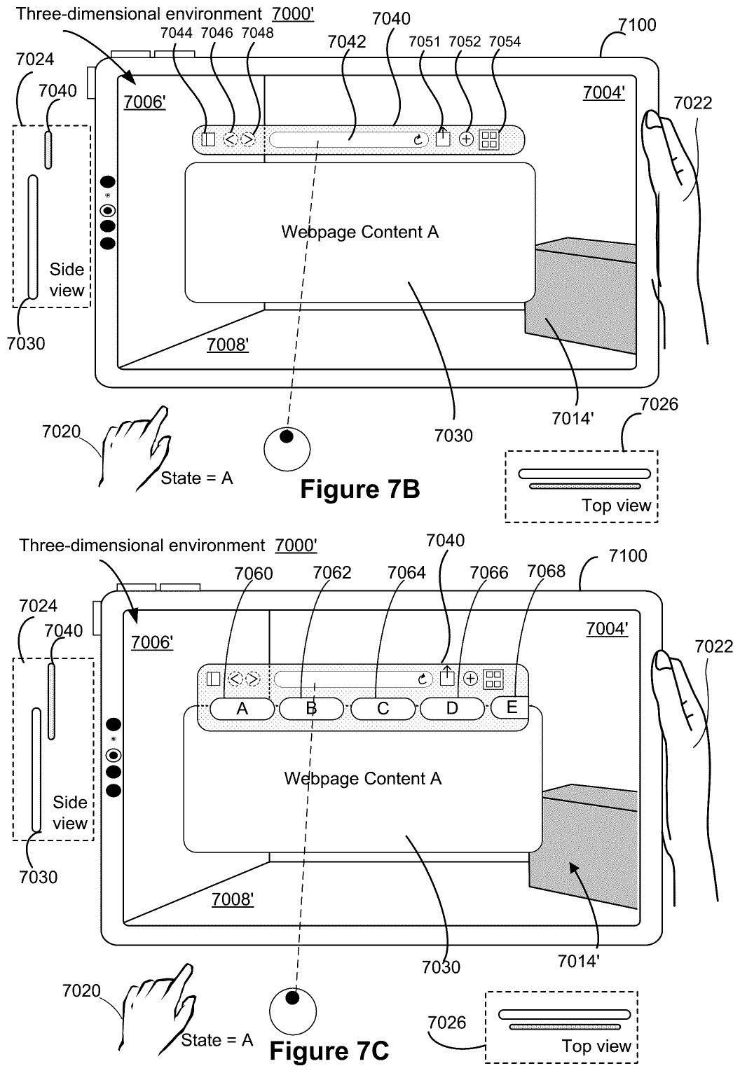

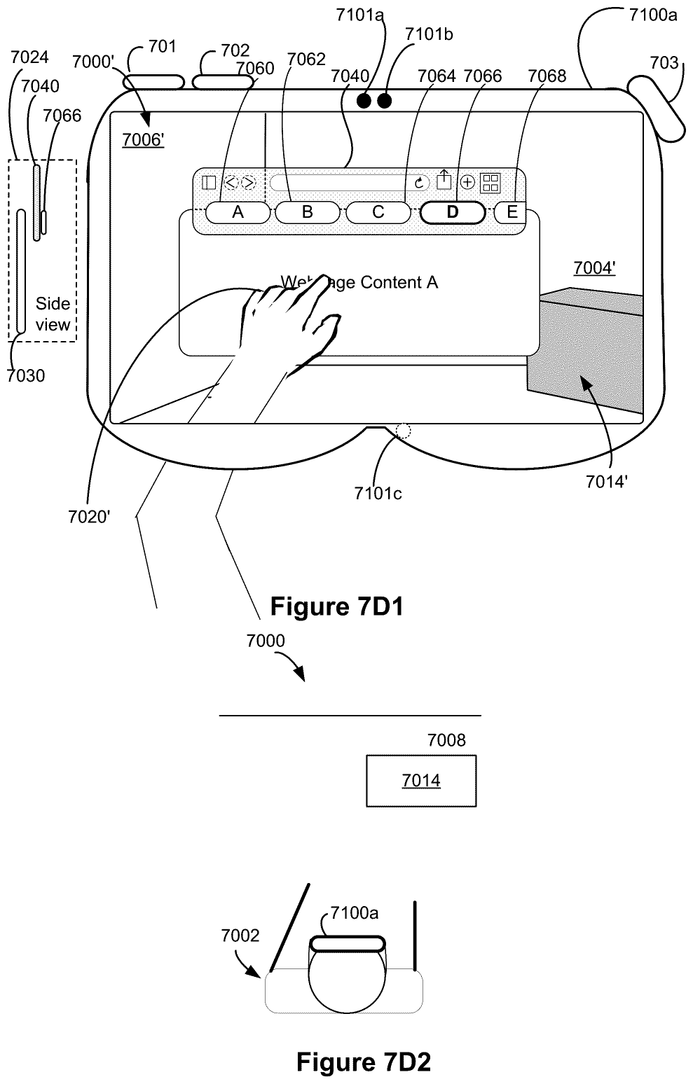

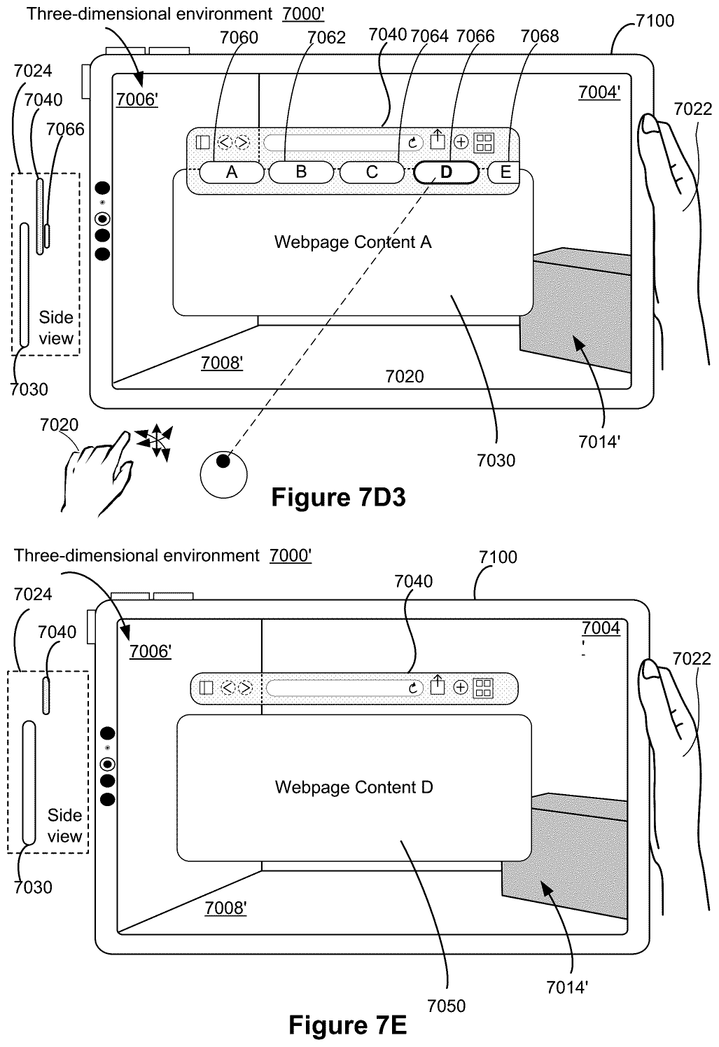

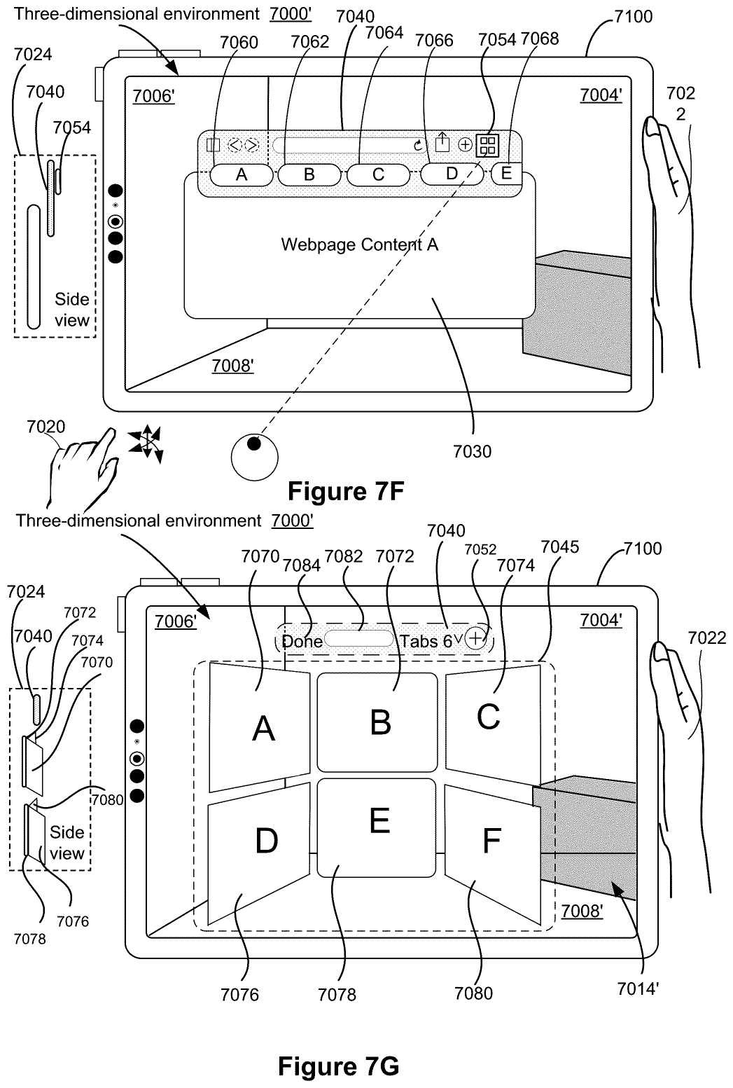

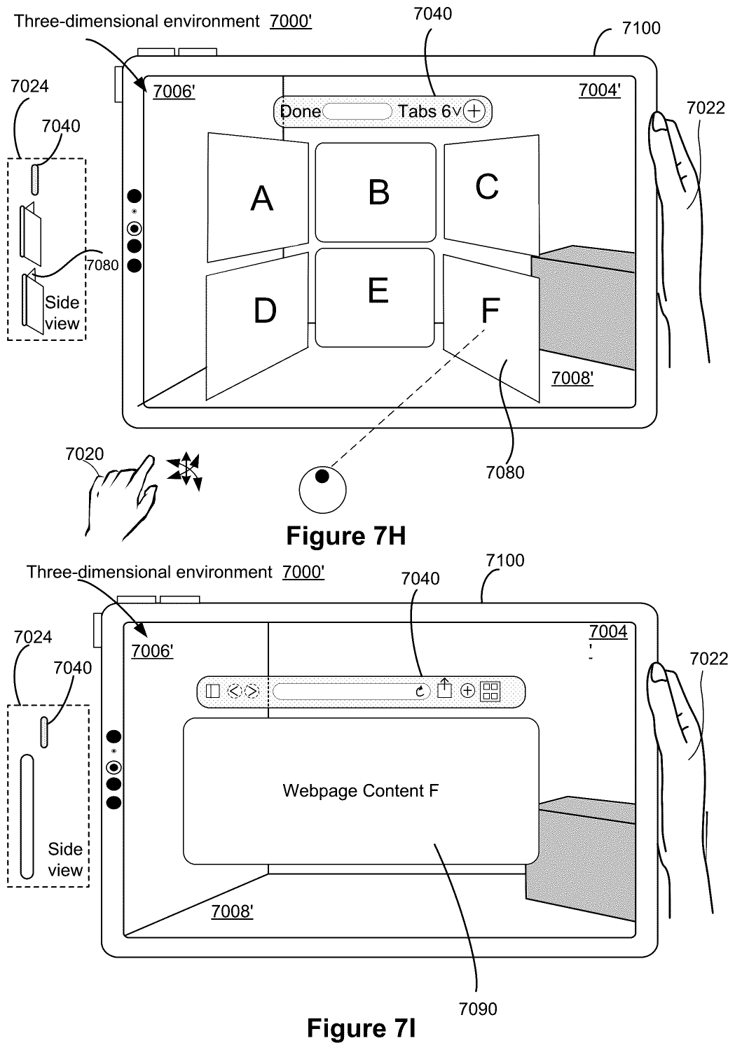

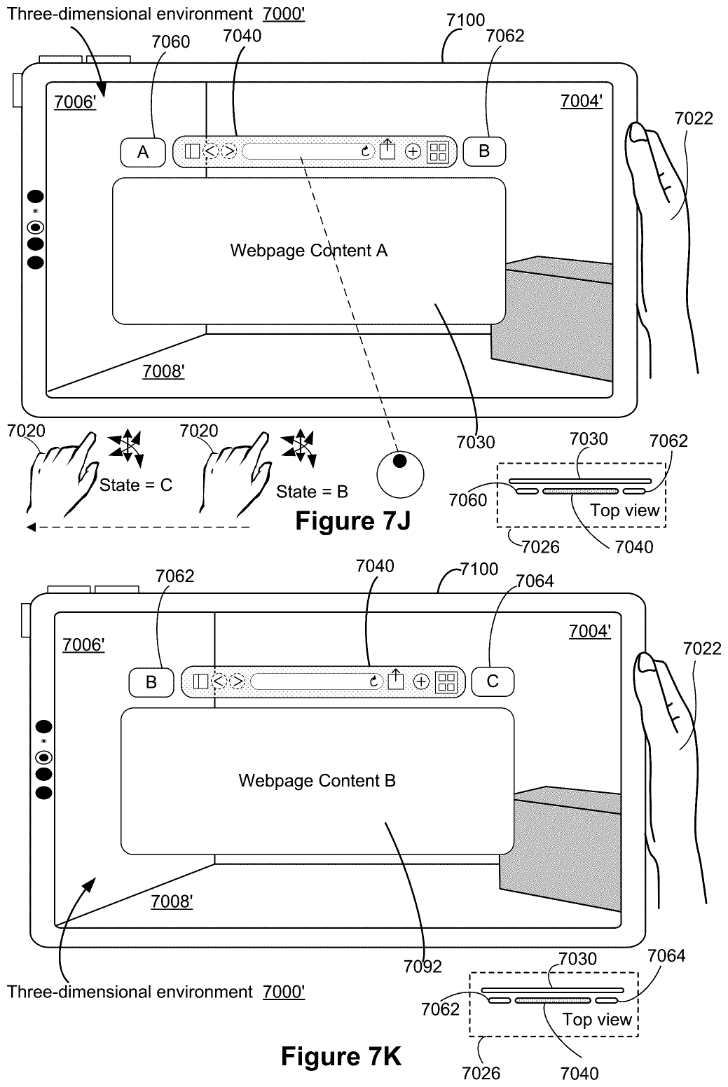

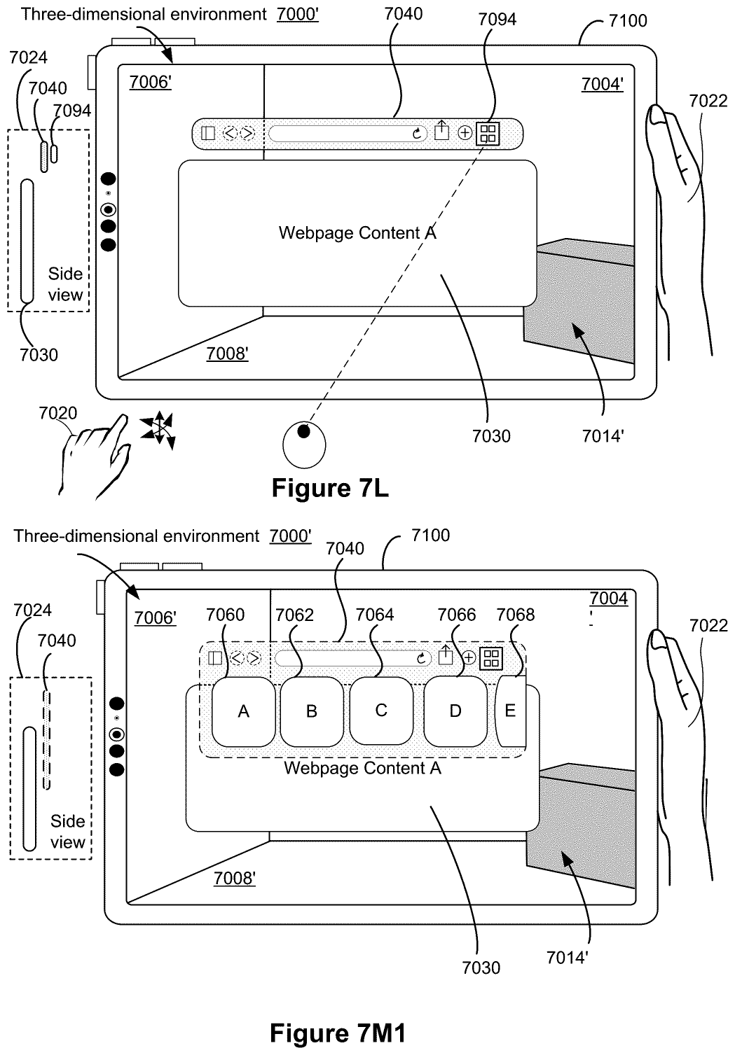

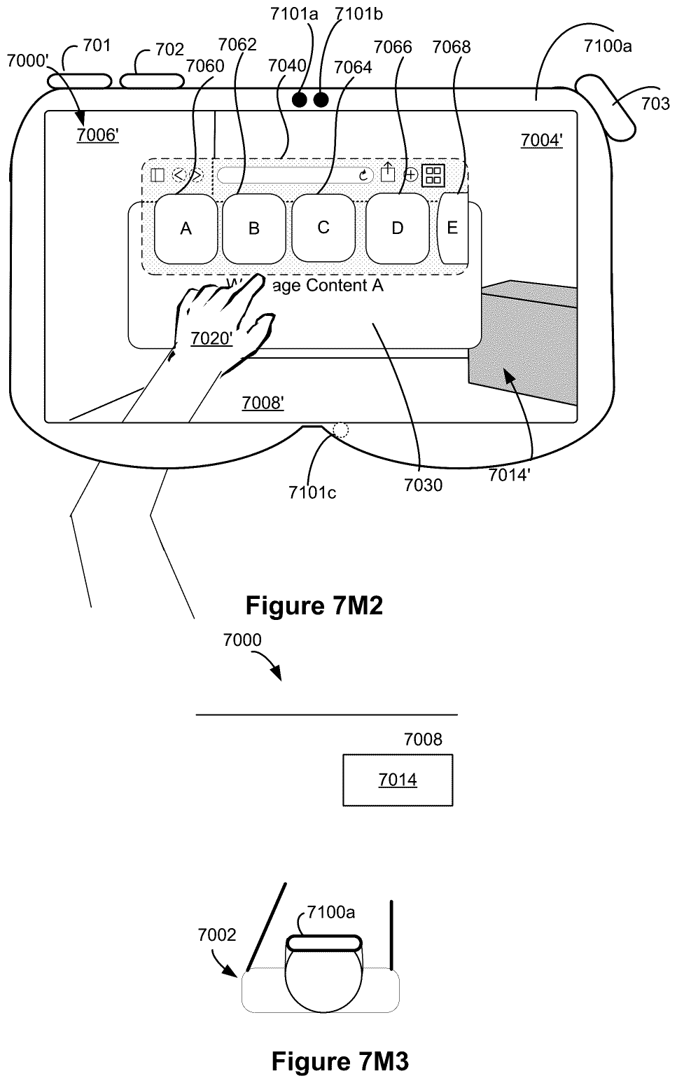

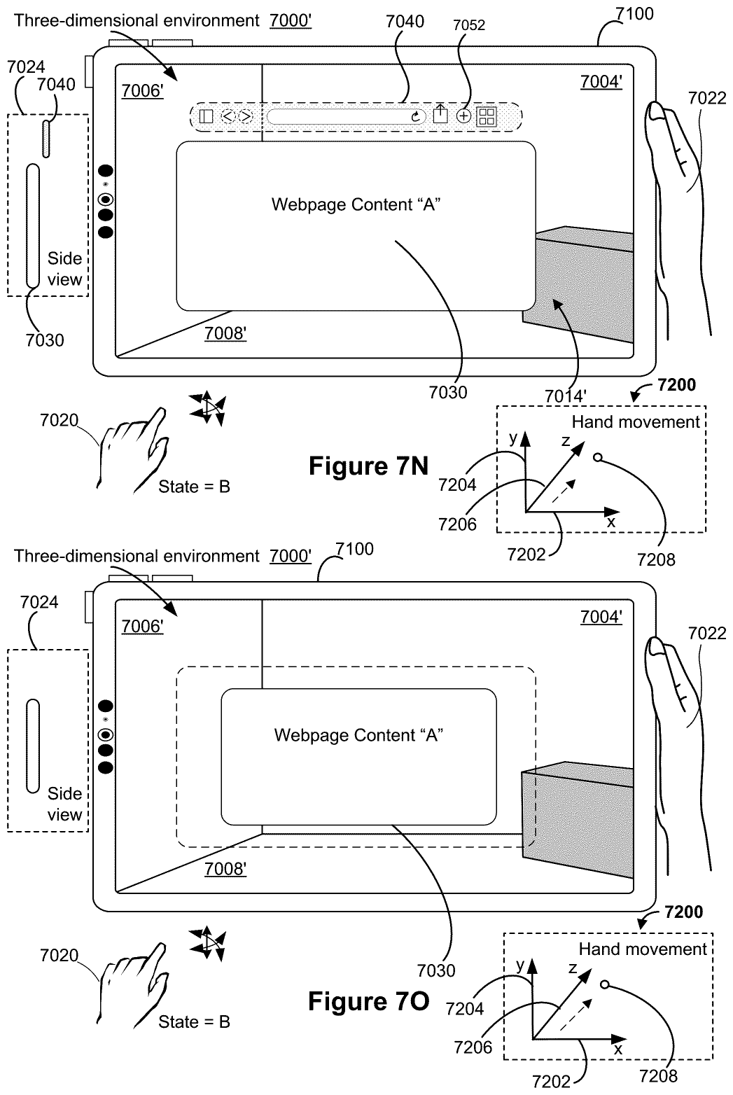

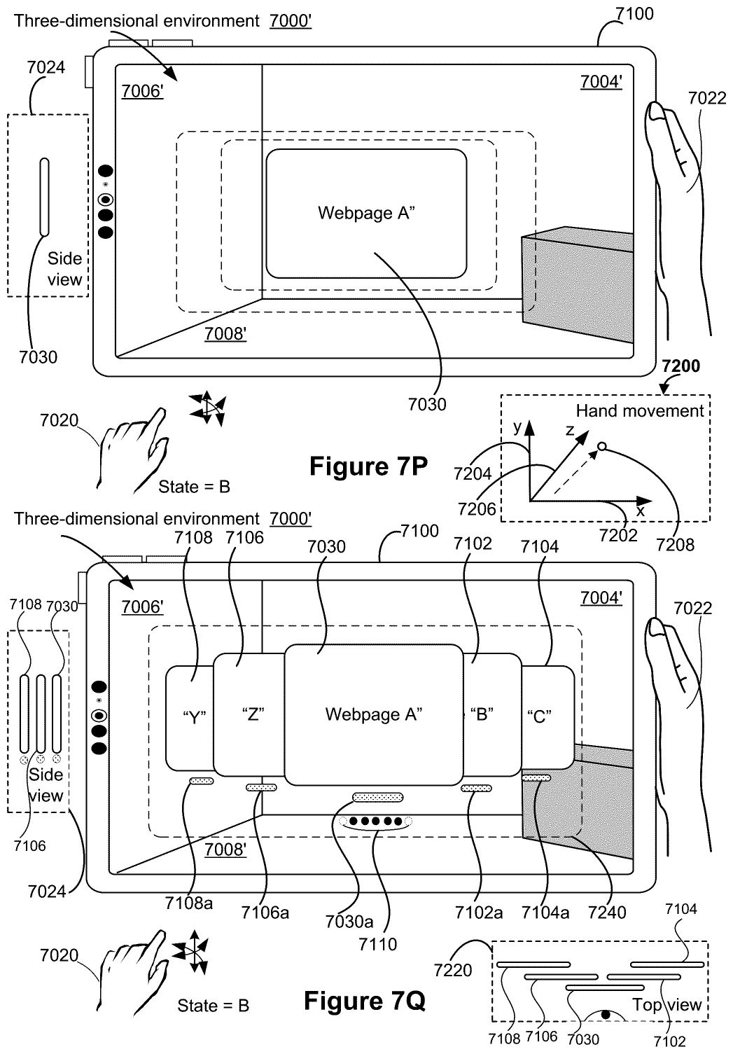

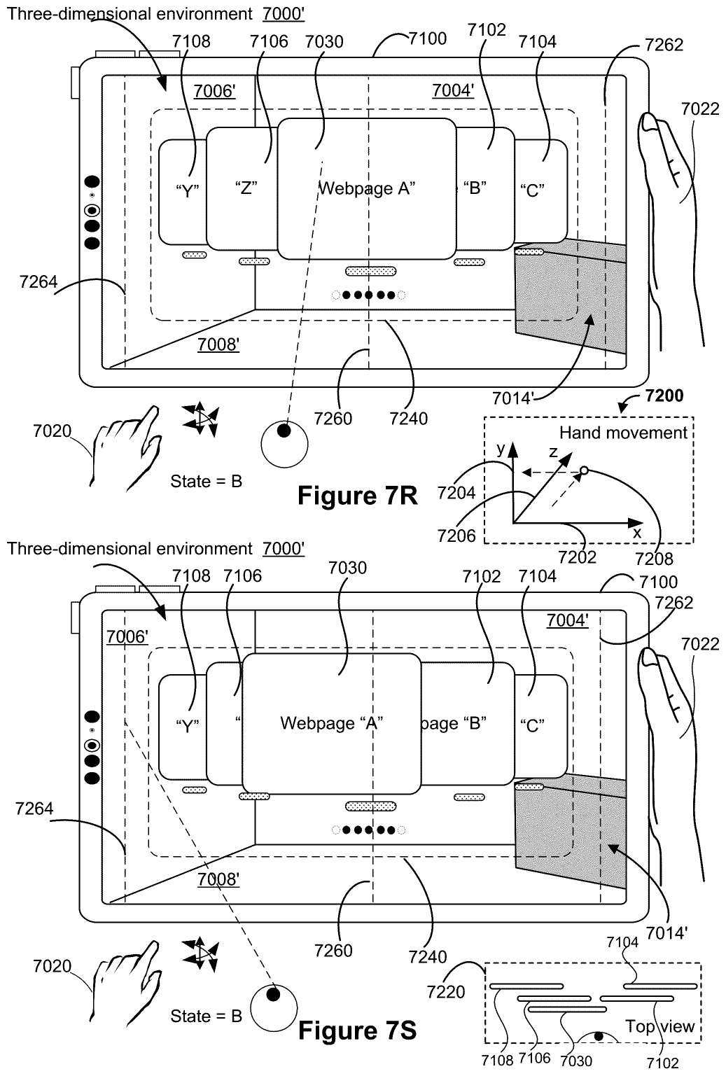

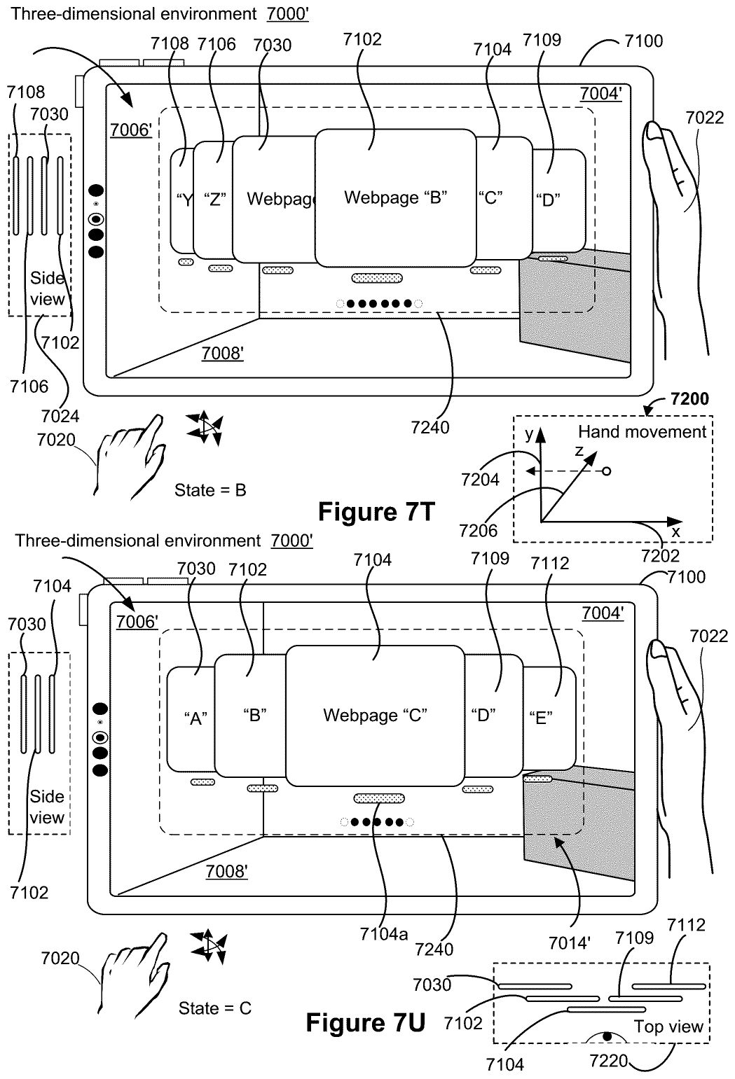

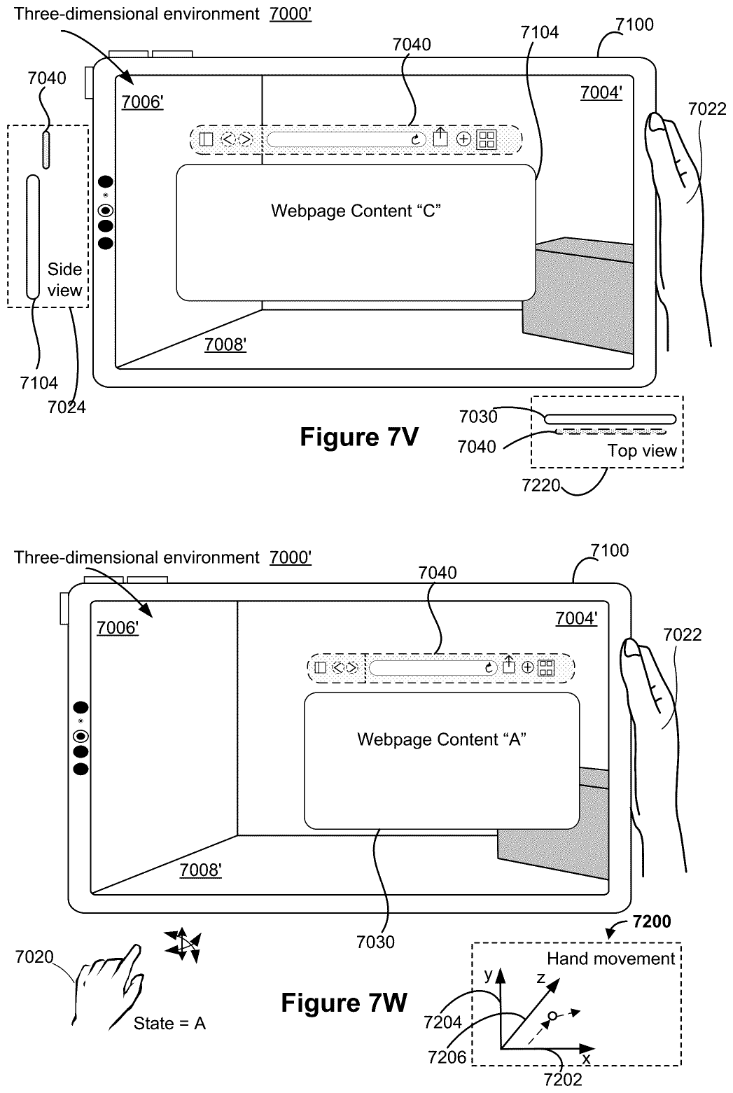

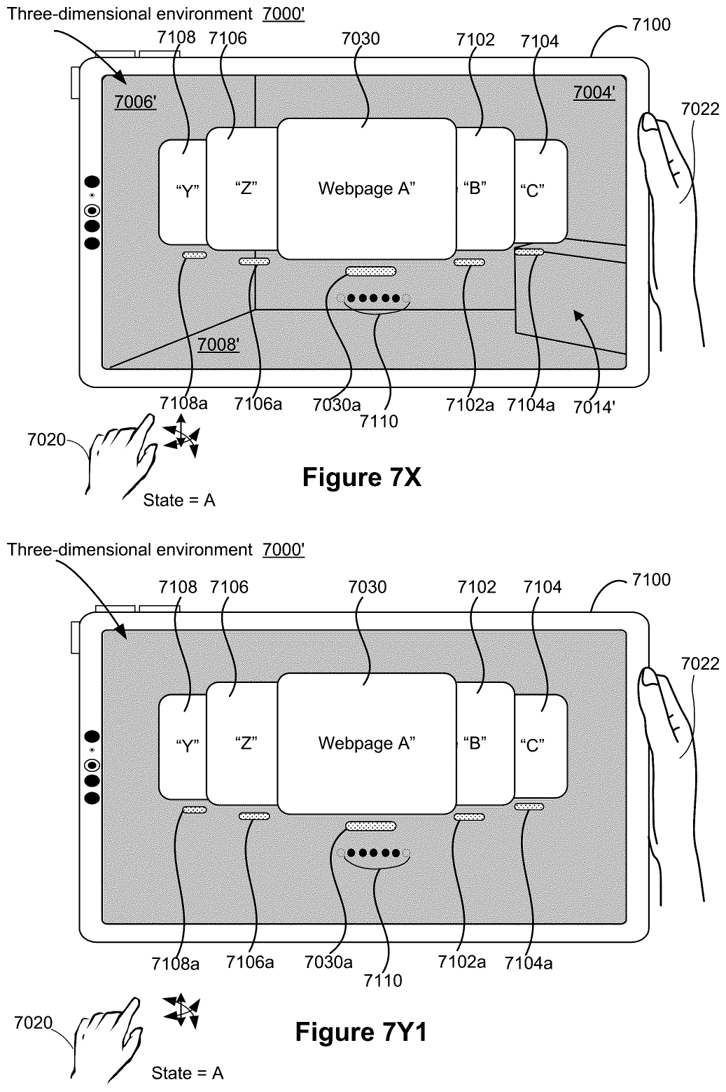

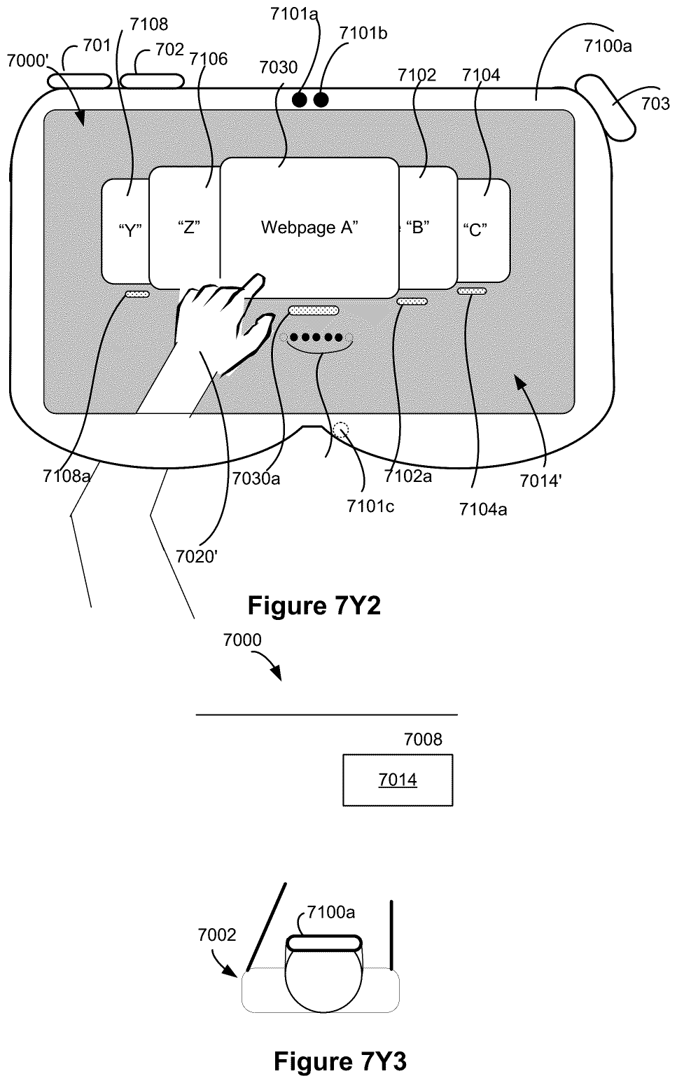

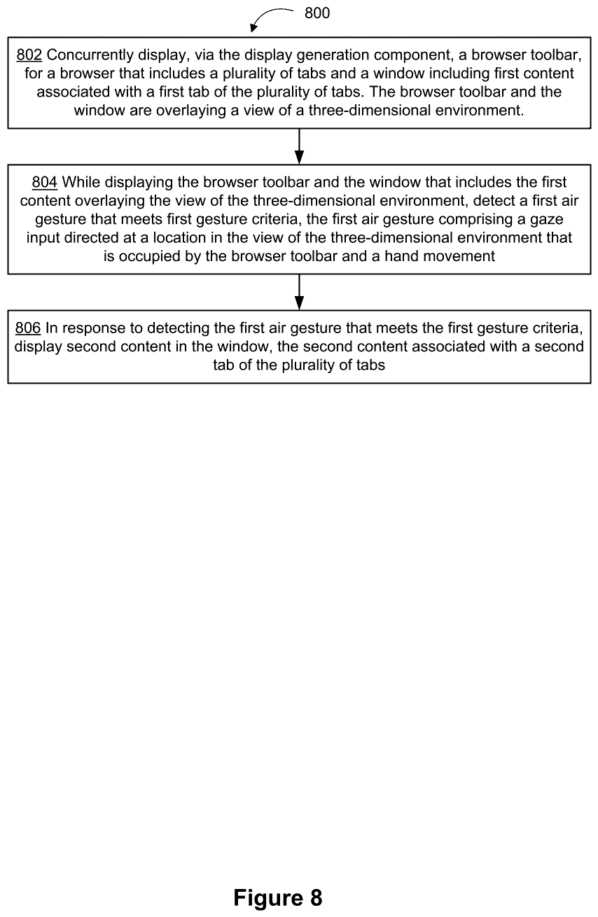

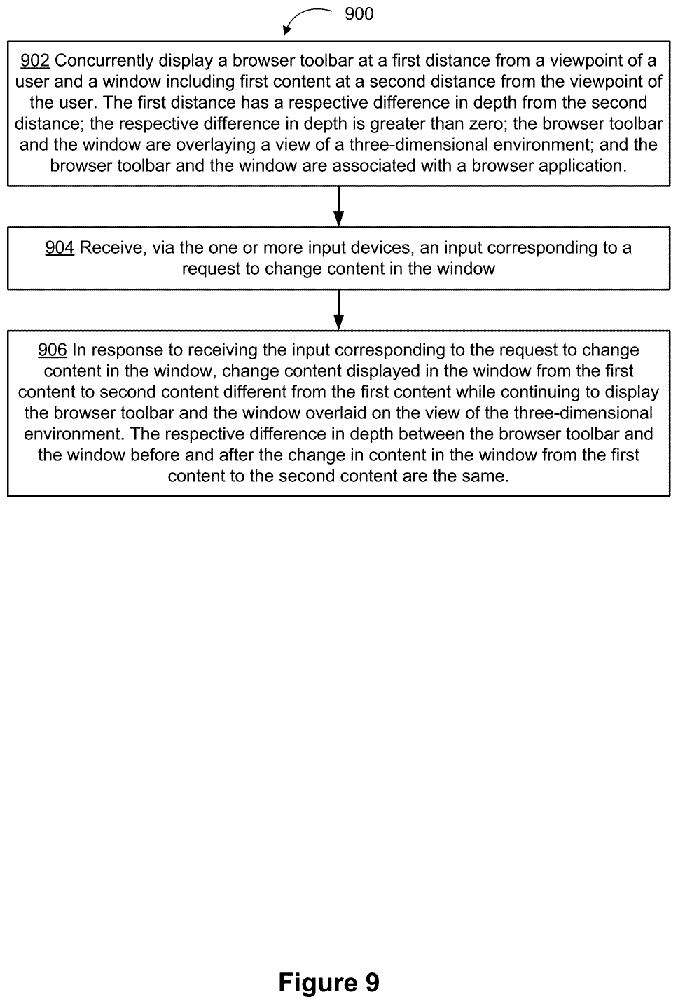

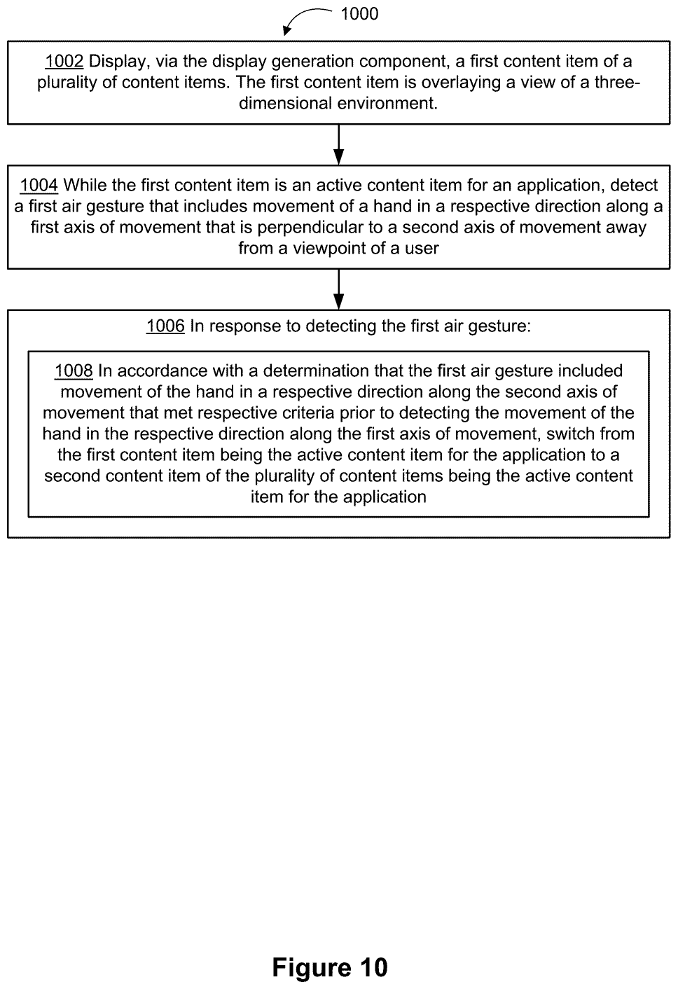

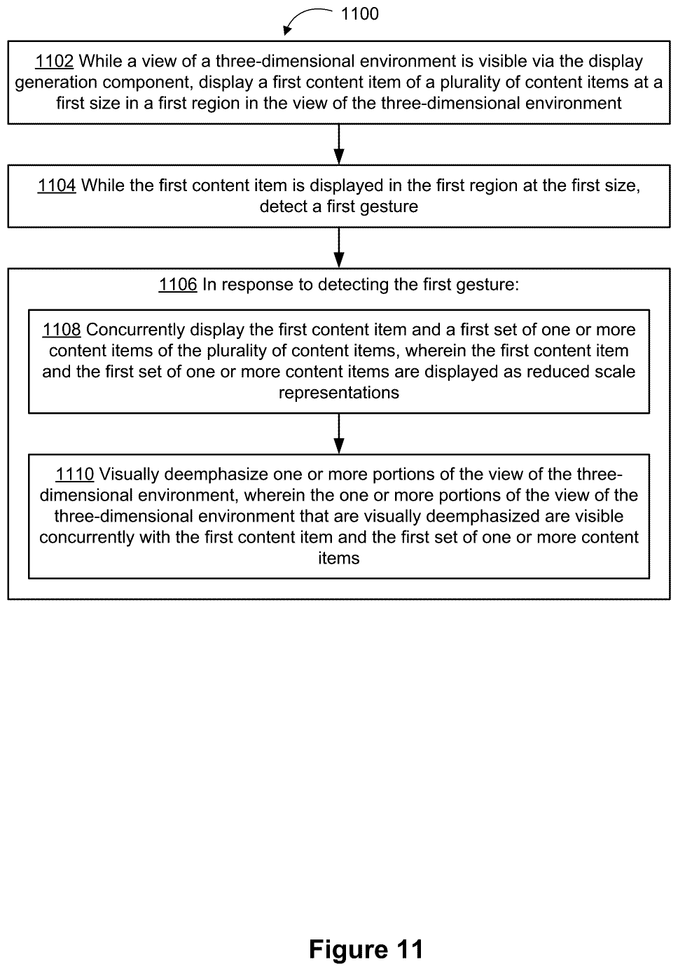

FIGS. 1A-6 provide a description of example computer systems for providing XR experiences to users. FIGS. 7A-7M3 illustrate examples of switching between tabbed windows in a three-dimensional environment. FIG. 8 is a flow diagram of an example method 800 for switching between tabbed windows in a three-dimensional environment. The user interfaces in FIGS. 7A-7M3 are used to illustrate the processes described below, including the processes in FIG. 8. Further, FIGS. 7A-7M3 illustrate examples of spatially positioning and dynamically changing a browser toolbar while interacting with a browser application in a three-dimensional environment. FIG. 9 is a flow diagram of an example method 900 for spatially positioning and dynamically changing a browser toolbar while interacting with a browser application in a three-dimensional environment. The user interfaces in FIGS. 7A-7M3 are used to illustrate the processes described below, including the processes in FIG. 9. FIGS. 7N-7Y3 illustrate examples of quick switching between tabbed windows in a three-dimensional environment. FIG. 10 is a flow diagram of an example method 1000 for quick switching between tabbed windows in a three-dimensional environment. The user interfaces in FIGS. 7N-7Y3 are used to illustrate the processes described below, including the processes in FIG. 10. Further, FIGS. 7N-7Y3 illustrate example techniques for viewing an overview of multiple content items of the same kind in a three-dimensional environment while reducing visual prominence of remaining portions of the view of the three-dimensional environment. FIG. 11 is a flow diagram of an example method 1100 for spatially positioning and dynamically changing a browser toolbar while interacting with a browser application in a three-dimensional environment. The user interfaces in FIGS. 7N-7Y3 are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HID), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in an XR environment may be made in response to representations of physical motions (e.g., vocal commands). A person may sense and/or interact with an XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

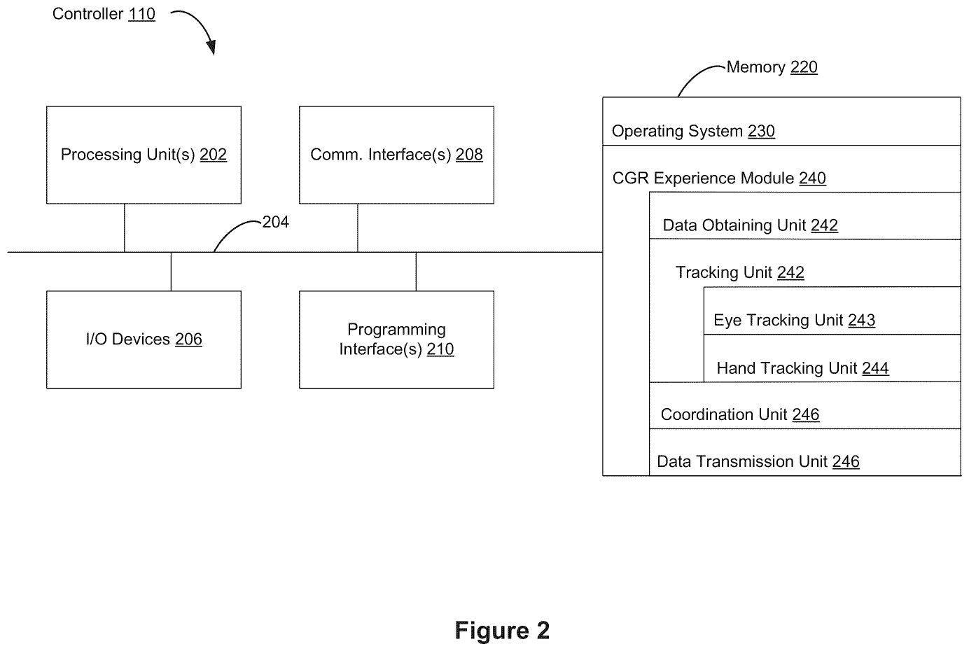

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate an XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

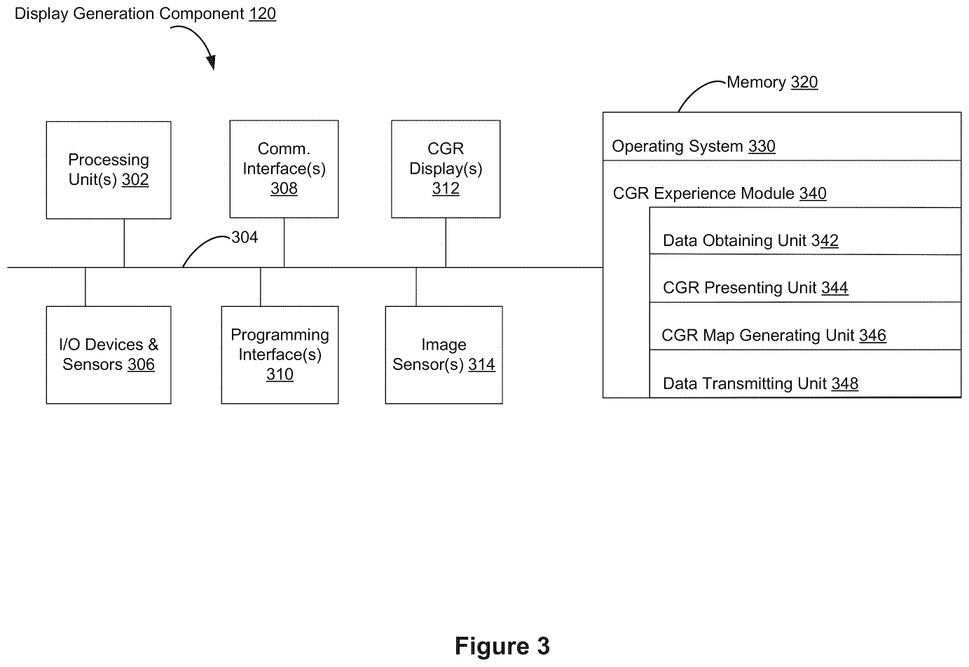

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is an XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D 1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIG. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. For hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMID, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

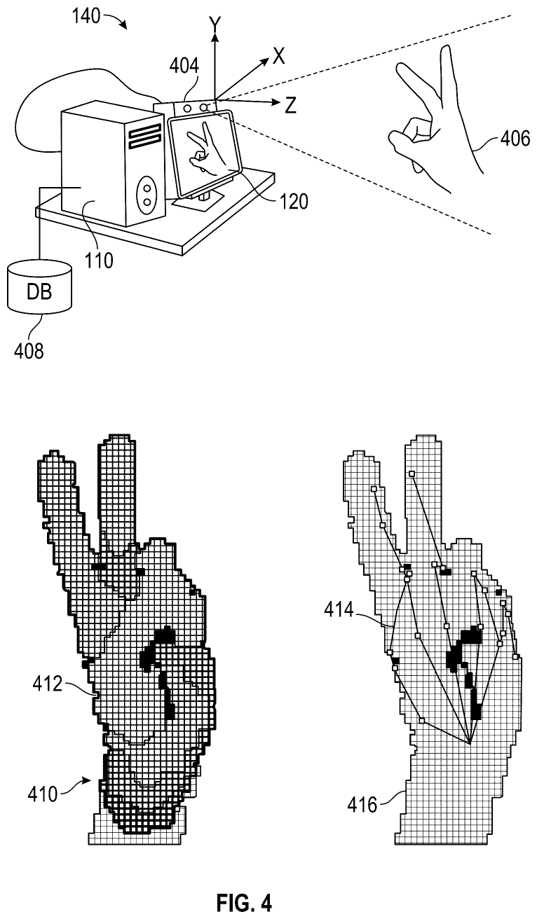

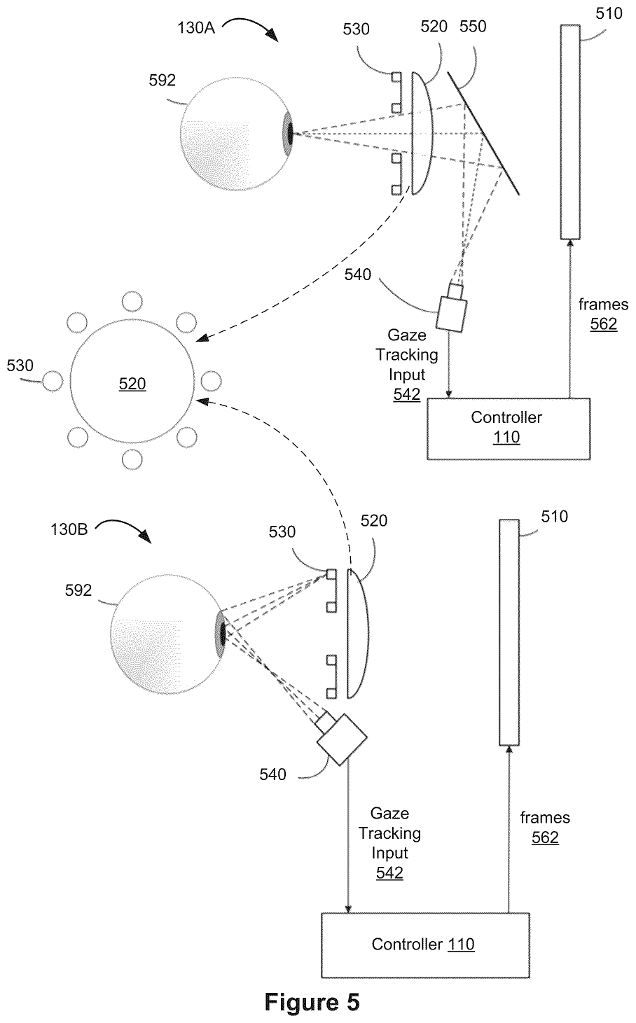

In some embodiments, the tracking unit 244 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 245 and/or eye tracking unit 243. In some embodiments, the hand tracking unit 245 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 245 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 245), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 245), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LcoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes an XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMID) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and an XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, an XR presenting unit 344, an XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate an XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 245 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environment of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving their hand 406 and/or changing their hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves their hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

An air pinch gesture, used in various examples and embodiments described herein as a selection input, is one example of a selection input. In some embodiments, the selection input can be performed with other selection gestures such as an air tap gesture or inputs performed with a controller or other physical device.

An air pinch and drag gesture, used in various examples and embodiments described herein as a scroll input, is one example of a scroll input. In some embodiments, the scroll input can be performed with other scrolling gestures or inputs such as an input performed with a controller or other physical device.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or an XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

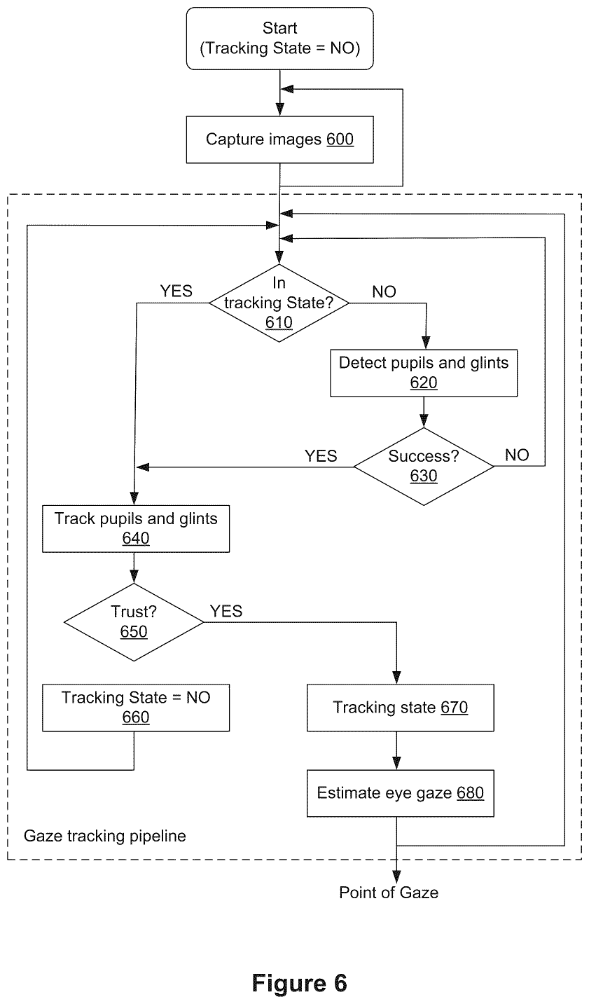

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component and one or more input devices.

FIGS. 7A-7Y illustrate three-dimensional environments that are visible via a display generation component (e.g., a display generation component 7100, or a display generation component 120) of a computer system (e.g., computer system 101) and interactions that occur in the three-dimensional environments caused by user inputs directed to the three-dimensional environments and/or inputs received from other computer systems and/or sensors. In some embodiments, an input is directed to a virtual object within a three-dimensional environment by a user's gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user's hand movement (e.g., whole hand movement, whole hand movement in a respective posture, movement of one portion of the user's hand relative to another portion of the hand, and/or relative movement between two hands of the user) and/or manipulation with respect to the physical object (e.g., touching, swiping, tapping, opening, moving toward, and/or moving relative to). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, contact sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not qualify as a recognized gesture input for triggering an associated operation of the computer system.

In some embodiments, a three-dimensional environment that is visible via a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environments (e.g., transitions between presenting a computer-generated environment or experience with different levels of immersion, adjusting the relative prominence of audio/visual sensory inputs from the virtual content relative to the representation of the physical environment) based on user inputs and/or contextual conditions.

In some embodiments, the display generation component includes a pass-through portion in which the representation of the physical environment is displayed or visible. In some embodiments, the pass-through portion of the display generation component is a transparent or semi-transparent (e.g., see-through) portion of the display generation component revealing at least a portion of a physical environment surrounding and within the field of view of a user. For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display (sometimes called “optical passthrough”). In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., forward facing and/or rear facing camera(s) of a mobile device or associated with a head-mounted display, or other cameras that feed image data to the computer system) (sometimes called “optical passthrough”). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected, by the display generation component onto physical surfaces or empty space in the physical environment while portions of the physical environment are visible through a pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the user's hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a preset spatial relationship relative to the viewpoint (e.g., is anchored or fixed to the viewpoint), movement of the viewpoint relative to the three-dimensional environment causes movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a preset spatial relationship between the position of the virtual object and the position of the portion of the user in the three-dimensional environment. In some embodiments, a virtual object is locked to a preset portion of a field of view provided by the display generation component, and moves in the three-dimensional environment in accordance with the movement of the field of view, irrespective of movement of the user that does not cause a change of the field of view.

While not shown in FIGS. 7A-7Y, in some embodiments, representation(s) of a user's hand(s), arm(s), and/or wrist(s) are included in the views of a three-dimensional environment. In some embodiments, the representation(s) of a user's hand(s), arm(s), and/or wrist(s) are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands of the user are, optionally, displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, the representation of the user's hand or wrist is outside of the currently displayed view of the three-dimensional environment while the virtual position in the three-dimensional environment that corresponds to the location of the user's hand or wrist is outside of the current field of view provided via the display generation component; and the representation of the user's hand or wrist is made visible in the view of the three-dimensional environment in response to the virtual position that corresponds to the location of the user's hand or wrist being moved within the current field of view due to movement of the display generation component, the user's hand or wrist, the user's head, and/or the user as a whole.

As shown in the examples in FIGS. 7A-7Y, content that is visible via a display generation component 7100 of computer system 101 is displayed on a touch screen held by user 7002. In some embodiments, display generation component 7100 of computer system 101 is a head-mounted display worn on user 7002's head (e.g., what is shown in FIGS. 7A-7Y as being visible via display generation component 7100 of computer system 101 corresponds to user 7002's field of view when wearing a head-mounted display).

FIGS. 7A-7M illustrate examples of switching between tabbed windows in a three-dimensional environment. FIG. 8 is a flow diagram of an example method 800 for switching between tabbed windows in a three-dimensional environment. The user interfaces in FIGS. 7A-7M are used to illustrate the processes described below, including the processes in FIG. 8. Further, FIGS. 7A-7M illustrate examples of spatially positioning and dynamically changing a browser toolbar while interacting with a browser application in a three-dimensional environment. FIG. 9 is a flow diagram of an example method 900 for spatially positioning and dynamically changing a browser toolbar while interacting with a browser application in a three-dimensional environment. The user interfaces in FIGS. 7A-7M are used to illustrate the processes described below, including the processes in FIG. 9.

FIG. 7A illustrates physical environment 7000 that is visible to user 7002 via display generation component 7100 of computer system 101. The physical environment includes physical walls 7004, 7006, and 7008. The physical environment 7000 also includes physical object 7014. User 7002 is holding display generation component 7100 with hand 7020 and/or hand 7022. Optionally, display generation component 7100 can be placed on a surface or attached to user 7002's body (e.g., a head mounted display 7100a, as shown in FIGS. 7D1-7D2, 7M2-7M3 and 7Y2-7Y3), leaving hand 7020 and hand 7022 free to perform various air gestures. In some embodiments, one or more portions of the view of physical environment 7000 that is visible to user 7002 via display generation component 7100 are virtual passthrough portions that include representations of corresponding portions of physical environment 7000 captured via one or more image sensors of computer system 101. In some embodiments, one or more portions of the view of physical environment 7000 that is visible to user 7002 via display generation component 7100 are optical passthrough portions, in that user 7002 can see one or more portions of physical environment 7000 through one or more transparent or semi-transparent portions of display generation component 7100. For example, in some embodiments, while the user's hand 7020 is within the field of view of the one or more sensors of HMD 7100a (e.g., within the field of view of the user), a representation of the user's hand 7020′ is displayed in the user interface displayed (e.g., as a passthrough representation and/or as a virtual representation of the user's hand 7020) on the display of HMD 7100a.

In some embodiments, the display generation component 7100 comprises a head mounted display (HMD) 7100a. For example, as illustrated in FIG. 7D1 (e.g., and FIG. 7M2 and FIG. 7Y2), the head mounted display 7100a includes one or more displays that displays a representation of a portion of the three-dimensional environment 7000′ that corresponds to the perspective of the user, while an HMD typically includes multiple displays including a display for a right eye and a separate display for a left eye that display slightly different images to generate user interfaces with stereoscopic depth, in the figures a single image is shown that corresponds to the image for a single eye and depth information is indicated with other annotations or description of the figures. In some embodiments, HMD 7100a includes one or more sensors (e.g., one or more interior- and/or exterior-facing image sensors 314), such as sensor 7101a, sensor 7101b and/or sensor 7101c for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and depressible or other input devices. In some embodiments input elements are mechanical input elements, in some embodiments input elements are solid state input elements that respond to press inputs based on detected pressure or intensity. For example, in FIG. 7D1 (e.g., and FIG. 7M2 and FIG. 7Y2), HMD 7100a includes one or more of button 701, button 702 and digital crown 703 for providing inputs to HMD 7100a. It will be understood that additional and/or alternative input devices may be included in HMD 7100a.

FIG. 7D2 (e.g., and FIG. 7M3 and FIG. 7Y3) illustrates a top-down view of the user 7002 in the physical environment 7000. For example, the user 7002 is wearing HMD 7100a, such that the user's hand(s) (e.g., that are optionally used to provide air gestures or other user inputs) are physically present within the physical environment 7000 behind the display of HMD 7100a.

FIG. 7D1 (e.g., and FIG. 7M2 and FIG. 7Y2) illustrates an alternative display generation component of the computer system than the display illustrated in FIGS. 7A-7C, 7D3-7M1 and 7N-7Y1. It will be understood that the processes, features and functions described herein with reference to the display generation component 7100 described in FIGS. 7A-7C, 7D3-7M1 and 7N-7Y1 are also applicable to HMD 7100a, illustrated in FIGS. 7D1, 7M2 and 7Y3.

As shown in the examples in FIGS. 7A-7Y1 display generation component 7100 of computer system 101 is a touchscreen held by user 7002. In some embodiments, the display generation component of computer system 101 is a head-mounted display worn on user 7002's head (e.g., what is shown in FIGS. 7A-7Y1 as being visible via display generation component 7100 of computer system 101 corresponds to user 7002's field of view when wearing a head-mounted display 7100a, as shown in FIGS. 7D1-7D2, 7M2-7M3 and 7Y2-7Y3). In some embodiments, the display generation component is a standalone display, a projector, or another type of display. In some embodiments, the computer system is in communication with one or more input devices, including cameras or other sensors and input devices that detect movement of the user's hand(s), movement of the user's body as whole, and/or movement of the user's head in the physical environment. In some embodiments, the one or more input devices detect the movement and the current postures, orientations, and positions of the user's hand(s), face, and/or body as a whole. In some embodiments, user inputs are detected via a touch-sensitive surface or touchscreen. In some embodiments, the one or more input devices include an eye tracking component that detects location and movement of the user's gaze. In some embodiments, the display generation component, and optionally, the one or more input devices and the computer system, are parts of a head-mounted device that moves and rotates with the user's head in the physical environment, and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component (e.g., a touchscreen) is optionally moved and rotated by the user's hand relative to the physical environment or relative to the user's head, and changes the viewpoint of the user in the three-dimensional environment in accordance with the movement of the display generation component relative to the user's head or face or relative to the physical environment.

FIG. 7B illustrates a view of a three-dimensional environment 7000′ that is visible to user 7002 via display generation component 7100. In FIG. 7B, display generation component 7100 is held by user 7002 with hand 7022. The view of the three-dimensional environment 7000′ includes a representation (or optical view) of portions of the physical environment 7000 as captured by one or more cameras of computer system 101 (or, in some embodiments, an optical passthrough view through one or more transparent or semi-transparent portions of display generation component 7100). The view of the three-dimensional environment 7000′ includes representation (or optical view) 7004′ of a portion of physical wall 7004, representation (or optical view) 7006′ of a portion of physical wall 7006, and representation (or optical view) 7008′ of a portion of physical wall 7008. Further, the view of the three-dimensional environment 7000′ includes representation (or optical view) 7014′ of a portion of physical object 7014. Further, the view of the three-dimensional environment 7000′ includes browser toolbar 7040 and content window 7030 of a browser application. Browser toolbar 7040 and content window 7030 of the browser application are virtual content. In some embodiments, browser toolbar 7040 and content window 7030 correspond to user interfaces of the browser application, which is a software application executing on computer system 101. Browser toolbar 7040 includes a number of controls including sidebar button 7044 for opening a sidebar, which includes bookmarks and saved webpages; back button 7046 for navigating backward to a previously opened page; forward button 7048 for navigating forward to previously opened webpage; address bar 7042 for entering a web page address (e.g., a URL) or a search query; share button 7051 for sharing a webpage; tab button 7052 for opening a new tab; and tab overview button 7054 for activating tab overview mode. In some embodiments, the browser application for which the toolbar 7040 and content window 7030 are shown in FIG. 7B is in a normal browsing mode.

In FIG. 7B, side view 7024 illustrates browser toolbar 7040 and content window 7030 as seen from the side. Top view 7026 illustrates browser toolbar 7040 and content window 7030 as seen from the top (e.g., instead of seen from the front as in the view of three-dimensional environment 7000′). In side view 7024 the user's location is toward the right side of the side view 7024, and in top view 7026 the user's location is toward the bottom of the top view 7026. As shown in side view 7024 and top view 7026, browser toolbar 7040 is spaced apart from content window 7030, e.g., browser toolbar 7040 is separated from content window 7030 in a “z” direction, such that browser toolbar 7040 and content window 7030 are displayed at different depths in the view of the three-dimensional environment 7000′. For example, browser toolbar 7040 is displayed closer to a viewpoint of user 7002 than content window 7030. For example, the distance from content window 7030 to user 7002 (or other reference point) is greater than the distance from browser toolbar 7040 to user 7002 (or the same reference point). In some embodiments, in FIG. 7B, browser toolbar 7040 is in collapsed state, in which open tabs that are included in the browser toolbar 7040 are not visible. Side view 7024 further illustrates that, in collapsed state, browser toolbar 7040 does not overlay content window 7030, e.g., no portion of the content window 7030 is occluded by the browser toolbar.

In some embodiments, browser toolbar 7040 and/or content window 7030 are world-locked. In some embodiments, browser toolbar 7040 and/or content window 7030 are viewpoint-locked. In some embodiments, browser toolbar 7040 and/or content window 7030 are viewpoint-locked to the viewpoint of user 7002 or point-locked (to a different reference point such as a hand or a wrist of user 7002), and exhibit lazy follow behavior. In some embodiments, as viewpoint of user 7002 changes, an angle at which browser toolbar 7040 is displayed towards user 7002 changes to greater than zero, such that browser toolbar 7040 is angled toward user 7002 as viewpoint of user 7002 changes.

FIG. 7B further illustrates user 7002 gazing at (e.g., focusing attention on) a location in the view of the three-dimensional environment that is occupied by browser toolbar 7040 in conjunction with maintaining hand 7020 in a ready state, which is denoted as state “A” in FIG. 7B.

FIG. 7C illustrates a transition from FIG. 7B in response to detecting a gaze input by user 7002 directed at the browser toolbar 7040 while hand 7020 is in the ready state “A”. In response to detecting the gaze input by user 7002 directed at the browser toolbar 7040 while hand 7020 is in the ready state in FIG. 7B, browser toolbar 7040 expands and reveals open tabs in the expanded browser toolbar 7040. For example, browser toolbar 7040 when expanded includes tab “A” 7060, tab “B” 7062, tab “C” 7064, tab “D” 7066, and tab “E” 7068 (partially visible). Side view 7024 illustrates that browser toolbar 7040 has expanded (e.g., vertically), where the expanded browser toolbar 7040 overlays content window 7030 partially, e.g., the browser toolbar 7040 occludes a portion of the content window 7030. In some embodiments, tab “A” 7060, tab “B” 7062, tab “C” 7064, tab “D” 7066, and tab “E” 7068 partially overlay browser toolbar 7040 when browser toolbar 7040 is in expanded state. Top view 7026 illustrates that position of the browser toolbar 7040 in the view of the three-dimensional environment 7000′ has not changed as a result of increasing a length of the browser toolbar 7040. In some embodiments, when browser toolbar 7040 expands, the browser toolbar 7040, including any open tabs displayed therein, move towards user 7002 in the “z” direction. In some embodiments, when browser toolbar 7040 expands, content window 7030 is dimmed and moved further away from user 7002. In some embodiments, browser toolbar 7040 is partially transparent. In some embodiments, when browser toolbar 7040 expands, corners of browser toolbar 7040 change relative to the corners of browser toolbar 7040 when in collapsed state.

In some embodiments, browser toolbar 7040 expands and/or tab “A” 7060, tab “B” 7062, tab “C” 7064, tab “D” 7066, and tab “E” 7068 are revealed in response to a gaze input directed at a control element (e.g., a button) in conjunction with an air pinch gesture.

In some embodiments (but not shown in FIG. 7C), in response to detecting the gaze input by user 7002 directed at the browser toolbar 7040 while hand 7020 is in the ready state in FIG. 7B, browser toolbar 7040 remains in a collapsed state and tab “A” 7060, tab “B” 7062, tab “C” 7064, tab “D” 7066, and tab “E” 7068 are displayed in the view of the three-dimensional environment 7000′ separately from browser toolbar 7040. In some embodiments, when tab “A” 7060, tab “B” 7062, tab “C” 7064, tab “D” 7066, and tab “E” 7068 are displayed separately from browser toolbar 7040, tab “A” 7060, tab “B” 7062, tab “C” 7064, tab “D” 7066, and tab “E” 7068 are displayed at least partially overlaying content window 7030.

In some embodiments, for browser toolbar 7040 to expand, it is not necessary that user 7002 gazes at a particular portion of the browser toolbar 7040. For example, browser toolbar 7040 expands and reveals open tabs “A”-“E” 7060-7068 when user 7002 gazes at any portion of browser toolbar 7040 while hand 7020 is in the ready state. In some embodiments, for browser toolbar 7040 to expand, it is necessary that user 7002 gazes at a particular portion of the browser toolbar 7040, such as address bar 7042 or other field for searching the web. In some embodiments, for browser toolbar 7040 to expand, it is necessary that user 7002 gazes at a location in the three-dimensional environment that is occupied by a portion of browser toolbar 7040 for at least a threshold amount of time while hand 7020 is in the ready state. This allows the computer system 101 to disambiguate between intentional air gestures for interacting with browser toolbar 7040 and incidental or quick gazes that are not intended to expand or otherwise interact with the browser toolbar 7040.

In some embodiments, tab “A” 7060, tab “B” 7062, tab “C” 7064, tab “D” 7066, and tab “E” 7068 show corresponding sources or names of webpages that are associated with the tab “A” 7060, tab “B” 7062, tab “C” 7064, tab “D” 7066, and tab “E” 7068, respectively (e.g., as opposed to showing content of the associated webpages). In some embodiments, content window 7030 includes content of a currently active tab. In FIG. 7C, content window 7030 includes webpage content of a webpage associated with tab “A” 7060.

FIG. 7C further illustrates that while user 7002 gazes (e.g., continues to gaze) at browser toolbar 7040 and hand 7020 remains in the ready state “A”, the browser toolbar 7040 remains in expanded state. In some embodiments, if the gaze of user 7002 (the one that expanded browser toolbar 7040) moves away from browser toolbar 7040, the browser toolbar 7040 would collapse back to its unexpanded state, for example as shown in FIG. 7B. For example, if user 7002 interacts with the webpage visible in content window 7030 (e.g., if user 7002 scrolls the webpage or selects a link in the webpage), then browser toolbar 7040 would collapse to its unexpanded state. In some embodiments, if the gaze of user 7002 moves away from the browser toolbar 7040 and then the gaze of user 7002 quickly returns to a location in the three-dimensional environment 7000′ that is occupied by a portion of the browser toolbar 7040 (e.g., within a predetermined amount of time), then the browser toolbar 7040 does not collapse to its unexpanded state. In some embodiments, for browser toolbar 7040 to collapse, the gaze of user 7002 must be directed at a location in the three-dimensional environment 7000′ that is not occupied by the browser toolbar 7040 at least for a predetermined amount of time, e.g., collapsing the browser toolbar 7040 is delayed until a threshold amount of time passes without the gaze of user 7002 returning to the browser toolbar 7040. In some embodiments, in response to user 7002 interacting with user interfaces that are different from the browser toolbar 7040, such as content window 7030 or applications other than the browser application, the browser toolbar 7040 collapses without delay (e.g., immediately without the need to pass a time threshold). In some embodiments, the browser toolbar 7040 collapses without delay when user 7002 gazes at a predetermined region of content window 7030 (e.g., center of window 7030 or lower). In some embodiments, if hand 7020 is no longer engaged in ready state “A” or otherwise engaged (e.g., when hand 7020 is not performing a gesture or is outside the field of view of the cameras), browser toolbar 7040 collapses.

In some embodiments, browser toolbar 7040 is automatically hidden from view, and thus not included in the displayed view of the three-dimensional environment 7000′ when (e.g., in accordance with a determination that) attention of user 7002 is not directed at content window 7030 (optionally for at least a predetermined amount of time), e.g., when the gaze of user 7002 moves in a direction away from content window 7030 and away from browser toolbar 7040. In some embodiments, after hiding browser toolbar 7040, the browser toolbar is automatically redisplayed in the displayed view of the three-dimensional environment 7000′ when the user's gaze or attention of user 7002 is re-directed again at content window 7030.

FIG. 7D (e.g., FIGS. 7D1-7D3) (e.g., where a user interface analogous to the user interface described in FIG. 7D3 is shown on HMD 7100a in FIG. 7D1) illustrates user 7002 gazing at tab “D” 7066 while hand 7020 is in ready state (initially). In response to detecting the gaze input of user 7002 directed at tab “D” 7066 while the hand 7020 is maintained in ready state “A”, tab “D” 7066 pops out (in the “z” direction), e.g., moves towards user 7002 to provide visual feedback to user 7002 that the user's focus is on tab “D” 7066, as illustrated in side view 7024. In some embodiments, tab “D” 7066 separates from browser toolbar 7040 in response to the gaze input directed at tab “D” 7066 while hand 7020 is in the ready state. In some embodiments, if user 7002 ceases to maintain hand 7020 in ready state (e.g., taking hand 7020 out of field of view or lowering the position of hand 7020), tab “D” 7066 is moved by the computer system 101 back to the location tab “D” 7066 was in prior to popping out, browser toolbar 7040 is collapsed, and tabs A-E 7060-7068 is hidden, respectively. In some embodiments, if user 7002 ceases to maintain hand 7020 in the ready state (state “A”), the computer system 101 collapses browser toolbar 7040 even if the gaze of user 7002 is directed at browser toolbar 7040. Further, FIG. 7D (e.g., 7D1-7D3) illustrates user 7002 performing an air pinch gesture (shown with arrows near hand 7020) while the gaze of user 7002 is directed tab “D” 7066. Gazing at tab “D” 7066 puts tab “D” 7066 in focus, and the air pinch gesture, performed while the gaze is maintained at tab “D” 7066, selects tab “D” 7066.

In some embodiments, in FIG. 7D (e.g., FIGS. 7D1-7D3), if user 7002 gazes at browser toolbar 7040 while browser toolbar 7040 is in the expanded state, and user 7002 swipes their hand 7020 in a leftward or rightward direction, open tabs “A”-“E” 7060-7068 in browser toolbar 7040 are scrolled, e.g., previously undisplayed open tabs are revealed and one or more of tab “A” 7060, tab “B” 7062, tab “C” 7064, tab “D” 7066, and tab “E” 7068 are hidden to make room for the revealed tabs. In some embodiments, in FIG. 7D (e.g., FIGS. 7D1-7D3) if user 7002 gazes at browser toolbar 7040 while browser toolbar 7040 is in expanded state (and prior to selecting tab “D” 7066), and user 7002 swipes their hand 7020 in a leftward or rightward direction, then computer system 101 switches from tab “A” 7060 to the next (adjacent tab), e.g., switches from tab “A” 7060 to tab “B” 7062 as the currently active tab. In some embodiments, switching from tab “A” 7060 to tab “B” 7062 also changes webpage content displayed in content window 7030. In some embodiments, while browser toolbar 7040 is in expanded state, user 7002 can grab and drag a tab from tabs “A”-“E” 7060-7068 to create a new window with content of the dragged tab. For example, user 7002 can reach out and pinch tab “B” 7062 (e.g., pinch at a location in the view of the three-dimensional environment 7000′ where tab “B” 7062 is located) and drag the pinched tab “B” 7062 out of browser toolbar 7040 to create a new content window that includes webpage content associated with tab “B” 7062. Alternatively, user 7002 can perform an air pinch gesture with hand 7020 while gazing at tab “B” 7062 and then move hand 7020 while holding the air pinch gesture to drag tab “B” 7062 out of browser toolbar 7040, where upon release of the air pinch gesture, a new content window that includes webpage content associated with tab “B” 7062 is created.

FIG. 7E illustrates transition from FIG. 7D (e.g., FIGS. 7D1-7D3) in response to detecting the air pinch gesture while the gaze of user 7002 is directed at tab “D” 7066. In response to detecting the air pinch gesture while the gaze of user 7002 is directed at tab “D” 7066 (e.g., as shown in FIGS. 7D), tab “D” 7066 is selected and a webpage that is associated with tab “D” 7066 becomes active, where content window 7030 of tab “A” 7060 is replaced with content window 7050 of tab “D” 7066, as shown in FIG. 7E. Further, upon switching from tab “A” 7060 to tab “D” 7066, browser toolbar 7040 collapses and tab “A” 7060, tab “B” 7062, tab “C” 7064, tab “D” 7066, and tab “E” 7068 are hidden from the view of the three-dimensional environment 7000′ (also illustrated by the reduced size of toolbar 7040 in side view 7024). In some embodiments, content of the webpage displayed in content window 7050 can be scrolled in response to a gaze input directed at a location in the three-dimensional environment occupied by content window 7050 and a directional move of the user's hand 7020 (e.g., up, down, left, or right) while maintaining an air pinch gesture (e.g., a pinch without release). In some embodiments, browser toolbar 7040 collapses and/or tabs “A”-“E” 7060-7068 are hidden in response to a further input by user 7002 (e.g., one that occurs after the input selecting tab “D” 7066). Such further input by user 7002 can be a scrolling input in response to which content of content window 7050 is scrolled or an input selecting a link displayed in content window 7050.

FIGS. 7B-7E illustrate a normal browsing mode, e.g., as opposed to a tab overview mode (illustrated in FIG. 7F-7I) or a fast tab switching mode (illustrated in FIGS. 7N-7Y), according to some embodiments.

FIGS. 7F-7I illustrate example techniques for displaying and using an overview of multiple content items of the same kind in a three-dimensional environment.

FIG. 7F illustrates user 7002 gazing at tab overview button 7054 while hand 7020 is in the ready state (at least initially). Tab overview button 7054 for activating a tab overview mode is displayed in browser toolbar 7040. In response to detecting the gaze input of user 7002 directed at tab overview button 7054 while hand 7020 is maintained in ready state “A”, tab overview button 7054 pops out (moves in the “z” direction), e.g., tab overview button 7054 moves towards user 7002, to provide visual feedback to user 7002 that the user's focus is on tab overview button 7054, as illustrated in side view 7024. In some embodiments, tab overview button 7054 separates from browser toolbar 7040 in response to the gaze input directed at tab overview button 7054 while hand 7020 is in ready state. In some embodiments, if user 7002 ceases to maintain hand 7020 in ready state (e.g., taking hand 7020 out of the field of view or lowering the position of hand 7020), tab overview button 7054 moves back to the location tab overview button 7054 was in prior to popping out, browser toolbar 7040 collapses and tabs “A”-“E” 7060-7068 are also hidden, respectively.

Further, FIG. 7F illustrates user 7002 performing an air pinch gesture (shown with arrows near hand 7020) while the gaze of user 7002 is directed tab overview button 7054. Gazing at tab overview button 7054 puts tab overview button 7054 in focus, and the air pinch gesture, performed while tab overview button 7054 is in focus, selects tab overview button 7054.

FIG. 7G illustrates transition from FIG. 7F in response to detecting the air pinch gesture while the gaze of user 7002 is directed at tab overview button 7054. In response to detecting the air pinch gesture while the gaze of user 7002 is directed at tab overview button 7054, a tab overview mode is activated. In some embodiments, in the tab overview mode, as shown in FIG. 7G, multiple open tabs are concurrently displayed in the three-dimensional environment 7000′. For example, in the tab overview mode, content window 7030 is hidden (or removed) from the view of the three-dimensional environment 7000′ and replaced with reduced scale representations of webpages that are associated with currently open tabs. For example, reduced scale representations of webpage “A” 7070, webpage “B” 7072, webpage “C” 7074, webpage “D” 7076, webpage “E” 7078, and webpage “F” 7080 are displayed in place of content window 7030, where webpage “A” 7070 is associated with open tab “A” 7060, webpage “B” 7072 is associated with open tab “B” 7062, webpage “C” 7074 is associated with open tab “C” 7064, webpage “D” 7076 is associated with open tab “D” 7066, webpage “E” 7078 is associated with open tab “E” 7068, and webpage “F” 7080 is associated with open tab “F” (tab “F” is not visible in FIG. 7F due to limited space in browser toolbar 7040, but tab “F” can be revealed in browser toolbar 7040 in response a scrolling request). In the tab overview mode, reduced scale representations of webpage “A” 7070, webpage “B” 7072, webpage “C” 7074, webpage “D” 7076, webpage “E” 7078, and webpage “F” 7080 are displayed in a grid 7045 to provide an overview of currently open webpages. In some embodiments, position of grid 7045 in the view of the three-dimensional environment 7000′ is based on location of content window 7030, or the location of browser toolbar 7040, or the location of another feature of the browser application. In some embodiments, in the tab overview mode, user 7002 can select a target webpage from webpages “A”-“F” 7070-7080 (e.g., via an air pinch gesture in conjunction with a gaze input directed at the target webpage) and drag it out from grid 7045.

In some embodiments, an animation is provided when transitioning from the normal browsing mode in FIG. 7F to the tab overview mode in FIG. 7G. For example, in the transition animation, content window 7030 can fly up (optionally until it disappears) while also tilting toward user 7002 and browser toolbar 7040 can fly down. In some embodiments, visual prominence of the view of the three-dimensional environment 7000′ that is not occupied by the browser application is reduced in response to entering the tab overview mode. For example, the view of the three-dimensional environment 7000′ other than the browser toolbar 7040 and webpages “A”-“F” 7070-7080 is darkened, blurred, or hidden.

In some embodiments, the tab overview mode for the browser application can be activated by an air pinch gesture (e.g., an inward pinch) performed with two hands. For example, each hand 7020 and 7022 can maintain an air pinch gesture (e.g., an index finger in contact with a thumb finger) and the pinched fingers on hand 7020 are brought into contact with or towards the pinched fingers on hand 7022. In some embodiments, the tab overview mode for the browser application can be activated by a double air pinch gesture, where a second air pinch gesture follows a first air pinch gesture within a threshold amount of time. In some embodiments, if the consecutive air pinch gestures are not performed with the threshold amount of time, then respective air pinch gestures are interpreted by the computer system as separate selection inputs (e.g., selecting a link or playing a video, or other type of selection operation, depending on location of a focus selector).

In some embodiments, in the tab overview mode, webpages displayed in the first column and last column of the grid 7045 are angled toward user 7002. For example, webpage “A” 7070 and webpage “D” 7076 on the left side (or first column), and webpage “C” 7074 and webpage “F” 7080 on the right side (or last column) are displayed angled towards user 7002, as also illustrated in side view 7024. In some embodiments, sizes of webpages “A”-“F” 7070-7080 are determined based on the number of open tabs. In some embodiments, webpages displayed in a grid 7045 in the overview mode can be scrolled vertically or horizontally, or both, to reveal webpages that were previously undisplayed. In some embodiments, webpages of all currently open tabs are displayed in the grid 7045, and the grid 7045 of webpages is not scrollable. In some embodiments, if webpages “A”-“F” 7070-7080 are included in one or more webpage groups, those webpage groups are also displayed in the overview mode. In some embodiments, a vertical space that the grid 7045 takes up in the view of the three-dimensional environment 7000′ is the same, regardless of the number of open tabs for which webpages are displayed, e.g., grid 7045 increases in size horizontally, but not vertically, if the number of open tabs increases.

In some embodiments, in response to the air pinch gesture while the gaze of user 7002 is directed at tab overview button 7054, the computer system, in addition to activating the tab overview mode, changes what is displayed in browser toolbar 7040. For example, browser toolbar 7040 collapses and enters a tab search mode (e.g., as shown in FIG. 7G) in which different user interface elements and controls are included in the displayed browser toolbar 7040 (e.g., one or more controls that are displayed in the browser toolbar 7040 when in the normal browsing mode are removed when the browser application is in the tab overview mode, and/or one or more controls that are not available in the normal browsing mode are displayed in browser toolbar 7040 when the browser application is in the tab overview mode). For example, in the tab search mode of browser toolbar 7040, sidebar button 7044, back button 7046, forward button 7048, tab overview button 7054, and share button 7051 are removed from browser toolbar 7040. Further, in the tab search mode of browser toolbar 7040, address bar 7042 for entering a web page address is replaced with a search field 7082 for receiving or entering a search query, which in turn is used for searching currently open webpages and tabs for content matching or satisfying the search query. In addition, in some embodiments, while the browser is in tab overview mode, done button 7084, for exiting the tab overview mode, is displayed in browser toolbar 7040. In response to selecting done button 7084, the browser application exits the tab overview mode, and browser toolbar 7040 also exits the tab search mode. Tab button 7052 for adding new tabs remains displayed in browser toolbar 7040 in both the normal browsing mode and the tab overview mode. In some embodiments, the browser toolbar 7040 can expand and display tabs “A”-“F” 7070-7080 in response to a gaze input by user 7002 directed at search field 7082 while hand 7020 or hand 7022 is in ready state, as shown in FIG. 7G. In some embodiments, in addition to displaying multiple tabs in the tab overview mode, browser toolbar 7040 is removed from display, as shown in FIG. 7G.

In some embodiments, if user interfaces of other applications were displayed/visible in the view of the three-dimensional environment 7000′ prior to entering the tab overview mode (e.g., the user interface of other application are displayed concurrently with content window 7030), the user interfaces are removed from the view of the three-dimensional environment 7000′ when the tab overview mode is activated for the browser application.

FIG. 7H illustrates that, while the browser application is the in the tab overview mode, user 7002 performs an air pinch gesture with hand 7020 (illustrated with arrows near hand 7020) in conjunction with a gaze input directed at webpage “F” 7080 (e.g., focusing attention on a location in the view of the three-dimensional environment that is occupied by reduced scale representation of webpage “F” 7080).

FIG. 7I illustrates a transition from FIG. 7H in response to detecting the gaze input by user 7002 directed at webpage “F” 7080 in conjunction with performing the air pinch gesture with hand 7020. In response to detecting the gaze input by user 7002 directed at webpage “F” 7080 in conjunction with the air pinch gesture performed with hand 7020, webpage “F” 7080 is selected to be an active webpage for the browser application. Further, the browser application exits the tab overview mode and content window 7090 for content of webpage “F” 7080 replaces the grid 7045 of reduced scale representation of webpages “A”-“F” 7070-7080. Further, browser toolbar 7040 exits tab search mode and browser toolbar 7040 is displayed in a collapsed state. In some embodiments, content of webpage “F” 7080 that is displayed in content window 7090 can change in response to a scrolling input or other input by user 7002. In some embodiments, content of webpage “F” 7080 that is displayed in content window 7090 can change in response to a selection input by user 7002 that selects a link displayed in content window 7090.

FIG. 7J illustrates the browser application in a normal browsing mode, where open tabs are displayed on each side of browser toolbar 7040 (e.g., separately from browser toolbar 7040) instead of within an expanded browser toolbar 7040 as in FIG. 7C. For example, tab “A” 7060 is displayed on the left side of browser toolbar 7040 and tab “B” 7062 is displayed on the right side of browser toolbar 7040. As shown in top view 7026, browser toolbar 7040 is spaced apart from content window 7030, e.g., browser toolbar 7040 is separated from content window 7030 in a “z” direction, such that browser toolbar 7040 and content window 7030 are displayed at different depths in the view of the three-dimensional environment 7000′. For example, browser toolbar 7040 is displayed closer to a viewpoint of user 7002 than content window 7030, e.g., the distance from content window 7030 to user 7002 (or other reference point) is greater than the distance from browser toolbar 7040 to user 7002 (or the same reference point). In this example, tab “A” 7060 and tab “B” 7062 are displayed at the same depth at which browser toolbar 7040 is displayed from the viewpoint of user 7002. As illustrated in FIG. 7J, webpage content “A,” which is associated with tab “A” 7060 is displayed in content window 7030, where tab “A” 7060 is a currently active tab for the browser application. For example, the tab that is displayed on the left side of browser toolbar 7040 is the currently active tab for the browser application (e.g., tab “A” 7060) and the tab that is displayed on the right side of browser toolbar is the next tab in a sequence of open tabs for the browser applications (e.g., tab “B” 7062).

FIG. 7J further illustrates that while user 7002 is gazing at (e.g., focusing attention on) a location in the view of the three-dimensional environment that is occupied by browser toolbar 7040, hand 7020 performs an air pinch gesture (denoted with state “B”) in conjunction with movement of hand 7020 in a leftward direction (denoted with a punctuated arrow), followed by a release of the air pinch gesture at the end of the leftward movement of hand 7020 (denoted with state “C”).

FIG. 7K illustrates a transition from FIG. 7J in response to detecting the user input described above in relation to FIG. 7J. For example, in response to detecting the gaze input by user 7002 directed at browser toolbar 7040 in conjunction with hand 7020 maintaining the air pinch gesture while hand 7020 moves in the leftward direction, followed by the release of the air pinch gesture, tab “B” 7062 becomes the currently active tab, moving tab “B” 7062 from the right to the left side of the browser toolbar 7040, thereby replacing tab “A” 7060 and revealing tab “C” 7064 on the right side of browser toolbar 7040, previously occupied by tab “B” 7062. Accordingly, the next tab in the sequence of open tabs (e.g., tab “B” 7062, which is next after tab “A” 7060 in the sequence of open tabs) becomes the currently active tab for the browser application.

FIG. 7L illustrates user 7002 gazing at tab browsing button 7094 for activating tabbed browsing while hand 7020 is (initially) in the ready state. Tab browsing button 7094 is displayed in browser toolbar 7040. In response to detecting the gaze input directed at tab browsing button 7094 while hand 7020 is maintained in the ready state, tab browsing button 7094 pops out (in the “z” direction), e.g., tab browsing button 7094 moves towards user 7002 to provide visual feedback to user 7002 that the user's focus is on tab browsing button 7094, as illustrated in side view 7024. In some embodiments, if user 7002 ceases to maintain hand 7020 in the ready state (e.g., by taking hand 7020 out of the field of view or lowering the position of hand 7020), tab browsing button 7094 would move back to the location tab browsing button 7094 was in prior to popping out (e.g., it would move back to the same depth as browser toolbar 7040, from the viewpoint of user 7002).

Further, FIG. 7L illustrates user 7002 performing an air pinch gesture (shown with arrows near hand 7020) while the gaze of user 7002 is directed at tab browsing button 7094. Gazing at tab browsing button 7094 puts tab browsing button 7094 in focus, and performing the air pinch gesture with hand 7020 while the tab browsing button 7094 is in focus causes the computer system 101 to select tab browsing button 7094 and to activate a tabbed browsing mode.

FIG. 7M (e.g., FIGS. 7M1 and FIG. 7M2, where a user interface analogous to the user interface described in FIG. 7M1 is shown on HMD 7100a in FIG. 7M2) illustrates a transition from FIG. 7L in response to detecting the air pinch gesture while the gaze of user 7002 is directed at tab browsing button 7094. In response to detecting the air pinch gesture while the gaze of user 7002 is directed at tab browsing button 7094, a tabbed browsing mode is activated and open tabs “A”-“E” 7060-7068 are revealed. In some embodiments, tabs “A”-“E” 7060-7068 are displayed in expanded browser toolbar 7040. In some embodiments, tabs “A”-“E” 7060-7068 are displayed separately from browser toolbar 7040, e.g., floating in the view of three-dimensional environment 7000′ (e.g., below or under browser toolbar 7040). Tabs “A”-“E” 7060-7068 are displayed at least partially overlaying content window 7030, which includes content of the currently active webpage associated with tab “A” 7060. In some embodiments, tabs “A”-“E” 7060-7068 correspond to reduced scale representations of webpages. For example, the contents of webpages associated with tabs “A”-“E” 7060-7068 are displayed in tabs “A”-“E” 7060-7068, respectively, at reduced scale, for example, as opposed to regular scale if displayed in content window 7030. In some embodiments, webpage logos or other information identifying a source of the webpage is displayed in tabs “A”-“E” 7060-7068 in the tabbed browsing mode. In some embodiments, browser toolbar 7040 is semi-transparent, where content window 7030 is visible through browser toolbar 7040. In some embodiments, tabs “A”-“E” 7060-7068 are scrolled in response to a gaze input at browser toolbar 7040 (or directed at a portion of the view of the three-dimensional environment 7000′ that is occupied by one or more of tabs “A”-“E” 7060-7068) in conjunction with an air pinch and drag gesture. In some embodiments, user 7002 can instruct the computer system 101 to exit the tabbed browsing mode by focusing attention on content window 7030 or on portion of the view of the three-dimensional environment 7000′ other than browser toolbar 7040. In some embodiments, user 7002 can instruct the computer system 101 to exit the tabbed browsing mode by selecting a tab from tabs “A”-“E” 7060-7068.

Additional descriptions regarding FIGS. 7A-7M3 are provided below in reference to methods 800 and 900 described with respect to FIGS. 8 and 9.

FIGS. 7N-7Y3 illustrate examples of quick switching between tabbed windows in a three-dimensional environment. FIG. 10 is a flow diagram of an example method 1000 for quick switching between tabbed windows in a three-dimensional environment. The user interfaces in FIGS. 7N-7Y3 illustrate the processes described below, including the processes described herein with reference to FIG. 10. Further, FIGS. 7N-7Y3 illustrate example techniques for viewing an overview of multiple content items of the same kind in a three-dimensional environment while reducing visual prominence of remaining portions of the view of the three-dimensional environment. FIG. 11 is a flow diagram of an example method 1100 for spatially positioning and dynamically changing a browser toolbar while interacting with a browser application in a three-dimensional environment. The user interfaces in FIGS. 7N-7Y illustrate the processes described below, including the processes described herein with reference to FIG. 11.

FIG. 7N illustrates a browser application in a view of a three-dimensional environment 7000′ that is visible to user 7002 via display generation component 7100. The browser application, which is in a normal browsing mode, is visible to user 7002 via display generation component 7100. Browser toolbar 7040 of the browser application is optionally displayed spaced apart from content window 7030 of the browser application, as illustrated in side view 7024. For example, browser toolbar 7040 is separated from content window 7030 in a “z” direction, such that browser toolbar 7040 and content window 7030 are displayed at different depths in the view of the three-dimensional environment 7000′. In some embodiments, browser toolbar 7040 includes a control for searching for user-specified content in currently open tabs. In some embodiments, browser toolbar 7040 includes a control for adding a new tab, e.g., tab button (e.g., control) 7052. Content window 7030 includes webpage content associated with tab “A” 7060, where tab “A” 7060 is a currently active tab for the browser application. In some embodiments, browser toolbar 7040 can appear and disappear in the normal browsing mode in response to various user actions or instructions, for example instructions in the form of a user's gaze and air gestures.

In some embodiments, browser toolbar 7040 is hidden from view of the three-dimensional environment 7000′ in response to user 7002 shifting their gaze away from the browser toolbar and/or content window 7030 for more than a predetermined amount of time (e.g., more than 1, 2, or more seconds). In some embodiments, browser toolbar 7040 is redisplayed if the focus of the user 7002 is directed to (e.g., while the user 7002 is gazing at) the browser application or at a location that was previously occupied by browser toolbar 7040 for more than a predetermined amount of time, e.g., a first threshold amount of time. In some embodiments, the browser toolbar 7040 dynamically changes (e.g., expanding to include additional or different controls) when focus of user 7002 is maintained directed at browser toolbar 7040 for more than a second threshold amount of time, where the second threshold amount of time is more than the first threshold amount of time.

FIG. 7N further illustrates movement of hand 7020 of user 7002 along z-axis 7206 (e.g., further away from user 7002 in a depth-wise direction) while hand 7020 maintains an air pinch gesture (e.g., an index finger and a thumb finger of hand 7020 are in contact), denoted with state “B” and arrows near hand 7020. View 7200 illustrates a representation of a three-dimensional coordinate system of the three-dimensional environment (e.g., a Cartesian coordinate system as shown in view 7200, or another coordinate system such as a radial coordinate system; the Cartesian coordinate system shown in FIG. 7N is based on three mutually perpendicular coordinate axes: the x-axis 7202, the y-axis 7204, and the z-axis 7206). Movement of hand 7020 (distance and direction) in the three-dimensional environment 7000 is illustrated with a punctuated arrow in the coordinate system of the three-dimensional environment (e.g., a Cartesian coordinate system as shown in view 7200, or another coordinate system such as a radial coordinate system). If movement of hand 7020 along axis 7206 reaches point 7208, the browser application switches from a normal browsing mode to a quick tab switching mode, in accordance with some embodiments.

FIG. 7O illustrates a transition from FIG. 7N in response to detecting the movement of hand 7020 along the z-axis 7206 while hand 7020 maintains the air pinch gesture (denoted with arrows near hand 7020 and state “B”). In response to detecting the movement of hand 7020 along the z-axis 7206 while hand 7020 maintains the air pinch gesture, content window 7030 is moved along z-axis 7206 in accordance with movement of hand 7020 along z-axis 7206. For example, content window 7030 is moved further away from user 7002 or a viewpoint of user 7002. Further, concurrently with moving content window 7030 along z-axis 7206, the size of content window 7030 is reduced based on the movement of hand 7020 along z-axis 7206. In some embodiments, if browser toolbar 7040 was displayed when the movement of hand 7020 along z-axis 7206 was detected, browser toolbar 7040 is removed or hidden from the view of the three-dimensional environment 7000′ in response to detecting the movement of hand 7020 along the z-axis 7206 while hand 7020 maintains the air pinch gesture, as illustrated in side view 7024.

Point 7208 represents a distance away from user 7002 (or viewpoint of user 7002. When the hand movement along z-axis 7206 reaches point 7208, a fast tab switching mode is activated. In some embodiments, the fast tab switching mode is activated when hand 7020 reaches another predetermined threshold, e.g., one that is optionally based on other criteria, such as velocity and/or direction. In some embodiments, fast tab switching mode is activated based on more than one criterion, such as criteria based, at least in part, on distance, speed, and/or direction of the user's hand movement (e.g., along z-axis 7206).

FIG. 7P illustrates a transition from FIG. 7O in response to detecting further movement of hand 7020 along the z-axis 7206 while hand 7020 maintains the air pinch gesture. As illustrated in FIG. 7P, size of content window 7030 continues to be reduced and content window 7030 continues to be moved along z-axis 7206 in accordance with movement of hand 7020 along the z-axis 7206 until hand 7020 moves a predetermined distance along z-axis 7206, e.g., until hand 7020 reaches point 7208 in the coordinate system of the three-dimensional environment (e.g., a Cartesian coordinate system as shown in view 7200, or another coordinate system such as a radial coordinate system), or until hand 7020 reaches another threshold at which fast tab switching mode is activated. In some embodiments, audio feedback is provided that increases in volume as the hand movement along z-axis 7206 gets closer to the threshold where the fast tab switching mode is activated, e.g., as hand 7020 gets closer to point 7208. In some embodiments, when the hand movement along z-axis 7206 gets closer to the threshold where the fast tab switching mode is activated, the audio is stopped, providing feedback that the threshold at which the fast tab switching mode is activated had been reached.

FIG. 7Q illustrates a transition from FIG. 7P in response to detecting that the movement of the hand 7020 reaches a respective threshold at which a fast tab switching mode is activated (or where other gesture criteria is satisfied for activating the fast tab switching mode). For example, the fast tab switching mode is activated in response to detecting that hand 7020 is moved a predetermined amount of distance along z-axis 7206, reaching point 7208 in the coordinate system of the three-dimensional environment (e.g., a Cartesian coordinate system as shown in view 7200 in FIG. 7P, or another coordinate system such as a radial coordinate system). In response to activating the fast tab switching mode, multiple (tabbed) content windows are displayed. For example, content window 7030 for webpage “A”, content window 7102 for webpage “B”, content window 7104 for webpage “C”, content window 7106 for webpage “Z”, and content window 7108 for webpage “Y” are displayed in response to activating the fast tab switching mode (e.g., in response to the hand movement along z-axis 7206 that reaches respective threshold for activating the fast tab switching mode). In some embodiments, content windows 7030, 7102, 7104, 7106, and 7108 are displayed in a virtual region in the view of the three-dimensional environment 7000′, e.g., a fast tab switcher region 7240, where the fast tab switcher region 7240 is positioned in the view of the three-dimensional environment 7000′ based at least partially on a location of content window 7030 prior to detecting the movement of hand 7020 along z-axis 7206 (e.g., prior to detecting the gesture that activated the fast tab switching mode). In some embodiments, once content windows 7030, 7102, 7104, 7106, and 7108 are displayed in the fast tab switcher region 7240, the fast tab switcher region 7240 cannot be repositioned or moved to a different location in the view of the three-dimensional environment 7000′.

In some embodiments, content windows 7030, 7102, 7104, 7106, and 7108 are displayed in a carousel or loop mode, where content windows 7030, 7102, 7104, 7106, and 7108 can be scrolled or navigated through in response a scrolling or swiping input, where after the last content window in the sequence is navigated through, the navigation continues with the first content window in the sequence (e.g., content windows are navigated though in a loop, where after all content windows have been navigated through the scrolling can begin from the beginning if a further scrolling request is detected). In some embodiments, an indicator 7110 provides visual feedback indicating a number of content windows that are displayed (e.g., indicated with filled black dots) and/or a number of content windows that can be additionally revealed in response to a scrolling input (e.g., indicated with dashed dots). In some embodiments, content window 7030 for webpage “A”, which is a currently active content window for the browser application, is displayed closest to user 7002 (or viewpoint of user 7002) as illustrated in side view 7024 and top view 7220, followed by content window 7102 for webpage “B” and content window 7106 for webpage “Z”, where content window 7104 for webpage “C” and content window 7108 for webpage “Y” are displayed furthest away from user 7002. Each content window 7030, 7102, 7104, 7106, and 7108 is associated with a respective window grabber, which is a user interface element for selecting and moving a respective window in the view of the three-dimensional environment 7000′. For example, content window 7030 for webpage “A” is associated with a window grabber 7030a, content window 7102 for webpage “B” is associated with a window grabber 7102a, content window 7104 for webpage “C” is associated with a window grabber 7104a, content window 7106 for webpage “Z” is associated with a window grabber 7106a, and content window 7108 for webpage “Y” is associated with a window grabber 7108a.

In some embodiments, for the fast tab switching mode to be activated, the movement of the hand 7020 along the z-axis 7206 is required to be continuous and to satisfy movement criteria based on velocity along one or more of axes 7202-7206 within a predetermined time interval. In some embodiments, to activate the fast tab switching mode and display content windows 7030, 7102, 7104, 7106, and 7108, movement of the hand 7020 along the z-axis 7206 is performed in conjunction with maintaining an air pinch gesture throughout the movement of hand 7020 along z-axis 7206 (denoted with arrows and state “B” in FIGS. 7P-7Q). For example, to activate the fast tab switching mode, movement of the hand 7020 along the z-axis 7206 is performed in conjunction with a selection input, such as an air pinch gesture performed with one or two hands. In some embodiments, if the selection input performed with hand 7020 is stationary, e.g., the selection input is performed without movement of the hand 7020 along the z-axis 7206, a respective selection operation is performed (e.g., selection of a control or a link displayed in content window 7030 for webpage “A”). In some embodiments, if the selection input performed with hand 7020 is performed in conjunction with movement of hand 7020 along the x-axis 7202 without being preceded with movement of hand 7020 along the z-axis 7206, webpage “A” remains the currently active page and content window 7030 for webpage “A” remains displayed without activating the fast tab switching mode (e.g., without displaying content windows 7030, 7102, 7104, 7106, and 7108). In some embodiments, if the selection input performed with hand 7020 is performed in conjunction with movement of hand 7020 along the x-axis 7202 without being preceded with movement of hand 7020 along the z-axis 7206, a respective operation is performed in content window 7030 for webpage “A” (e.g., laterally scrolling content in content window 7030).

In some embodiments, for activating the fast tab switching mode, it is not necessary that movement of the hand 7020 along the z-axis 7206 is performed in conjunction with an air pinch gesture. In some embodiments, it is necessary to maintain the air pinch gesture of hand 7020 (denoted with arrows near hand 7020 and state “B”) to activate and maintain the fast tab switching mode. For example, even if the fast tab switching mode is activated in response to detecting movement of hand 7020 along the z-axis 7206 while hand 7020 maintains the air pinch gesture (e.g., state “B”), if the air pinch gesture is released, the browser application returns to the normal browsing mode, where only the currently active content window is displayed without displaying content windows associated with other open tabs, e.g., as illustrated in FIG. 7N.

In some embodiments, the computer system disambiguates the intent of user 7002 when the user makes an air gesture, for example whether to activate the fast tab switching mode in response to detecting the movement of the hand 7020 along the z-axis 7206 based at least in part on a comparison of velocity of the movement of the hand 7020 in the direction along the z-axis 7206 and the velocity of the movement of the hand 7020 in the direction along the x-axis 7202. In some embodiments, the computer system disambiguates the intent of user 7002, whether to activate the fast tab switching mode in response to detecting the movement of the hand 7020 along the z-axis 7206, based at least in part on a comparison of velocity of the movement of the hand 7020 in the direction along the z-axis 7206 and the velocity of the movement of the hand 7020 in the direction along the y-axis 7204. In some embodiments, the fast tab switching mode is activated in response to detecting movement of hand 7020 along the z-axis 7206 that has velocity that is at least as great as the velocity of a movement of hand 7020 along the y-axis 7204 multiplied by a predefined integer (e.g., 2, 3, 4, 5 or another integer).

FIG. 7R illustrates (see view 7200) movement of hand 7020 along the x-axis 7202 (e.g., from right to left) in conjunction with maintaining the air pinch gesture performed with hand 7020 (denoted with arrows and state “B”). The movement of hand 7020 along the x-axis 7202 is detected after the movement of hand 7020 along the z-axis 7206 has reached point 7208 (or has satisfied other gesture criteria for activating the fast tab switching mode) and while the fast tab switching mode is active. Movement of hand 7020 (distance and direction) along the x-axis 7202 in the three-dimensional environment 7000 is illustrated in view 7200 with a punctuated arrow parallel to the x-axis 7202 in the coordinate system of the three-dimensional environment (e.g., a Cartesian coordinate system as shown in view 7200, or another coordinate system such as a radial coordinate system).

FIG. 7S illustrates a transition from FIG. 7R in response to detecting the movement of hand 7020 along the x-axis 7202 in conjunction with maintaining the air pinch gesture. In response to detecting the movement of hand 7020 along the x-axis 7202 in conjunction with maintaining the air pinch gesture, content windows 7030, 7102, 7104, 7106, and 7108 are scrolled, leftward in this example. For example, content window 7030 is moved in leftward direction as illustrated in view 7220 in FIG. 7S. In some embodiments, content windows 7030, 7102, 7104, 7106, and 7108 are also scrolled or shifted in the leftward direction in accordance with movement of hand 7020 along the x-axis 7202. For example, content windows 7030, 7102, 7104, 7106, and 7108 are scrolled or shifted in accordance with direction and magnitude of movement of hand 7020 along the x-axis 7202. In some embodiments, scrolling speed of content window 7030 (or the set of displayed content windows, e.g., content windows 7030, 7102, 7104, 7106, and 7108) is determined based on movement of hand 7020 along the x-axis 7202, and, optionally, the scrolling speed can be modified based on a location of user's gaze. For example, if a location of the gaze of user 7002 is directed at a location in the view of the three-dimensional environment 7000′ where content window 7030 is displayed, which is the currently active content window for the browser application, then content windows 7030, 7102, 7104, 7106, and 7108 are scrolled with a first speed. For example, if the gaze of user 7002 is directed at a center of fast tab switcher region 7240 or somewhere along or near central line 7260, as illustrated in FIG. 7R, then content windows 7030, 7102, 7104, 7106, and 7108 are scrolled with the first speed. The first speed is a base scrolling speed that can be increased in response to shifting the gaze of user 7002 in the same direction as a direction of movement of hand 7020 along the x-axis 7202 (e.g., same hand movement that causes the scrolling). For example, if the gaze of user 7002 is shifted towards the left side or edge of fast tab switcher region 7240 while hand 7020 is moving in a leftward direction along the x-axis 7202, then the scrolling speed increases from the first scrolling speed to a second scrolling speed that is faster that the first scrolling speed. In some embodiments, if the gaze of user 7002 is further shifted towards line 7264 (which illustrates a threshold distanced away from central line 7260) while hand 7020 is moving in the leftward direction along the x-axis 7202, as illustrated in FIGS. 7S, then the scrolling speed increases from the second (or first) scrolling speed to a third scrolling speed that is faster that the second scrolling speed. In some embodiments, the second scrolling speed is determined by multiplying the first scrolling speed by a first integer number higher than 1 (or other multiplier different than 1), and the third scrolling speed is determined by multiplying the first speed by a second integer number higher than 1 (or other multiplier different than 1), where the second integer is higher than the first integer.

In some embodiments, if the gaze of user 7002 is shifted from content window 7030 in a direction opposite of the direction of movement of hand 7020 along the x-axis 7202 (e.g., the gaze input shifts toward right side of fast tab switcher region 7240 or right line 7262), then the scrolling speed is not increased, and scrolling continues to occur at the first scrolling speed in accordance with movement of hand 7020 along the x-axis 7202. In some embodiments, after the initial lateral movement of hand 7020 along the x-axis 7202 in the leftward direction, scrolling can be maintained based on user's gaze only, e.g., once scrolling is initiated, hand 7020 does not have to continuously move laterally along the x-axis 7202 for scrolling to occur, if the gaze of user 7002 is directed towards line 7264 (or, alternatively, toward the left side of fast tab switcher region 7240). In some embodiments, after the initial lateral movement of hand 7020 along the x-axis 7202 in the leftward direction, scrolling can be maintained by maintaining the air pinch gesture and holding hand 7020 at an ending position of the lateral movement of hand 7020 along the x-axis 7202, e.g., similar to a swipe and hold, where the lateral movement of hand 7020 along the x-axis 7202 correspond to the swipe and maintaining the air pinch at the ending position corresponds to the hold. Accordingly, once scrolling is initiated, hand 7020 does not have to continuously move laterally along the x-axis 7202 for scrolling to continue.

In some embodiments, if termination of the air pinch gesture is detected while content window 7030 has shifted away from central line 7260, but before content window 7030 has reached a position in the fast tab switcher region 7240 that corresponds to the position of content window 7106 before the current scrolling operation began (as illustrated in FIG. 7S), then content window 7030 snaps back automatically to the central position in the fast tab switcher region 7240, where central line 7260 runs through the middle of content window 7030 and the fast tab switcher region 7240. In some embodiments, content window 7030 snaps back automatically before content window 7030 has reached a position in the fast tab switcher region 7240 that corresponds to the position of content window 7106 before the scrolling operation began in response to detecting an air pinch gesture or in response to detecting an air pinch and pull gesture.

FIG. 7T illustrates a transition from FIG. 7S in response to continuously detecting the movement of hand 7020 along the x-axis 7202 while hand 7020 maintains the air pinch gesture or in response to continuously detecting a scrolling input as described above (e.g., scrolling input based on the gaze of user 7002 or based on holding the air pinch gesture at the ending position of the lateral movement of hand 7020 along the x-axis 7202), as illustrated in side view 7024. As illustrated in FIG. 7T, content windows 7030, 7102, 7104, 7106, and 7108 continue to be scrolled, revealing content window 7109 for webpage “D” (which was previously undisplayed), where content window 7030 is moved to a position or location of content window 7106 before the scrolling, and content window 7102 is moved to a position or location of content window 7030 before the scrolling. In some embodiments, content windows 7030, 7102, 7104, 7106, 7108, and 7109 are cycled through in a loop, where content windows (previously displayed and newly revealed) are rotated within the fast tab switcher region 7240 (e.g., similar to a carousel). In some embodiments, during the scrolling, a vertical position of content windows 7030, 7102, 7104, 7106, 7108, and 7109 along the y-axis 7204 does not change, but a horizontal position of each of the content windows along the x-axis 7202 and a depth position of those windows along the z-axis 7206 does change.

Further, FIG. 7T illustrates a continuous movement of hand 7020 along the x-axis 7202 while hand 7020 maintains the air pinch gesture, as illustrated in view 7200.

FIG. 7U illustrates a transition from FIG. 7T in response to continuously detecting the movement of hand 7020 along the x-axis 7202 while hand 7020 maintains the air pinch gesture, or in response to continuously detecting a scrolling input as described above (e.g., a scrolling input based on holding the air pinch gesture at the ending position of the lateral movement of hand 7020 along the x-axis 7202). As illustrated in FIG. 7U, content windows 7030, 7102, 7104, 7106, 7108, 7109 continue to be scrolled through, where content window 7112 for webpage “E” is revealed and content windows 7108 and 7106 are hidden from view (e.g., to make room for newly displayed content windows). Further, as illustrated in FIG. 7U and in top view 7220, content window 7030 is moved to a position of content 7108 before the scrolling, content window 7102 is moved to a position of content window 7106 before the scrolling, content window 7104 is moved to a position of content window 7030 before the scrolling, content window 7109 is moved to a position of content window 7102 before the scrolling, and content window 7112 is moved to a position of content window 7104 before the scrolling. In some embodiments, an audible sound is generated whenever a different content window from content windows 7030, 7102, 7104, 7106, 7108, 7109, and 7112 is displayed or moved into a central position in fast tab switcher region 7240, e.g., the middle position relative to other content windows. For example, a clicking sound or an audible tick is generated when a new content window is moved to the central position that corresponds to a position for a content window that would become active if the scrolling is terminated. In some embodiments, content windows 7030, 7102, 7104, 7106, 7108, 7109, and 7112 are open tabs for the browser application. In some embodiments, a source indication is displayed (e.g., at a top or bottom position within each of the respective content windows, or in separate navigation region not show in this example) for content windows 7030, 7102, 7104, 7106, 7108, 7109, and 7112 when content windows 7030, 7102, 7104, 7106, 7108, 7109, and 7112 are displayed in fast tab switcher region 7240.

FIG. 7U further illustrates hand 7020 performing a termination of a selection input, e.g., release of the air pinch gesture that was maintained throughout the movement of hand 7020 along the x-axis 7202 (e.g., denoted with arrows and state “C”).

FIG. 7V illustrates a transition from FIG. 7U in response to detecting termination of the selection input (e.g., releasing of the air pinch gesture that was maintained throughout the movement of hand 7020 along the x-axis 7202). In response to detecting termination of the selection input, the content window that was located in a central position at the time the termination of the selection input was detected is selected to be a currently active content window for the browser application and the browser application reenters the normal browsing mode (e.g., displaying the currently active content window without concurrently displaying other content windows and optionally redisplaying browser toolbar 7040). For example, as illustrated in FIG. 7U, the termination of the selection input is detected when content window 7104 for webpage “C” is displayed at the center position of fast tab switcher region 7240, and, as illustrated in FIG. 7V, content window 7104 for webpage “C” is selected to be the currently active content window for the browser application, which reenters the normal browsing mode. Thus, webpage “C” becomes the currently active webpage for the browser application. As illustrated in FIG. 7V, window grabber 7104a that is displayed in the fast tab switcher region 7240 is removed when content window 7104 is selected to be the active content window for the browser application and the browser application is in the normal browsing mode.

In some embodiments, the selection of content window 7104 for webpage “C” to be the active content window for the browser application is determined in accordance with the magnitude and direction of lateral movement of hand 7020 along x-axis 7202 (e.g., as opposed to release of the air pinch gesture). In some embodiments, the selection of content window 7104 for webpage “C” to be the active content window for the browser application is determined in accordance with the magnitude and direction of lateral movement of hand 7020 along x-axis 7202 (e.g., as opposed to release of the air pinch gesture) in combination with termination of the selection input (e.g., release of the air pinch gesture). In some embodiments, the content window 7104 is selected to be active for the browser application in response to detecting movement of the hand along the z-axis 7206 towards user 7002 (e.g., similar to a push-out gesture), optionally while the air pinch gesture is maintained.

FIG. 7W illustrates a transition from FIG. 7O in response to detecting a selection input (e.g., the air pinch gesture in 7O denoted with state “B”) in conjunction with a movement of hand 7020 along z-axis 7206 that does not meet respective gesture criteria for activating the fast tab switching mode or in conjunction with other movement of hand 7020 that does not meet the respective gesture criteria. As illustrated in FIG. 7W, the browser application, including content window 7030 and optionally browser toolbar 7040 if displayed, is moved in the view of the three-dimensional environment in response to detecting a selection input (e.g., the air pinch gesture in 7O denoted with state “B”) in conjunction with movement of hand 7020 along z-axis 7206 that does not meet a respective gesture criteria for activating the fast tab switching mode or in conjunction with other movement of hand 7020 that does not meet the respective gesture criteria.

FIGS. 7X-7Y (e.g., FIGS. 7Y1-7Y3) illustrate example techniques for viewing an overview of multiple content items of the same kind in a three-dimensional environment while reducing visual prominence of remaining portions of the view of the three-dimensional environment, in accordance with some embodiments.

FIG. 7X illustrates a transition from FIG. 7P in response to detecting that the movement of the hand 7020 reaches a respective threshold where the fast tab switching mode is activated (or where other gesture criteria is satisfied for activating the fast tab switching mode as described above in relation to FIG. 7P). For example, the fast tab switching mode is activated in response to detecting that hand 7020 is moved a predetermined amount of distance along z-axis 7206, reaching point 7208 in the coordinate system of the three-dimensional environment (e.g., a Cartesian coordinate system as shown in view 7200 in FIG. 7P, or another coordinate system such as a radial coordinate system). In some embodiments, the fast tab switching mode is activated in response to detecting movement of hand 7020 along z-axis 7206 that satisfies various gesture criteria, including magnitude, velocity, a respective configuration of hand 7020 while performing the movement of hand along the z-axis 7206 (e.g., an air pinch gesture), or a combination of two or more such criteria.

In some embodiments, in response to activating the fast tab switching mode, multiple (tabbed) content windows are displayed while visual prominence of remaining portions of the view of the three-dimensional environment 7000′ is reduced. For example, when the fast tab switching mode is activated (in response to detecting the movement of hand 7020 along the z-axis 7206), content windows 7102, 7104, 7106, and 7108 are displayed concurrently with the currently active content window 7030, while at the same time content window 7030 is shrunk (or its size is reduced) and portions of the view of the three-dimensional environment 7000′ that are not occupied by content windows 7030, 7102, 7104, 7106, and 7108 and corresponding window grabbers 7030a, 7102a, 7204a, 7106a, and 7108a (or other user interface related to the browser application, such as indicator 7110) are visually deemphasized. For example, representations (or optical view) of walls 7004′, 7006′, and 7008′, representation (or optical view) of physical object 7014′ and any unoccupied free space in the representation (or optical view) of the three-dimensional environment 7000′ is darkened or blurred (as illustrated in FIG. 7X) or hidden from the representation (or optical view) of the three-dimensional environment 7000′ (as illustrated in FIG. 7Y (e.g., FIGS. 7Y1-7Y3, where a user interface analogous to the user interface described in FIG. 7Y1 is shown on HMID 7100a in FIG. 7Y2).

In some embodiments, when content windows 7030, 7102, 7104, 7106, and 7108 are scrolled, e.g., in response to lateral movement of hand 7020 along the x-axis 7202 (as described in relation to FIGS. 7R-7U), the portions of the three-dimensional environment 7000′ that are not occupied by content windows 7030, 7102, 7104, 7106, and 7108 (and other user interface elements associated with the browser application) continue to be displayed with reduced visual prominence (e.g., remain darkened, blurred, or hidden).

In some embodiments, when the tab overview mode is activated, as illustrated in FIG. 7G, reduced scale representations of webpages 7070-7080 are displayed, and furthermore visual prominence of the remaining portions of the view of the three-dimensional environment 7000′ that are not associated with the browser application (e.g., browser toolbar 7040) is reduced. For example, representations (or optical view) of walls 7004′, 7006′, and 7008′, representation (or optical view) of physical object 7014′ and any unoccupied free space in the representation (or optical view) of the three-dimensional environment 7000′ is darkened or blurred or hidden from the representation of the three-dimensional environment 7000′. In some embodiments, in the tab overview mode, all open tabs are displayed concurrently (as opposed to less than all).

Additional descriptions regarding FIGS. 7N-7Y are provided below in reference to methods 1000 and 1100 described with respect to FIGS. 10 and 11.

FIG. 8 is a flow diagram of an exemplary method 800 for switching between tabbed windows in a three-dimensional environment, in accordance with some embodiments. In some embodiments, method 800 is performed at a computer system (e.g., computer system 101 in FIG. 1) that is in communication with a display generation component (e.g., display generation component 120 in FIGS. 1A, 3, and 4) (e.g., a heads-up display, a head-mounted display (HMD), a display, a touchscreen, a projector, a tablet, a smartphone, etc.) and one or more input devices (e.g., cameras, controllers, touch-sensitive surfaces, joysticks, buttons, etc.). In some embodiments, the method 800 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 800 are, optionally, combined and/or the order of some operations is, optionally, changed.

As described herein, the method 800 provides a mechanism for viewing tabbed windows and switching tabs in a mixed reality three-dimensional environment, including selecting a tab of interest in response to detecting an air gesture. An example of the air gesture used to select a respective tab is a gaze input directed to the respective tab (e.g., to put the targeted tab in focus) in conjunction with an air pinch or an air tap gesture (e.g., to perform the selection) performed while the respective tab is in focus. Optionally, open tabs are first revealed in a browser toolbar in response to a gaze input directed to the browser toolbar. For example, browser toolbar 7040 in FIG. 7B transitions from a collapsed state to an expanded state in response to a gaze by user 7002 directed at browser toolbar 7040, where, in the expanded state, open tabs 7060-7068 that were previously hidden are revealed in browser toolbar 7040 (as illustrated in FIG. 7C). In some embodiments, it is necessary that the gaze input is performed in conjunction with maintaining a hand in a ready state for the open tabs to be revealed. Switching between different opened tabs in response to an air gesture in the mixed reality three-dimensional environment provides additional control over browsing and navigating between tabs and tabbed windows without displaying (e.g., without requiring the display of) additional controls that clutter the mixed reality three-dimensional environment, and/or reduces the number of user inputs necessary to switch between tabs. Reducing the number of user inputs and providing additional control options to the user enhances the operability of the system and makes the user-system interface more efficient (e.g., by helping the user to provide proper inputs and reducing user mistakes when operating/interacting with the system), which, additionally, reduces power usage and improves battery life of the system by enabling the user to use the system more quickly and efficiently. Further, using a gaze input and an air gesture (e.g., a touchless interaction with digital content) provides an ergonomically improved gesture mechanism for switching between tabbed content items. Providing an ergonomically improved gesture mechanism makes the user-system interface more efficient which, additionally, reduces power usage and improves battery life of the system by enabling the user to use the system more quickly and efficiently.

The computer system concurrently displays (802), via the display generation component (e.g., display generation component 120), a browser toolbar (“chrome”) (e.g., a graphical user interface for exploring content, such as documents, web pages, emails, notes), for a browser (e.g., an application for searching, exploring and navigating content, such as web pages, notes, emails, documents) that includes a plurality of tabs (e.g., the plurality of opened tabs correspond to a number of selectable user interface elements for switching between content items) and a window including first content (e.g., a window that corresponds to a region that displays a content item such as a web page, a note, an email, a document, or other content) associated with a first tab of the plurality of tabs. The browser toolbar (e.g., browser toolbar 7040) and the window (e.g., content window 7030) are displayed overlaying a view of a three-dimensional environment (e.g., view of the three dimensional environment 7000′) (FIG. 7B).

In some embodiments, the browser toolbar includes one or more controls or selectable user interface elements, such as one or more of the following: navigation controls (e.g., back button 7046 and forward button 7048 in FIG. 7B), an address bar or a search bar (e.g., for providing identifying information, sometimes called a search query, that can be used by the browser application to locate desired content) (e.g., address bar 7042 in FIG. 7B, or search bar 7082 in FIG. 7G), a control for opening new tabs (e.g., tab button 7052 in FIG. 7B), a control for sharing content (e.g., share button 7051 in FIG. 7B), a control for showing all currently opened tabs (e.g., tab overview button 7054 in FIG. 7B), a control for closing all tabs, a control associated with each tab for closing the associated tab, a refresh control to update displayed content, and other controls. In some embodiments, a browser application includes a first region (e.g., content display region) in the graphical user interface dedicated for displaying browsed content (e.g., content window 7030 in FIG. 7B), and another region (e.g., toolbar display region) for displaying the browser toolbar (e.g., browser toolbar 7040 in FIG. 7B). In some embodiments, in addition to browsing, navigation, and searching functions, the browser application can be used to perform one or more other functions, examples of which include: marking content as a favorite, opening a new tab, reviewing browsing history, and activating different browsing modes (e.g., a first browsing mode is used for exploring/navigating one content item at a time, and a second browsing mode is used for exploring/previewing more than one content at a time). In some embodiments, the toolbar includes one or more controls that correspond to the one or more of the functions provided by the browser application. For example, in response to a gesture (e.g., direct, or indirect) selecting a corresponding tab (e.g., gaze input and/or a combination of gaze input and hand movement), content associated with a particular content item is displayed in the first region. For example, in response to user 7002's gaze directed at tab “D” 7066, which puts tab “D” 7066 in focus, in conjunction with an air pinch gesture performed with hand 7020 while tab “D” 7066 is in focus, content window 7050 for webpage “D” is displayed in place of content window 7030 for webpage “A” (as illustrated in FIGS. 7D-7E). In some embodiments, at least some of the tabs are visible in the browser toolbar (and can be selected) when the browser toolbar is in expanded state. In some embodiments, the number of visible tabs depends on factors such as the number of open tabs, the size of a tab, and the size of the toolbar, and/or the size of the display. In some embodiments, each tab corresponds to a content item that is opened and ready to be browsed and displayed in the first region (e.g., the content display region).

While displaying the browser toolbar (e.g. browser toolbar 7040) and the window (e.g., content window 7030) that includes the first content overlaying the view of the three-dimensional environment (e.g., view of the three dimensional environment 7000′), the computer system detects (804) a first air gesture that meets first gesture criteria, the first air gesture comprising a gaze input directed at a location in the view of the three-dimensional environment that is occupied by the browser toolbar and a hand movement. In some embodiments, the browser toolbar is displayed in an expanded state in which opened tabs are visible in the browser toolbar, where the tabs are hidden from display when the browser toolbar is in collapsed state. In some embodiments, the window and the browser toolbar are displayed in separate regions (e.g., content display region and toolbar display region) overlaying the view of the three-dimensional environment. In some embodiments, the browser toolbar region is separated from the content display region in a z dimension. In some embodiments, the gaze input is directed at a respective tab that is displayed in the browser toolbar (in the expanded state), and the hand movement (e.g., hand gesture or configuration) includes an air pinch gesture (e.g., a pinch gesture with the thumb and the index or other finger with the left or the right hand), while gazing at the respective tab to be selected. For example, user 7002's gaze directed at tab “D” 7066, which puts tab “D” 7066 in focus, in conjunction with an air pinch gesture performed with hand 7020 while tab “D” 7066 is in focus (as illustrated in FIG. 7D (e.g., FIG. 7D1-7D3)). In some embodiments, the gaze input is directed at the browser toolbar or in a region around the browser toolbar, and the hand movement includes an ongoing gesture with a first portion that is an air pinch gesture, followed by a second portion that is a drag gesture (e.g., dragging the hand while the performing the air pinch, where the gesture ends upon release of the pinch). In some embodiments, the gaze input is directed at the browser toolbar (when in expanded state), and the hand movement includes crossing the index and middle finger (e.g., by moving the fingers in opposite directions towards each other) to switch between adjacent tabs. In some embodiments, the gaze input is directed at the browser toolbar or around it, and the hand movement is a swipe gesture selecting a previous or subsequent tab in a sequence of the plurality of tabs, e.g., a lateral hand movement while optionally an air pinch gesture is maintained.

In response to detecting the first air gesture that meets the first gesture criteria, the computer system displays (806) second content in the window, the second content associated with a second tab of the plurality of tabs (e.g., transitioning from displaying the first content in the window to displaying the second content, in response to detecting the first air gesture). For example, in response to user 7002's gaze directed at tab “D” 7066, which puts tab “D” 7066 in focus, in conjunction with an air pinch gesture performed with hand 7020 while tab “D” 7066 is in focus, content window 7050 for webpage “D” is displayed in place of content window 7030 for webpage “A” (as illustrated in FIGS. 7D-7E). In some embodiments, concurrently with transitioning from displaying the first content in the window to displaying the second content window, the computer system automatically switches from the first tab to the second tab (e.g., the content displayed in the window corresponds to the associated tab that is currently selected).

Transitioning from displaying a content item associated with the first tab to displaying a content item associated with the second tab in response to an air gesture, which includes a gaze input and hand movement, reduces the number of inputs necessary to navigate multiple opened content items of the same kind, such as web pages, documents, and other content items and/or provides an ergonomically improved gesture mechanism for switching between tabs.

In some embodiments, a first set of tabs are displayed prior to detecting the first air gesture that meets the first gesture criteria. In some embodiments, the first set of tabs are displayed in an expanded browser toolbar. For example, open tabs 7060-7068 that were previously hidden are revealed in browser toolbar 7040 before detecting a gesture that switches from one tab to another tab as the active tab, as illustrated in FIG. 7C and FIG. 7M (e.g., FIGS. 7M1-7M3). In some embodiments, the first set of tabs are displayed in a separate region (e.g., overlaying at least a portion of the content currently displayed in the window). In some embodiments, the first set of tabs includes the second tab and/or the first tab. Displaying tabs that correspond to content items in a browser toolbar allows for efficient browsing of content items, as navigation between tabs in the browser toolbar causes switching of active content items that are displayed (e.g., a different tab is selected in response to an air gesture, such as a gaze and pinch, or a gaze and a drag of the hand laterally, and the content item associated with the selected tab is displayed and made active for the browser application).

In some embodiments, while displaying the browser toolbar and the window, without displaying the plurality of tabs (e.g., the plurality of tabs are not visible when the browser toolbar is in a collapsed state), the computer system detects a first user input interacting with the browser toolbar and, in response to detecting the first user input interacting with the browser toolbar, a first set of tabs of the plurality of tabs are displayed. In some embodiments, in response to user interaction with the browser toolbar, the browser toolbar expands or is switched to a state in which one or more of the plurality of tabs is visible in the browser toolbar. For example, browser toolbar 7040 in FIG. 7B transitions from a collapsed state to an expanded state, in response to a gaze by user 7002 directed at browser toolbar 7040, where, in the expanded state, open tabs 7060-7068 that were previously hidden are revealed in browser toolbar 7040, as illustrated in FIG. 7C. In some embodiments, in response to the user interaction with the browser toolbar, one or more of the plurality of tabs are displayed (or revealed), for example, near the browser toolbar but separately from the browser toolbar (e.g., the tabs can be displayed in an array, and, optionally, the array may be scrolled). In some embodiments, the array is one dimensional (e.g., open tabs 7060-7068 are displayed in a one dimensional array in FIG. 7F and FIGS. 7M (e.g., FIG. 7M1-7M3)). In some embodiments, the array is multi-dimensional, such as a grid with more than one row (e.g., grid 7045 in FIG. 7G). In some embodiments, content items that are associated with one or more of the plurality of tabs are displayed at a reduced scale so that more content items can be previewed and explored at the same time. In some embodiments, the reduced scale (sometimes called scaled downed) content items are displayed instead of the associated tabs. For example, reduced scale representations of webpage “A” 7070, webpage “B” 7072, webpage “C” 7074, webpage “D” 7076, webpage “E” 7078, and webpage “F” 7080 are displayed in a grid 7045 to provide an overview of currently open webpages (FIG. 7G). In some embodiments, tabs are concurrently displayed with the scaled downed content items.

Revealing or displaying tabs, in response to user input interacting with the browser toolbar (e.g., a gaze input directed to a portion of the browser toolbar and/or positioning of a hand in a ready state), reduces the number of inputs for switching between tabs and provides additional control to the user while at the same time maintaining the view of the three-dimensional environment without the clutter of additional controls, windows, menus, and/or other user selectable elements. For example, in response to detecting the first user input interacting with the browser toolbar, multiple tabs are revealed, optionally separately or within the browser toolbar, and the user can quickly switch to a new content item by selecting one of the tabs that is revealed, or can quickly scroll through other tabs associated with the browser toolbar that are not yet revealed, without the need to explore and view respective content of a target content item. In other words, a user can focus on the content item, for a selected tab, that is currently active, while the view of the three-dimensional environment is maintained uncluttered with unnecessary windows or user selectable elements, and the tabs can be revealed when needed, in response to a user input.

In some embodiments, in response to detecting the first user input interacting with the browser toolbar, the computer system expands the browser toolbar, including displaying the first set of tabs in the expanded browser toolbar. For example, a gaze input directed at a location occupied by the browser toolbar 7040, optionally in conjunction with hand 7020 in ready state “A,” causes the browser toolbar to expand (as shown in FIG. 7C). In some embodiments, when the browser toolbar is expanded or in an expanded state, some of the currently opened tabs are visible in the expanded browser toolbar, whereas when the browser toolbar is collapsed or in a collapsed state, tabs are not visible. Automatically displaying tabs (e.g., user selectable representations of open tabs) in the browser toolbar in response to a user input interacting with the browser toolbar and automatically collapsing the browser toolbar when the user is no longer interacting with the browser toolbar, reduces the number of inputs required for switching between tabs and provides additional control to the user while the view of the three-dimensional environment is maintained without clutter from additional controls, windows, menus, and/or other user selectable elements.

In some embodiments, the first user input interacting with the browser toolbar comprises a respective gaze input directed at a location in the view of the three-dimensional environment that is occupied by the browser toolbar. In some embodiments, a gaze input directed at the browser toolbar or in the vicinity of or around the browser toolbar, is sufficient to expand the browser toolbar or for otherwise revealing or displaying one or more of the plurality of tabs. For example, a gaze input directed at a location occupied by the browser toolbar 7040 without any hand gesture or movement causes the browser toolbar to expand (FIG. 7B). In some embodiments, a hand of the user in a ready state configuration is also required, in addition to the gaze input (e.g., in some embodiments, the ready state configuration corresponds to lifting the hand so that it appears within the field of view of the image sensors or a portion thereof that corresponds to an interaction space in which hand movement captured by the image sensors are treated as inputs to the controller 110), for expanding the browser toolbar. For example, a gaze input directed at a location occupied by the browser toolbar 7040 in conjunction with hand 7020 in ready state “A” causes the browser toolbar to expand, as shown by the transition from FIG. 7B to FIG. 7C. Automatically revealing or displaying tabs (e.g., in the browser toolbar or separately) in response to a gaze input directed at a portion of the browser toolbar (optionally in combination with a hand of the user in the ready state) reduces the number of inputs required by the computer system for switching between content items, by providing a mechanism to switch between content items without the need to manipulate multiple windows. Also, switching between hiding the tabs and displaying the tabs in response to a gaze input, optionally in combination with a hand of the user in the ready state, without the need to select user controls, improves the operability and operational efficiency of the device. For example, keeping the tabs hidden when not used for navigation between content items, but providing the tabs in response to (e.g., a single) gaze input reduces the number of inputs required for browsing content items associated with respective tabs. In other words, using a single gaze input to control whether tabs are displayed improves the operability of the device by providing more control options while at the same time maintaining the view of the three-dimensional environment uncluttered by additional windows, controls, and/or other user interface elements.

In some embodiments, the first user input interacting with the browser toolbar comprises a respective gaze input directed to a location in the view of the three-dimensional environment that is occupied by the browser toolbar (e.g., in some embodiments, the gaze input must be directed at a portion in space that is occupied by a particular portion of the browser toolbar, such as a search bar, and, in some embodiments, a gaze input directed at any portion in space that is occupied by the browser toolbar is sufficient). In some embodiments, in response to detecting the gaze input directed to the location in the view of the three-dimensional environment that is occupied by the browser toolbar: in accordance with a determination that gaze input meets a duration threshold, the computer system displays the first set of tabs of the plurality of tabs; and, in accordance with a determination that the gaze input does not meet the duration threshold, the computer system maintains display of the browser toolbar and the window without displaying the first set of tabs of the plurality of tabs (e.g., the first set of tabs of the plurality of tabs remain hidden or otherwise not displayed). In some embodiments, displaying the first set of tabs is delayed until the user looks toward the browser toolbar for a predetermined period. In other words, the duration of the gaze is used to distinguish between gazes that are not intended to be user inputs and gazes that are intended as an input interacting with the browser toolbar. In some embodiments, the number of times open tabs appear and then disappear unnecessarily when a user briefly shifts their gaze to the browser toolbar is reduced and the user's intent is disambiguated in accordance with a determination of whether the user's gaze meets respective threshold criteria (e.g., the duration threshold). Controlling whether tabs are displayed with a gaze input (e.g., without the need for any other direct or indirect gestures) in accordance with a determination that the gaze input meets a duration threshold automatically disambiguates between intended inputs to display the tabs and gazes directed to the browser toolbar that are not intended to interact with the browser toolbar. Automatically disambiguating between gazes at the browser toolbar that are indented to display open tabs and gazes not intended to display the tabs improves the operability and operational efficiency of the device by avoiding displaying unnecessary user interface elements and/or avoiding user inputs that are required to correct the unintended display (and/or unintended hiding) of the tabs.

While displaying the browser toolbar and the window, without displaying the plurality of tabs (e.g., the plurality of tabs are not visible), the computer system detects a respective gaze input directed to a location in the view of the three-dimensional environment that is occupied by the browser toolbar (e.g., the respective gaze input is a specific example of the aforementioned first user input interacting with the browser toolbar). In some embodiments, in response to detecting the respective gaze input directed to the location in the view of the three-dimensional environment that is occupied by the browser toolbar: in accordance with a determination that a hand is in a ready state (e.g., in some embodiments, the ready state corresponds to lifting the hand so that it appears within the field of view of the image sensors or a portion thereof that corresponds to an interaction space in which hand movement captured by the image sensors are treated as inputs to the controller 110), the computer system displays the first set of tabs of the plurality of tabs; and, in accordance with a determination that no hand is in the ready state, the computer system maintains displaying the browser toolbar and the window without displaying the first set of tabs of the plurality of tabs (e.g., tabs are hidden and/or the browser toolbar is in a collapsed state). For example, browser toolbar 7040 in FIG. 7B and FIG. 7C expands and open tabs “A”-“E” 7060-7068 are revealed when user 7002 gazes at any portion of browser toolbar 7040 while hand 7020 is in the ready state, denoted as state “A” in FIG. 7B. Controlling whether tabs are displayed with a gaze input in combination with a hand in a ready state provides additional user control over tabbed browser navigation by disambiguating between gaze inputs intended to display the tabs and gaze inputs that are not intended to display the tabs (e.g., when a user would like to view the address in the address bar or a count of open tabs that maybe visible in the browser toolbar). Automatically disambiguating between gazes at the browser toolbar that are indented to display open tabs and gazes not intended to display the tabs based on whether a hand of the user is in a ready state in addition to a gaze input directed at the browser toolbar improves the operability of the device by avoiding displaying unnecessary user interface elements and/or avoiding the need for additional user inputs to dismiss or correct the unintended display (and/or unintended hiding) of the tabs.

In some embodiments, the first user input interacting with the browser toolbar comprises a respective gaze input (e.g., a gaze input directed at a location in the view of the three-dimensional environment that is occupied by a control in the browser toolbar for revealing the plurality of tabs) and (e.g., in combination with) a respective hand movement selecting (e.g., using a direct or indirect air gesture) a control displayed in the browser toolbar (e.g., the control is a button for expanding the toolbar, or a button for displaying an overview of the plurality of opened tabs in a one dimensional array or a multidimensional grid). In some embodiments, open tabs, which are previously undisplayed, are revealed in response to selecting the control displayed in the browser toolbar. In some embodiments, the hand movement selecting the control corresponds to an indirect input (e.g., a gaze input in combination with an air pinch or an air tap). For example, FIGS. 7F-7G illustrate that in response to detecting an air pinch gesture while a gaze of user 7002 is directed at tab overview button 7054, a tab overview mode is activated and reduced scale representations of webpages “A” 7070, webpage “B” 7072, webpage “C” 7074, webpage “D” 7076, webpage “E” 7078, and webpage “F” 7080 are displayed, where webpages “A”-“F” are associated with open tabs “A”-“F” 7060-7080, respectively. In some embodiments, the selection of the control is a direct input such as an air tap at a location in space occupied by the control in the view of the three-dimensional environment (e.g., in such embodiments, a gaze input is not necessary as the user directly interacts with a respective control). Controlling whether tabs are displayed with a gaze input in combination with a hand movement selecting a control provides additional user control over tabbed browser navigation by disambiguating between gaze inputs intended to display the tabs (e.g., when a user wants to quickly switch between the tabs, e.g., without the need to switch between the content items themselves), and gaze inputs that are not intended to display the tabs, which are otherwise undisplayed (e.g., displaying the plurality of tabs is not needed when a user would like to quickly check an address in the address bar or a count of open tabs displayed in the browser toolbar). Displaying the tabs in response to a gaze input in combination with a hand movement improves operability of the device since a user input need not be disambiguated as there is a dedicated button/control for displaying the tabs.

In some circumstances, the computer system detects a second user input different from the first user input. In some embodiments, the second user input includes moving a direction of the user's gaze away from the browser toolbar and/or the tabs. In some embodiments, the second user input corresponds to selecting a tab. In some embodiments, the second user input corresponds to a gaze input toward a content window displaying content associated with a currently active tab. For example, the second user input corresponds to user interaction with the content item itself, or with the view of the three-dimensional environment surrounding the browser toolbar or the content window. In some embodiments, in response to detecting the second user input, the computer system ceases to display (e.g., by hiding) the first set of tabs of the plurality of tabs. For example, in response to detecting an air pinch gesture while the gaze of user 7002 is directed at tab “D” 7066 in FIG. 7D (e.g., FIGS. 7D1-7D3), tab “D” 7066 is selected, a webpage associated with tab “D” 7066 becomes active, browser toolbar 7040 collapses, and tabs “A”-“E” 7060-7068 are hidden from the view of the three-dimensional environment 7000′ (as shown in FIG. 7E). In some embodiments, where the first set of tabs is displayed in a region separated from the browser toolbar, tabs are hidden from display in response to the second user input while the browser toolbar remains in the same state (as opposed to dynamically changing the browser toolbar from an expanded state to a collapsed state). Automatically ceasing to display the tabs, revealed in response to user interaction with the browser toolbar, in response to a subsequent user input interacting with the three-dimensional environment, improves the operability of the device by automatically uncluttering the view of the three-dimensional environment, and/or reducing the user inputs necessary to do so.

In some embodiments, the browser toolbar is (e.g., already) expanded when (e.g., at the time that) the second user input is detected. In some embodiments, the computer system collapses the browser toolbar in response to the second user input, including ceasing to display (e.g., hiding) the first set of tabs that are displayed in the expanded browser toolbar. In some embodiments, collapsing the toolbar includes ceasing display of the first set of tabs that are displayed in the expanded browser toolbar. In some embodiments, in addition to ceasing to display the first set of tabs, one or more controls are also ceased to be displayed. Automatically collapsing the browser toolbar, expanded in response to user interaction with the browser toolbar, in response to a subsequent user input interacting with the three-dimensional environment, improves the operability of the device by automatically uncluttering the view of the three-dimensional environment, and/or reducing the user inputs necessary to do so.

In some embodiments, the second user input selects a tab of the first set of tabs that are displayed. In some embodiments, once the user selects a tab, the tabs are ceased to be displayed and/or the expanded browser toolbar is collapsed. For example, in response to detecting the air pinch gesture while the gaze of user 7002 is directed at tab “D” 7066 in FIG. 7D (e.g., FIGS. 7D1-7D3), tab “D” 7066 is selected, a webpage associated with tab “D” 7066 becomes active, browser toolbar 7040 collapses, and tabs “A”-“E” 7060-7068 are hidden from the view of the three-dimensional environment 7000′ (as shown in FIG. 7E). In some embodiments, the tab is selected with a gaze at a respective tab of the first set of tabs that are displayed and (e.g., in combination with) an air pinch gesture with a hand (e.g., an air pinch gesture where the thumb finger is brought towards or in contact with an index finger or a middle finger of the same hand). In some embodiments, the tab is selected in response to a gaze at the tab for a predetermined amount of time. In some embodiments, a tab is selected in response to a scrolling gesture that scrolls the plurality of tabs. In some embodiments, the second user input that selects the tab is a direct user input (e.g., an air tap at a location in space occupied by the tab in the view of the three-dimensional environment). In some embodiments, the second user input that selects the tab is an indirect user input (e.g., an air pinch with one hand, an air pinch performed with two hands (e.g., bimanual), or other air gesture that does not involve direct interaction a user interface element that corresponds to the tab). Automatically collapsing the browser toolbar, including ceasing to display displayed open tabs, in response to selecting one of the displayed tabs in the expanded browser toolbar, improves the operability of the device by automatically uncluttering the view of the three-dimensional environment (e.g., by removing the tabs after the user performs the selection of a target tab), and/or reduces the number or complexity of the user inputs necessary to do so.

In some embodiments, the second user input includes transitioning a hand from a state in which the hand is engaged to a state in which the hand is no longer engaged. In some embodiments, the hand is no longer engaged if it is lowered nearby the body of the user, or is otherwise outside the field of view of the image sensors or a portion thereof that corresponds to an interaction space in which hand movement captured by the image sensors are treated as inputs to the controller 110. In some embodiments, in response to the user changing the state of the hand from engaged (or in ready state) to disengaged (or in a state where the hand is outside the interaction space where the position or configuration of the hand is treated as input to the controller 110), the browser toolbar is automatically collapsed. Automatically collapsing the browser toolbar (including ceasing to display any displayed tabs) in response to disengaging the hand improves the operability of the device by automatically uncluttering the view of the three-dimensional environment (e.g., by removing the tabs after the user's hand is no longer engaged), and/or reducing the user inputs necessary to do so.

In some embodiments, the second user input includes moving a direction of a gaze away from a location in the three-dimensional environment occupied by the browser toolbar to a location outside the browser toolbar. In some embodiments, the browser toolbar transitions from an expanded state to a collapsed state in response to the computer system detecting a change in direction of the gaze away from the browser toolbar. In some embodiments, the first set of tabs are ceased to be displayed when the user ceases to gaze at the browser toolbar. Automatically collapsing the browser toolbar (including ceasing to display any displayed tabs) in response to a gaze input moving away from the browser toolbar to a location outside the browser toolbar improves the operability of the device by automatically uncluttering the view of the three-dimensional environment (e.g., by removing the tabs after the user no longer interacts with the browser toolbar), and/or reducing the user inputs necessary to do so.

In some embodiments, while displaying the browser toolbar and the first set of tabs of the plurality of tabs, the computer system detects that the user's gaze is directed to a location outside of the browser toolbar. In some embodiments, in response to detecting that the user's gaze is directed to a location outside of the browser toolbar: in accordance with a determination that the gaze is directed at the location outside the browser toolbar for more than a predetermined amount of time, the computer system ceases to display the first set of tabs; and, in accordance with a determination that the gaze is directed at the location outside the browser toolbar for less than a predetermined amount of time, the computer system maintains display of the first set of tabs. For example, in FIG. 7C, if user 7002's gaze is moved away from browser toolbar 7040 to the content window 7030 or to representation (or optical view) of physical object 7014′ for more than the predetermined amount of time, browser toolbar 7040 would collapse and tabs “A”-“E” 7060-7069 would be hidden, as illustrated in FIG. 7B. In some embodiments, displayed tabs are not hidden and the browser toolbar is not collapsed if the user briefly looks away from the browser toolbar and/or tabs (e.g., for less than the predetermined amount of time). In other words, if the user's gaze returns to the browser toolbar within a threshold amount of time, the browser toolbar does not collapse and/or displayed tabs remain displayed. Delaying hiding the tabs in accordance with a determination that the user's gaze away from the browser toolbar does not meet a duration threshold automatically disambiguates between inputs intended to cease interaction with the browser toolbar and brief changes in a direction of user's gaze that are not intended to cease interaction with the browser toolbar and/or the tabs. Automatically disambiguating between inputs intended to hide the tabs and unintended and/or brief changes in a direction of the gaze away from the browser toolbar improves the operability of the device by avoiding hiding the tabs when the user is still browsing the tabs and/or avoiding the need for user inputs to correct the unintended hiding of the tabs.

In some embodiments, in response to detecting that gaze is directed to the location outside of the browser toolbar: in accordance with a determination that the gaze is directed at the location outside the browser toolbar for less than a predetermined amount of time and that the location outside the browser toolbar is a location within a predetermined region in the window (e.g., center of the window or lower portion of the window, where the upper portion of the window is located near the browser toolbar) that displays the first content or the second content (e.g., the window displays content associated with a currently active or selected tab), the computer system ceases to display the first set of tabs without delay. For example, in FIG. 7C, if user 7002's gaze is moved away from browser toolbar 7040 to content window 7030, browser toolbar 7040 would collapse and tabs “A”-“E” 7060-7069 would be hidden (as illustrated in FIG. 7B) without delay. Automatically hiding the tabs without delay, even when the gaze is directed away from the browser toolbar for a short period of time (e.g., for less than the predetermined amount of time), in accordance with a determination that the gaze input is directed at a region in the view of the three-dimensional environment that is occupied by a currently active content item (e.g., webpage content) improves the operability of the device and reduces the number, extent, or nature of inputs necessary to switch between browsing open tab and interacting with a currently active content item.

In some embodiments, prior to detecting the first user input interacting with the browser toolbar, the computer system displays the browser toolbar at a first distance from a viewpoint of a user; and, in response to detecting the first user input interacting with the browser toolbar, the computer system displays the first set of tabs of the plurality of tabs at a second distance from the viewpoint of the user. For example, when a gaze input directed at browser toolbar 7040 is detected in FIG. 7B, and browser toolbar 7040 expands, including displaying open tabs “A”-“E” 7060-7068, browser toolbar 7040 (including open tabs “A”-“E” 7060-7068 displayed within browser toolbar 7040) move closer to view point of user 7002. In some embodiments, the first distance has a respective difference in depth from the second distance; the respective difference in depth is greater than zero; and the first distance is greater than the second distance. In some embodiments, a tab that is displayed within the browser toolbar, pops out or otherwise moves towards a viewpoint of a user in response to a user interaction with the tab. For example, in response to detecting user 7002's gaze directed at tab “D” 7066 while hand 7020 is maintained in ready state “A”, tab “D” 7066 pops out (in the “z” direction) and moves towards viewpoint of user 7002 while the browser toolbar 7040 maintains the same distance from the viewpoint of user 7002, as illustrated in side view 7024 in FIG. 7D (e.g., FIGS. 7D1-7D3). Moving the tabs towards the viewpoint of the user (e.g., along a z-axis) without changing a distance of the browser toolbar from the viewpoint of the user provides visual feedback to the user that the tabs are user selectable elements that can be interacted with or that a respective tab is selected or put into focus. Providing such visual feedback to the user improves the user interaction with the device as it informs the user of the changing state of the view of the three-dimensional environment.

In some embodiments, prior to detecting the first user input interacting with the browser toolbar, the computer system displays the browser toolbar in a collapsed state at a first distance from a viewpoint of a user; and, in response to detecting the first user input interacting with the browser toolbar, the computer system displays an expanded browser toolbar (e.g., a browser toolbar in an expanded state), including displaying the first set of tabs in the expanded browser toolbar, at a second distance from the viewpoint of the user. In some embodiments, the first distance has a respective difference in depth from the second distance; the respective difference in depth is greater than zero; and the first distance is greater than the second distance. In some embodiments, the browser toolbar and tabs that are displayed in the expanded browser toolbar move towards the viewpoint of the user. For example, when a gaze input directed at browser toolbar 7040 is detected in FIG. 7B, and browser toolbar 7040 expands, including displaying open tabs “A”-“E” 7060-7068, browser toolbar 7040 (including open tabs “A”-“E” 7060-7068 displayed within browser toolbar 7040) move closer to view point of user 7002. Moving the browser toolbar, including the tabs, towards the viewpoint of the user (e.g., along a z-axis) provides visual provides visual feedback to the user that improves user interaction with the device as it informs the user of the changing state of the view of the three-dimensional environment and how it responds to the users' actions, such as gazes, gestures, and other inputs, and improves operational efficiency of the computer system by helping the user avoid duplicative inputs and unneeded correctional inputs, which in turn reduces the computer system's computational load.

In some embodiments, displaying the first set of tabs of the plurality of tabs in response to detecting the first user input interacting with the browser toolbar includes displaying the first set of tabs overlaying at least a portion of the window that displays the first content or the second content, examples of which are shown in FIG. 7C, FIG. 7D (e.g., FIGS. 7D1-7D3) and FIG. 7M (e.g., FIGS. 7M1-7M3). In some embodiments, the window is displayed at a first distance from the viewpoint of a user; the first set of tabs are displayed at a second distance from a viewpoint of the user; the first distance has a respective difference in depth from the second distance; and the first distance is greater than the second distance. In some embodiments, the browser toolbar is a platter that when expanded to include tabs, overlays the window or region where content is displayed (e.g., where the web page or the document currently active is displayed) such that the platter is displayed closer to the viewpoint of the user than the content window. For example, in response to detecting user 7002's gaze directed at the browser toolbar 7040 while hand 7020 is in the ready state “A” in FIG. 7B, browser toolbar 7040 expands and tabs “A”-“E” 7060-7068 are displayed at least partially overlaying content window 7030, as illustrated in FIG. 7C. Displaying the tabs and, optionally, the browser toolbar, closer to the viewpoint of the user relative to the content when navigating between tabs improves operability of the device as it allows the user to focus on browsing the tabs without the need to close, dismiss, or move the displayed content. Additionally, displaying the tabs overlaying the content item allows displaying larger tabs (e.g., tabs “A”-“E” 7060-7068 illustrated in FIG. 7M (e.g., FIGS. 7M1-7M3) are larger relative to tabs “A”-“E” in FIG. 7C), where larger tabs not only indicate what type or source of content is associated with the displayed tabs, but also displays the content of those tabs at a reduced scale to fit within the larger tabs (e.g., snapshots of webpage content are displayed in tabs “A”-“E” 7060-7068 illustrated in FIG. 7M (e.g., FIGS. 7M1-7M3)).

In some embodiments, the plurality of tabs are ordered in a sequence, and, while the second tab is selected, the computer system detects a second air gesture that meets second gesture criteria, the second air gesture comprising a second gaze input and (e.g., in combination with) a swipe gesture performed with a hand. In some embodiments, the gaze is directed at a portion of the browser toolbar, such as one or more controls, or around (e.g., within a threshold distance from) the browser toolbar such as slightly above or below, but still nearby the browser toolbar. In some embodiments, the gaze can be directed at the tabs that are displayed in the browser toolbar, but the gaze does not have to be directed at the tabs, and can be directed at any portion of the browser toolbar or around it. In some embodiments, the swipe gesture performed with the hand is an indirect gesture, such as mid-air movement of the hand without direct interaction with a user interface element (e.g., direct interaction can be an air tap or a press on a button, control, or a swipe movement where the input device, such as a finger, stylus, a glove or other wearable input device, directly interacts the user interface element as opposed to from a distance (e.g., interacting from a distance can be based on configuration of the hand(s), movement of the hand(s), and/or gaze input)). For example, in embodiments where direct interaction is required to scroll the tabs in the browser toolbar (e.g., tabs “A-E” 7060-7068 positioned/located on a platter, which is browser toolbar 7040), the user 7002 may scroll the tabs by contacting the platter using the input device and swiping in a horizontal direction (e.g., FIG. 7C). In other words, the input device (e.g., finger or stylus) has a point of contact with the platter where the tabs are located and/or contact with one or more of the tabs themselves. In some embodiments, the swipe gesture is a lateral movement (e.g., leftward, or rightward) performed in conjunction with a particular hand configuration of a respective hand performing the lateral movement, such as an air pinch gesture where a thumb finger is brought into contact with an index finger (or other hand configuration).

In some embodiments, the second air gesture comprises a gaze input directed at the browser toolbar performed in conjunction with an air pinch gesture in combination with a swoop (or swipe like) gesture that laterally (optionally, continuously and/or without interruption) moves (e.g., drags horizontally) the pinched fingers without releasing the pinch (e.g., in some embodiments, the pinch and swoop portions of the gesture are performed indirectly without contact with the tabs or the browser toolbar, and in some embodiments, the pinched fingers directly interact with the browser toolbar). For example, in FIG. 7C, if user 7002 gazes at browser toolbar or tabs “A-E” 7060-7068 and performs an air pinch with hand 7020 in combination with lateral movement (e.g., leftward or rightward), tabs “A-E” 7060-7068 (e.g., shown in FIG. 7C) are scrolled. Tabs in the sequence are scrolled in in accordance with the lateral movement of the hand (e.g., direction and/or magnitude), where the tab that is selected is not necessarily a previous or subsequent tab in the sequence. In some embodiments, upon release of the air pinch, a tab is selected, and the selected tab becomes the currently active tab and content of the selected tab is displayed in the window for displaying content of a currently active tab. In some embodiments, the tab that is selected is determined in accordance with speed, velocity, acceleration, distance traveled, and/or other movement criteria for the lateral movement, rather than necessarily selecting a previous or subsequent tab in the sequence. In some embodiments, if the travel distance is below a predetermined threshold, the gesture is not interpreted as a request to switch tabs, and the currently displayed tab is maintained.

In some embodiments, in response to detecting the second air gesture, the computer system scrolls through one or more tabs of the plurality of tabs in a sequence, including selecting a third tab of the plurality of tabs in the sequence. In some embodiments, in response to the input scrolling the tabs in the toolbar, a different set of tabs of the plurality of tabs are displayed in the browser toolbar. For example, in response to a scroll input, tabs that are previously hidden are revealed, and tabs previously displayed are hidden. In some embodiments, the total number of tabs and/or their size determine how many tabs can be concurrently displayed. Automatically scrolling through the tabs in response to a gaze input in combination with a lateral movement of the hand reduces the number, extent, or nature of inputs necessary to browse through content items. For example, the user is no longer required to manage multiple open windows and can browse through multiple content items by scrolling the tabs rather than respective content items, thereby reducing memory usage by the computer system as content of the scrolled content items (other than selected content items displayed in a browser window) does not need to be loaded.

In some embodiments, the plurality of tabs are ordered in a sequence, and, while a third tab is selected in the sequence of tabs, the computer system detects a third air gesture that meets third gesture criteria, the third air gesture comprising a third gaze input and a swipe gesture performed with a hand in conjunction with the third gaze input. In response to detecting the third air gesture, the computer system selects a tab adjacent to the third tab (e.g., a next or a previous tab) in the sequence of the plurality of tabs. For example, in FIG. 7B, in response to user 7002′ gaze at browser toolbar 7040 and a swipe, a drag, or a flick air input performed with hand 7020 while maintain an air pinch, a currently active tab is switched from tab “A” 7060 to tab “B” 7062. In some embodiments, the gaze is directed at a portion of the browser toolbar or around (e.g., within a threshold distance of) the browser toolbar (e.g., slightly above or below, but still close enough to the browser toolbar to be interpreted by the computer system as a gaze input directed at the browser toolbar). In some embodiments, the gaze can be directed at the tabs that are displayed in the browser toolbar, but the gaze does not have to be directed at the tabs, and can be directed at any portion of the browser toolbar or around it. In some embodiments, the swipe gesture performed with the hand is an indirect gesture. In some embodiments, the swipe gesture is a lateral movement (e.g., leftward, or rightward) performed in conjunction with a particular hand configuration of a respective hand performing the lateral movement (e.g., in some embodiments, the particular configuration corresponds to an air pinch gesture where a thumb finger is brought into contact with an index finger (or other hand finger) of the same hand). In some embodiments, the air gesture comprises a gaze input directed at the browser toolbar performed in conjunction with an air pinch gesture followed by a swoop (or swipe like) gesture that laterally (optionally, continuously and/or without interruption) moves (e.g., drags horizontally) the pinched fingers without releasing the pinch (e.g., in some embodiments, the pinch and swoop portions of the gesture are performed indirectly without contact with the tabs or the browser toolbar, and in some embodiments, the pinched fingers directly interact with the browser toolbar). The next or previous tab in the sequence of tabs is selected in response to the swipe portion of the gesture (e.g., in response the lateral movement of the hand). In some embodiments, upon release of the pinch, the next or previous tab (depending on the direction and/or order of the tabs in the sequence) is selected, and the selected tab becomes the currently active tab and content of the selected tab is displayed in the window for displaying content of a currently active tab.

Automatically selecting a tab adjacent to the currently active tab in response to a gaze input in combination with a lateral movement of the hand reduces the number, extent, or nature of inputs necessary to switch between adjacent tabs.

In some embodiments, the second gaze input or third gaze input is directed at a location in the view of the three-dimensional environment that is occupied by the browser toolbar (e.g., browser toolbar 7040). Using a gaze input directed to the browser toolbar in addition to a hand movement to switch between tabs (adjacent or separated by other tabs) improves the operability of the device as it disambiguates between inputs directed at the content item(s) and inputs directed at the browser toolbar, including navigation between tabs.

In some embodiments, the second gaze input or third gaze input is directed at a location in the view of the three-dimensional environment that is occupied by a search field of the browser toolbar (e.g., a smart address bar, where a particular web page can be located in response to entering one or more keywords or a search query, such as search field 7082 in FIG. 7G), or around (e.g., within a threshold distance of) the search field such as slightly above or below it, but still nearby the search field. Using a gaze input directed to a search field of the browser toolbar in addition to a hand movement to switch between tabs (adjacent or separated by other tabs) improves the operability of the device as it disambiguates between inputs directed at the content item(s) and inputs directed at the browser toolbar.

In some embodiments, the plurality of tabs are ordered in a sequence, and, while a second tab is selected in the sequence of tabs, the computer system detects a fourth air gesture that meets fourth gesture criteria, the fourth air gesture comprising a fourth gaze input and a swipe gesture performed with a hand (e.g., in conjunction with the fourth gaze input). In response to detecting the fourth air gesture, in accordance with a determination that the fourth gaze input is directed at a location in the view of the three-dimensional environment that is occupied by the browser toolbar, the computer system scrolls through one or more tabs of the plurality of tabs in the sequence, including selecting a third tab of the plurality of tabs in the sequence. In some embodiments, in response to detecting the fourth air gesture: in accordance with a determination that the fourth gaze input is directed at a location in the view of the three-dimensional environment that is occupied by the window that displays the second content associated with the second tab (e.g., directed at a second content item), the computer system displays in the window a portion of the second content that was not displayed previously. In some embodiments, the fourth gesture criteria include a criterion that the fourth gaze input is directed at the second content item for more than a threshold amount of time (e.g., the fourth gaze input is determined not to be accidental, unintended, or too quick). In some embodiments, when the fourth gaze input is directed at the content in a window, as opposed to the browser toolbar, the content in the window is changed, shifted, scrolled though, or otherwise navigated through. Using the gaze input to disambiguate between inputs directed to the content item that is currently active and inputs direct at the browser toolbar to switch tabs (whether adjacent or separated by other tabs) improves the operability of the device as it disambiguates between inputs directed at the content item(s) and inputs directed at the browser toolbar.

In some embodiments, the computer system detects a second air gesture that meets second gesture criteria, the second air gesture comprising a gaze input directed at a location in the three-dimensional environment where a third tab of the plurality of tabs is displayed (e.g., the user is gazing at one of the tabs that are displayed, optionally, in the browser toolbar or a separate region in the three-dimensional environment), and a pinch gesture (e.g., an inward pinch with a thumb and index finger) (e.g., a pinch gesture detected in conjunction with the gaze input). In some embodiments, in response to detecting the second air gesture that meets second gesture criteria, the computer system selects the third tab of the plurality of tabs. For example, in FIG. 7D (e.g., FIGS. 7D1-7D3), in response to detecting the air pinch gesture while the gaze of user 7002 is directed at tab “D” 7066, tab “D” 7066 is selected and a webpage that is associated with tab “D” 7066 becomes active, where content window 7030 of tab “A” 7060 is replaced with content window 7050 of tab “D” 7066. In another example, in FIG. 7H, in response to detecting the gaze input by user 7002 directed at webpage “F” 7080 in conjunction with the air pinch gesture performed with hand 7020, webpage “F” 7080 is selected to be an active webpage for the browser application. Selecting a tab to navigate to a different content item in response to a gaze input in combination with a pinch gesture in the air (e.g., without direct contact or interaction with a user interface element) improves the operability of the device as it reduces the number of inputs necessary to switch to a different tab. Gaze and pinch gestures in the air also do not require the user to reach out and locate or “directly” touch or manipulate the tab; therefore, the input mechanism for selecting a tab is more ergonomic and efficient than input mechanisms that require directly interaction with the browser toolbar.

In some embodiments, while displaying a fourth tab of the plurality of tabs at a first distance from a viewpoint of a user, the computer system detects a second air gesture that meets third gesture criteria, the second air gesture comprising a second hand movement, including a first portion and a second portion. In some embodiments, the first portion corresponds to selecting the fourth tab; and the second portion corresponds to moving the selected fourth tab to a second distance from the viewpoint of the user (e.g., the hand moves towards the user while holding the fourth tab in the three-dimensional environment). In some embodiments, the first distance is greater than the second distance, and the first distance has a respective difference in depth from the second distance. In some embodiments, in response to detecting the second air gesture that meets the third gesture criteria, the computer system displays a new window that includes content associated with the fourth tab of the plurality of tabs. In some embodiments, the air gesture is direct input. For example, a user may reach out and grab a target tab that is visible in the three-dimensional environment and create a new window by dragging and moving it to the side. In some embodiments, the user may use an indirect input such as gaze at the target tab and a pinch gesture without release and dragging the tab and moving it aside and releasing. Automatically displaying a new window with content of a content item that corresponds to the selected tab in response to an air gesture, which includes selecting (e.g., via an air pinch) and dragging the tab, reduces the number, extent, and/or nature of inputs necessary to create a new window from a selected tab (e.g., a user is not required to reach out, locate, and directly interact with the tab.

In some embodiments, prior to detecting the first air gesture that meets the first gesture criteria: the computer system displays a representation of the first tab to a left side of the browser toolbar, and a representation of the second tab on a right side of the browser toolbar. In some embodiments, the first tab is displayed on one side of the browser toolbar (e.g., the left side) and the second tab is displayed on the other side of the browser toolbar (e.g., the right side). For example, in FIG. 7J, tab “A” 7060 is displayed on the left side of browser toolbar 7040 and tab “B” 7062 is displayed on the right side of browser toolbar 7040. In some embodiments, the second tab may be switched in response to an air gesture, such as a gaze input directed to the browser toolbar in combination with a lateral movement of the hand that is in a configuration that corresponds to a pinch gesture, where the second tab replaces the first tab and a new tab (e.g., a tab that is next in the sequence of tabs) is displayed in place of the second tab. For example, in response to detecting the gaze input by user 7002 directed at browser toolbar 7040 in conjunction with hand 7020 maintaining the air pinch gesture while hand 7020 moves in the leftward direction, followed by the release of the air pinch gesture, tab “B” 7062 becomes the currently active tab, e.g., by moving tab “B” 7062 from the right to the left side of the browser toolbar 7040, thereby replacing tab “A” 7060 on the left side of the browser toolbar and revealing tab “C” 7064 on the right side of browser toolbar 7040, previously occupied by tab “B” 7062, as illustrated in FIG. 7K. In some embodiments, depending on the direction of the lateral movement, the first tab can replace the second tab, and a new tab can be displayed in place of the first tab (e.g., on the left side of the browser toolbar). In some embodiments, the first tab and the second tab are displayed without displaying other open tabs. Displaying the first tab on a first side of the browser toolbar and the second tab on the second side of the browser toolbar, optionally without displaying other open tabs, reduces clutter in the view of the three-dimensional environment while also indicating to a user which tab is the next tab in the sequence of tabs, and reduces the number, extent, and/or nature inputs needed to switch to the next tab.

In some embodiments, while displaying the first set of tabs at a first distance from a viewpoint of a user, the computer system detects a second user input different from the first user input, the second user input including a gaze input directed at a third tab of the first set of tabs and a hand in a first state that corresponds to a ready state. In some embodiments, in response to detecting the second user input, the computer system displays the third tab at a second distance from the viewpoint of the user, wherein the first distance is greater than the second distance, and the first distance has a respective difference in depth from the second distance. Further, while displaying the third tab at the second distance from the viewpoint of the user, the computer system detects a third user input different from the second user input, the third user input selecting the third tab of the first set of tabs. In some embodiments, in response to the third user input selecting the third tab of the first set of tabs, the computer system displays the third tab at the first distance from the viewpoint of the user. In some embodiments, a selected tab is displayed at one distance from the user's viewpoint in response to detecting gaze input that is directed at the selected tab and the hand is in ready state and at another distance in response to detecting an air gesture (e.g., a pinch) that selects the selected tab. For example, in FIG. 7D (e.g., FIGS. 7D1-7D3), in response to detecting the gaze input of user 7002 directed at tab “D” 7066 while the hand 7020 is maintained in ready state “A”, tab “D” 7066 is put into focus and pops out (moves in the “z” direction), and when selected in response to an air pinch gesture performed while tab “D” 7066 is in focus, tab “D” 7066 is selected and moves back towards its previous position. Moving a target tab (e.g., one on which a user is focused on) towards the viewpoint of the user when the electronic device detects that a hand is in the ready state and moving the target tab away from the viewpoint of the user (e.g., to its original or prior position) in response to selecting the target tab, provides visual feedback to the user (e.g., by indicating when a tab is ready to be selected and when the tab is selected) that improves the efficiency of user interaction with the device as it informs the user of the changing state of the view of the three-dimensional environment and how it responds to the users' actions, such as gazes, gestures, and other inputs.

In some embodiments, the first user input interacting with the browser toolbar is detected while displaying the window including the first content or the second content at a first distance from a viewpoint of a user, and response to detecting the first user input interacting with the browser toolbar, while displaying the first set of tabs, the computer system dims the window and moves the window in a direction away from the viewpoint of the user. In some embodiments, in response to interacting with the browser toolbar, the prominence of the window is reduced or visually deemphasized so that the focus can be on the browser toolbar and/or the tabs. Visually deemphasizing (or reducing the prominence of) the window so that a user interacting with the browser toolbar can focus on the browser toolbar (as opposed to the window), reduces the visual clutter in the view of the three-dimensional environment, thereby allowing more efficient interaction with the browser toolbar.

In some embodiments, aspects/operations of methods 900, 1000, and 1100 may be interchanged with, substituted for, and/or added to these methods. For brevity, these details are not repeated here.

FIG. 9 is a flow diagram of an exemplary method 900 for spatially positioning a browser toolbar relative to a browser application in a three-dimensional environment, in accordance with some embodiments. In some embodiments, method 900 is performed at a computer system (e.g., computer system 101 in FIG. 1) that is in communication with a display generation component (e.g., display generation component 120 in FIGS. 1A, 3, and 4) (e.g., a heads-up display, a head-mounted display (HMID), a display, a touchscreen, a projector, a tablet, a smartphone, etc.) and one or more input devices (e.g., cameras, controllers, touch-sensitive surfaces, joysticks, buttons, etc.). In some embodiments, the method 900 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 900 are, optionally, combined and/or the order of some operations is, optionally, changed.

As described herein, method 900 displays the browser toolbar and the window overlaid on the view of the three-dimensional environment with respective difference in depth between the browser toolbar and the window and, optionally, maintaining that respective difference while switching between windows (or webpages). For example, side view 7024 in FIGS. 7B-7E and 7L-7M (e.g., FIGS. 7M1-7M3) illustrate the depth difference between browser toolbar 7040 and content window 7030. The depth difference between the browser toolbar and the window helps a user focus on the browser toolbar and, optionally, the tabs displayed therein. The depth difference between the browser toolbar and the window provides improved visual feedback to the user and improves switching between different windows (or webpages).

The computer system concurrently displays (902) a browser toolbar (e.g., browser toolbar 7040) at a first distance from a viewpoint of a user (e.g., a graphical user interface element that includes navigation controls, address or search bar, a refresh control, a control for opening new tabs, a control for sharing content, a control for showing all currently opened tabs, etc.) and a window including first content at a second distance from the viewpoint of the user (e.g., content window 7030). The first distance has a respective difference in depth from the second distance; the respective difference in depth is greater than zero; the browser toolbar and the window are overlaying a view of a three-dimensional environment (e.g., view of the three-dimensional environment 7000′); and the browser toolbar and the window are associated with a browser application. For example, as shown in side view 7024 and top view 7026 in FIG. 7B, browser toolbar 7040 is separated from content window 7030 in a “z” direction, such that browser toolbar 7040 and content window 7030 are displayed at different depths in the view of the three-dimensional environment 7000′. In some embodiments, a plurality of tabs are associated with the browser application, each tab corresponding a content item. In some embodiments, the plurality of tabs are displayed in the browser toolbar (e.g., tabs “A”-“E” 7060-7068 are displayed within browser toolbar 7040 in FIGS. 7C and 7M (e.g., FIG. 7M1-7M3)). In some embodiments, the plurality of tabs are floating separated from the browser toolbar. In some embodiments, the browser toolbar is displayed closer to a viewpoint of the user compared to the window (e.g., while a user is interacting with the browser toolbar). In some embodiments, the browser toolbar is displayed overlaying a portion of the window, where the window is displayed further away from the viewpoint of the user and the browser toolbar is displayed closer to the viewpoint of the user. For example, browser toolbar 7040 is displayed overlaying a portion of content window 7030 in FIGS. 7C and 7M.

The computer system receives (904), via the one or more input devices, an input corresponding to a request to change content in the window. For example, in FIG. 7D (e.g., FIGS. 7D1-7D3), the air pinch gesture while the gaze of user 7002 is directed at tab “D” 7066 is a request to change from tab “A” 7060's content to tab “D” 7066's content. In some embodiments, the request to change content in the window corresponds to an air gesture and/or hand gesture directed to the browser toolbar, and/or the window, or other object, control, or region in the three-dimensional environment. In some embodiments, the request to change content in the window is direct input, where an interaction with a user interface element occurs. In some embodiments, the user input requesting to change content corresponds to indirect input (e.g., a midair gesture without interaction with a user interface element).

In response to receiving the input corresponding to the request to change content in the window, the computer system changes (906) content displayed in the window from the first content to second content different from the first content while continuing to display the browser toolbar and the window overlaid on the view of the three-dimensional environment. For example, in response to detecting the air pinch gesture while the gaze of user 7002 is directed at tab “D” 7066 in FIG. 7D (e.g., FIGS. 7D1-7D3), tab “D” 7066 is selected and content window 7030 of tab “A” 7060 is replaced with content window 7050 of tab “D” 7066, where the respective different between content window 7050 and the browser toolbar 7040 is maintained as illustrated in side view 7024 in FIG. 7E. The respective difference in depth between the browser toolbar and the window before and after the change in content in the window from the first content to the second content are the same. In some embodiments, changing content displayed in the window from the first content to second content different from the first content occurs while continuing to display the browser toolbar and the window overlaid on the view of the three-dimensional environment with the respective difference in depth between the browser toolbar and the window. In some embodiments, the respective difference in depth between the browser toolbar and the window before and after the change in content in the window from the first content to the second content are the same; however, the respective difference can change momentarily or temporary during tabs switching.

In some embodiments, the input corresponding to the request to change content in the window includes an air gesture that meets first gesture criteria, and, in response to detecting the air gesture that meets the first gesture criteria, the computer system scrolls content in the displayed window. In some embodiments, the first content and the second content are portions of content associated with the same web page, document, email, application, etc. In some embodiments, the first air gesture includes a gaze input directed at the window, and a hand movement. In some embodiments, the hand movement includes moving the hand laterally (e.g., vertically and/or horizontally). In some embodiments, the hand movement includes a pinch gesture (e.g., single finger pinch, double finger pinch) in addition to the movement of the hand laterally. In some embodiments, the content in the window is scrolled in response to gaze input without hand movement. In some embodiments, scrolling in response to gaze input, without hand movement, includes a duration threshold requirement (e.g., a user's gaze dwells or remains directed at an affordance in the window (e.g., such as a slider that includes controls for selecting automatic scrolling in opposite directions) for a threshold amount of time or more). In some embodiments, the air gesture comprises a gaze input and a hand movement, such as a gaze input directed at an affordance (e.g., user interface control for scrolling content in the window) and a pinch gesture (e.g., a single finger pinch gesture, or a double finger pinch gesture) to select the control and cause the scrolling. In some embodiments, the pinch gesture is an inward pinch gesture (e.g., an inward pinch where a thumb finger and an index or other finger of the same hand are brought into contact with each other). In some embodiments, content in the window can be scrolled in different ways. For example, for users that are visually impaired, the first air gesture optionally does not include a gaze input, and/or the input may be based on voice commands and/or hand movements. In some embodiments, scrolling and other navigation to and/or within the window can be performed based on hand gestures without a gaze input. In some embodiments, for motor impaired users, the gestures can be limited to pressing a mechanical button, voice command, and/or other input depending on the level of mobility of the user. In some embodiments, the air gesture that meets the first gesture criteria is a direct input (e.g., by performing the scrolling input at a location in the physical space that is located where the content window is located in the view of the three-dimensional environment). In some embodiments, the air gesture that meets the first gesture is a midair gesture that does not interact directly with the window or the content in the window, e.g., without a need to attempt to locate and contact/interact the window, thus, proving an input mechanism that is more ergonomic and efficient. Maintaining a respective depth difference between the browser toolbar and the currently active window even when a user is scrolling content in the window provides visual feedback to the user that improves the user interaction with the device as it informs the user of the changing state of the view of the three-dimensional environment and how it responds to the users' actions (e.g., gazes, gestures, and other inputs) while also maintaining prominence of the browser toolbar.

In some embodiments, the input corresponding to the request to change content in the window includes an air gesture that meets second gesture criteria. In some embodiments, responsive to the air gesture that meets the second gesture criteria, the computer system selects a link displayed within content in the window (e.g., a link within content window 7030), wherein the second content displayed in the window is associated with the selected link. In some embodiments, the second air gesture is a gaze input directed at a location in the window that is occupied with the link. In some embodiments, the selection of the link is based on gaze input without hand movement. In some embodiments, selection in response to gaze input without hand movement, includes a duration threshold requirement (e.g., a user's gaze dwells or remains directed at the link in the window for a threshold amount of time or more). In some embodiments, the air gesture comprises a gaze input and a hand movement to select the link, such as a gaze input directed at the link and an air pinch gesture (e.g., a single finger pinch gesture, or a double finger pinch gesture) or an air tap gesture. In some embodiments, the air pinch gesture is an inward pinch gesture. In some embodiments, a link within the window can be selected differently for other users that may be visually impaired. For example, the link selection and navigation to and/or within the window can be performed based on hand gestures without a gaze input. In some embodiments, for motor impaired users, the gesture can be pressing a mechanical button, voice command, or other input depending on the level of mobility of the user. In some embodiments, the air gesture that meets the second gesture criteria is a direct or indirect input. The indirect input is ergonomic and efficient because the user does not have to reach to a location in the view of the three-dimensional environment that is occupied by the displayed link. The direct input is also ergonomic and efficient because does not require the user of physical devices that can exert pressure and strain on the user's hands and/or body. Maintaining a respective depth difference between the browser toolbar and the currently active window even when a user is selecting a link displayed in the window provides visual feedback to the user that improves the user interaction with the device as it informs the user of the changing state of the view of the three-dimensional environment and how it responds to the users' actions (e.g., gazes, gestures, and other inputs), while also maintaining prominence of the browser toolbar.

In some embodiments, a first plurality of tabs (e.g., tabs “A”-“E” 7060-7068) are displayed in the three-dimensional environment (e.g., view of the three-dimensional environment 7000′). In some embodiments, the plurality of tabs are displayed in the browser toolbar (e.g., browser toolbar 7040). In some embodiments, the plurality of tabs are displayed floating in the three-dimensional environment separated from the browser toolbar. In some embodiments, a currently selected tab, and a previously selected tab are displayed on each side of the browser toolbar (FIGS. 7J-7K). In some embodiments, the plurality of tabs that are displayed in the three-dimensional environment are a subset of all tabs that are associated with the browser application (e.g., other opened or active tabs that are not revealed or displayed until a user input is detected that navigates to an un-displayed tab). In some embodiments, the input corresponding to the request to change content in the window includes an air gesture that meets third gesture criteria. In some embodiments, responsive to the air gesture that meets the third gesture criteria, the computer system selects a second tab from the first plurality of tabs. For example, in response to detecting the air pinch gesture while the gaze of user 7002 is directed at tab “D” 7066 in FIG. 7D, tab “D” 7066 is selected and content window 7030 of tab “A” 7060 is replaced with content window 7050 of tab “D” 7066, where the respective different between content window 7050 and the browser toolbar 7040 is maintained as illustrated in side view 7024 in FIG. 7E.

In some embodiments, the third air gesture comprises a gaze input directed at the second tab and an air pinch gesture (e.g., a single finger pinch gesture, or a double finger pinch gesture). In some embodiments, the air pinch gesture is an inward pinch gesture. In some embodiments, the third air gesture comprises a gaze input without any hand movement. In some embodiments, the second tab is selected in response to a gaze input directed at the second tab for a threshold amount of time, e.g., user 7002's gaze dwelling for a minimum amount of time over tab “D” 7066 in FIG. 7D. In some embodiments, the third air gesture comprises a gaze input directed at the browser toolbar and hand movement that includes a first portion and a second portion, the first portion corresponding to a pinch gesture, and the second portion corresponding to a drag gesture, such as a lateral movement of the hand while also the hand is performing the pinch gesture, where the second tab is selected in response to release of the pinch gesture. In some embodiments, the air gesture that meets the third gesture criteria is a direct or indirect input. Maintaining a respective depth difference between the browser toolbar and the currently active window even when a user is switching between tabs (thereby also optionally switching windows) provides visual feedback to the user that improves the user interaction with the device as it informs the user of the changing state of the view of the three-dimensional environment and how it responds to the users' actions (e.g., gazes, gestures, and other inputs) while also maintaining prominence of the browser toolbar.

In some embodiments, a second plurality of tabs are associated with the browser application. In some embodiments, the computer system displays the browser application in a first display mode in which content associated with one tab of the second plurality of tabs is displayed in the window (e.g., a normal browsing mode in which one content item is visible at a time and is displayed at a full size in the window) (e.g., FIGS. 7B-7E illustrate the browser application in the normal browsing mode). In some embodiments, the first display mode corresponds to concurrently displaying the browser toolbar and the window, where only content associated with one tab is displayed in the window. In some embodiments, the second display mode corresponds to expose mode or a tab overview mode in which overview of the content of multiple tabs is concurrently displayed (e.g., FIG. 7G illustrates the browser application in the tab overview mode). In some embodiments, in the second display mode, tabs included in the overview are represented with reduced scale representations of the content that is associated with the respective tab (e.g., reduced scale representations of webpages “A”-“F” 7070-7080 in FIG. 7G).

In some embodiments, the computer system detects an air gesture that meets the fourth gesture criteria. In some embodiments, the fourth air gesture includes a gaze input directed at an affordance in the browser toolbar for activating the second display mode, and an air pinch gesture to select the affordance (e.g., in some embodiments, the air pinch gesture includes bringing an index finger and a thumb finger of the same in contact with each other (e.g., midair), and, in some embodiments, more than two fingers of the same hand can be used (e.g., the thumb finger can be brought into contact with two other fingers of the same hand (e.g., an index finger and a middle finger)). For example, FIG. 7F illustrates user 7002 gazing at tab overview button 7054 while hand 7020 is in the ready state. In some embodiments, the fourth air gesture includes a two-handed air gesture (e.g., a bimanual air gesture). The two-handed air gesture can be an air inward pinch performed with two hands (optionally, without the need for a gaze input). For example, each hand can maintain an air pinch gesture and the pinched fingers on one hand are brought into contact with the pinched fingers on the other hand (where optionally, the rest of the fingers on both hands are unfolded or partially unfolded). In some embodiments, the air gesture that meets the fourth gesture criteria is a direct interaction input, such an air tap on the displayed affordance for activating the overview display mode. In some embodiments, the air gesture that meets the fourth gesture criteria is a midair gesture that does not touch or directly interact with an affordance (e.g., an indirect input).

In some embodiments, in response to detecting the air gesture that meets the fourth gesture criteria, the computer system changes displaying the browser application from the first display mode to a second display mode (e.g., changes the mode from a normal browsing mode to a tab overview mode in which content items corresponding to opened tabs, optionally, all or a subset of the opened tabs, are displayed at reduced scale representations so that a user can quickly locate and select a target tab and/or determine if a new tab needs to be opened), including: ceasing to display the window; and concurrently displaying a first plurality of reduced scale representations of content items that are each associated with a respective tab of the second plurality of tabs. For example, in FIG. 7F, in in response to detecting the air pinch gesture while the gaze of user 7002 is directed at tab overview button 7054, a tab overview mode is activated as illustrated in FIG. 7G, where content window 7030 is removed from the view of the three-dimensional environment 7000′ and replaced with reduced scale representations of webpages In some embodiments, if the opened tabs do not fit within the space where virtual content can be displayed (e.g., within a virtual region dedicated for the browser application, such as grid 7045 in FIG. 7G), the reduced scale representations of the tabs can be scrolled, e.g., vertically or horizontally, to reveal previously undisplayed tabs (e.g., tabs not displayed immediately prior to the scrolling).

Switching from a normal browsing mode, where one window or content item is displayed at a time, to a tab overview mode, where multiple content items are concurrently displayed as reduced scale representations, in response to an air gesture, reduces the number or complexity of inputs necessary to search for and switch between tabs. For example, a user can quickly transition from exploring and/or interacting with one content item to obtaining an overview of multiple content items any of which can then be efficiently selected for further interaction in the normal browsing mode. The transition between the normal browsing mode and the tab overview mode is efficient since using air gestures is fast, touchless and ergonomically superior to methods that require interaction and navigation with menus and/or controls in order to change operational modes. Also, displaying reduced scale representations of the content items (e.g., where respective snapshots of the content are visible at reduce scale) as opposed to merely identifying the content (or the source of the content) allows for quick identification of a target content item (e.g., based on its content).

In some embodiments, changing displaying the browser application from the first display mode to the second display mode includes ceasing displaying the browser toolbar. In some embodiments, hiding the browser toolbar allows a user to focus on exploring the content items that are visible in the overview mode. In some embodiments, a user can exit the overview mode in a number of ways, including selecting a desired tab, resting the hands, or removing the hands from the field of view of the camera(s), or other gesture designed to exit the overview mode. Automatically (e.g., without further user input) hiding (e.g., ceasing to display) the browser toolbar when switching from the normal browsing mode to the tab overview mode unclutters the mixed reality three-dimensional environment, and provides a user with an opportunity to focus on the task at hand (e.g., finding and switching to a different content item). Also, uncluttering the mixed reality three-dimension environment reduces the likelihood of gazes or other gestures directed at the browser toolbar that may unintentionally exit the overview mode. In addition, hiding the browser toolbar provides additional space for displaying the content items in the overview mode.

In some embodiments, changing displaying the browser application from the first display mode to the second display mode includes collapsing the browser toolbar, including ceasing to display controls that were previously displayed in the browser toolbar. For example, in addition to displaying multiple tabs “A”-“F” 7070-7080 in FIG. 7G in the tab overview mode, browser toolbar 7040 enters a tab search mode as illustrated in FIG. 7G. In some embodiments, the browser toolbar is collapsed and/or dynamically changed, rather than removed from display. In some embodiments, the browser toolbar includes less controls when collapsed. In some embodiments, collapsing the browser toolbar includes displaying an animation, where the browser toolbar collapses and moves at a different position. In some embodiments, if tabs were displayed in an expanded browser toolbar, the tabs are removed from the browser toolbar in the collapsed state. Automatically (e.g., without further user input) collapsing the browser toolbar when switching from the normal browsing mode to the tab overview mode unclutters the mixed reality three-dimensional environment, and provides a user with an opportunity to focus on the task at hand (e.g., finding and switching to a different content item) while also maintaining a smaller version of the browser toolbar so as to facilitate access to the controls in the collapsed toolbar. In addition, collapsing the browser toolbar provides additional space for displaying the content items in the overview mode.

In some embodiments, a subset of the first plurality of reduced scale representations of the content items are displayed tilted towards the viewpoint of the user. For example, in FIG. 7G, webpage “A” 7070 and webpage “D” 7076 on the left side (or first column in grid 7045), and webpage “C” 7074 and webpage “F” 7080 on the right side (or last column in grid 7045) are displayed angled towards user 7002, as illustrated in side view 7024. In some embodiments, the first plurality of reduced scale representations are displayed in a grid (e.g., a one dimensional grid, or a two-dimensional grid, such as grid 7045 in FIG. 7G). In some embodiments, the subset of the first plurality of reduced scale representations that are displayed tilted towards the viewpoint of the user are displayed in columns at the outer boundaries of the grid (e.g., first and last columns in the grid). In some embodiments, displaying the reduce scale representations tilted towards the viewpoint of the user includes displaying portions of the representations at an angle towards the user. Tilting some of the content items (e.g., those that are displayed furthest away from the user) towards the viewpoint of the user provides an ergonomic and efficient input mechanism for selecting a tab in response to an air gesture (e.g., by reducing the user's movement needed to select tabs that are harder to reach or by positing the tabs to improve visibility from user's viewpoint).

In some embodiments, a user interface of a first application different from the browser application is displayed in the three-dimensional environment, and changing displaying the browser application from the first display mode to the second display mode includes ceasing displaying the user interface of the first application. In some embodiments, other applications, different from the browser application, that are visible in the view of the three-dimension environment concurrently with the browser application, are hidden or removed from the view of the three-dimensional environment in response to activating the tab overview mode (e.g., the second display mode). Automatically (e.g., without further user input) hiding applications other than the browser application when activating the tab overview mode, makes space for the content items displayed in the tab overview mode and reduces distractions and unclutters the view of the three-dimensional environment, thereby allowing a user to select a desired tab more efficiently.

In some embodiments, the air gesture that meets fourth gesture criteria comprises an air pinch gesture performed with two hands. In some embodiments, the air pinch gesture performed with two hands is an air inward pinch gesture, or an air depinch gesture, performed with two hands (optionally, without the need for a gaze input). For example, each hand can be maintained in a predefined configuration (e.g., a pinch configuration, or a flat hand configuration) while the two hands are moved together (for an inward pinch gesture) or moved apart (for an air depinch gesture). In some embodiments, the air gesture that meets the fourth gesture criteria is a direct input or indirect input. Switching from the normal browsing mode to the tab overview mode in response to an air gesture, reduces the number or complexity of inputs necessary to search for and switch between tabs. The transition between the normal browsing mode and the tab overview mode using air gestures is more efficient and ergonomically superior to gestures that require menu navigation or use of controllers. Also, displaying reduced scale representations of the content items (e.g., snapshots of the content at reduce scale) as opposed to displaying only textual identifiers of the content (or the source of the content), allows for quick identification of a target content item in the tab overview mode (e.g., based on its content).

In some embodiments, receiving the input that includes the air gesture that meets the fourth gesture criteria includes, while detecting a gaze input directed at an affordance (e.g., a selectable user interface element) displayed in the browser toolbar, detecting a selection gesture that is an air gesture performed with one hand. For example, in response to detecting the air pinch gesture while the gaze of user 7002 is directed at tab overview button 7054 in FIG. 7F, a tab overview mode is activated, as illustrated in FIG. 7G. In some embodiments, the selection gesture is an air tap gesture directed at the affordance (e.g., an air tap gesture is similar to a tap on a contact sensitive surface that is performed midair without the need to touch a touch sensitive surface). In some embodiments, the selection gesture is an air pinch gesture. In some embodiments, the selection gesture is an indirect input performed midair without the need to move the hand to a location of the displayed affordance, thereby providing an input mechanism that is more ergonomic and efficient. Switching from the normal mode to the overview mode in response to an air gesture, which is a selection gesture combined with a gaze input directed at an affordance (e.g., selectable user interface element for switching between the normal and overview modes), reduces the number or complexity of inputs necessary to search for and switch between tabs.

In some embodiments, receiving the input that includes the air gesture that meets the fourth gesture criteria includes, while detecting a gaze input directed at a search input area (e.g., address bar 7042, FIG. 7B, which can also be used for entering search queries) displayed in the browser toolbar, detecting a selection gesture that is an air gesture performed with one hand. In some embodiments, the selection gesture is an air tap gesture directed at the search input area. In some embodiments, the selection gesture is an air pinch gesture. In some embodiments, the selection gesture is an indirect input performed midair without the need to move the hand to a location of the displayed search input area, thereby providing an input mechanism that is more ergonomic and efficient. Switching from the normal browsing mode to the tab overview mode in response to an air gesture, which is a selection gesture combined with a gaze input directed at a search input area (e.g., address bar 7042 or a search field 7082), reduces the number or complexity of inputs necessary to search for and switch between tabs.

In some embodiments, while detecting a gaze directed at a region within the window, the computer system continues displaying the browser toolbar. In some embodiments, the computer system detects an input corresponding to a gaze moving in a direction away from the window and away from the browser toolbar, and in response to detecting the input corresponding to the gaze moving away from the window and away from the browser toolbar (e.g., optionally for more than a threshold amount of time), the computer system ceases displaying the browser toolbar. In some embodiments, the browser toolbar is automatically hidden when a user is no longer paying attention to the content displayed in the window or the browser toolbar itself (e.g., as indicated by the user's gaze moving away from the window and browser toolbar). Automatically (e.g., without further user input) hiding (e.g., ceasing to display) the browser toolbar when the user is no longer paying attention to the content item displayed in the window (e.g., a current webpage), unclutters the mixed reality three-dimensional environment and allows a user to focus on the task at hand (e.g., interacting with another application). Automatically hiding the browser toolbar in response to detecting that the user is no longer paying attention to the browser application, without the need to provide further input to close the browser toolbar manually, reduces the number of user inputs needed to unclutter the view of the three-dimensional environment.

In some embodiments, the computer system (e.g., after ceasing to display the browser toolbar as described above, and while continuing to not display the browser toolbar) detects an input corresponding to a gaze directed at a respective region within the window, and, in response to detecting the input corresponding to the gaze directed at the respective region within the window, the computer system redisplays the browser toolbar. In some embodiments, the browser toolbar is automatically redisplayed when a gaze input directed at the window is detected (e.g., optionally it is necessary for the gaze to continue to be directed at the window for more than a predetermined non-zero amount of time, e.g., 0.5 second, 1.0 second, or 2 seconds). Automatically (e.g., without further user input) redisplaying the browser toolbar when the device detects that the user is paying attention to the content displayed in the window and/or the browser toolbar, reduces the number and complexity of the user inputs needed to interact with the browser application and/or to switch between the browser application and other applications (e.g., by providing parts of the browser application when a user is ready to interact with these parts).

In some embodiments, the computer system displays the browser toolbar at an angle towards the user, and, while detecting a change in the viewpoint of the user, the computer system updates (e.g., automatically) the angle at which the browser toolbar is displayed towards the user, wherein the updated angle is greater than zero. In some embodiments, as the user's viewpoint changes, so does the angle at which the browser toolbar (and optionally the content window) is displayed. Displaying the browser toolbar (and optionally the currently active window) at an angle towards the user as the user's viewpoint changes improves user's spatial and contextual awareness, and allows the user to change viewpoint without the need to manually adjust the position of the browser toolbar (or the window).

In some embodiments, continuing to display the browser toolbar and the window overlaid on the view of the three-dimensional environment (e.g., even when content in the content window changes) includes displaying the browser toolbar at least partially overlaying the window. For example, in FIG. 7C, browser toolbar 7040 is displayed partially overlaying content window 7030 (and that spatial relationship is optionally maintained even if content in content window 7030 changes in response to switching to another tab). In some embodiments, the browser toolbar is displayed closer to the user than the window (e.g., a webpage) in the three-dimensional environment. Displaying the browser toolbar partially overlaying the window (e.g., a bottom portion or half or other portion of the browser toolbar overlays the content window) while also maintaining a depth separation between the browser toolbar and the window (e.g., the difference in depth is illustrated in FIG. 7C in side view 7024) allows for manipulation of the browser toolbar separately from the window (e.g., hiding, collapsing, or expanding the browser toolbar, or otherwise dynamically changing the browser toolbar in response to user inputs directed to the browser toolbar), thereby maintaining an orderly and uncluttered view of the three-dimensional environment.

In some embodiments, the computer system collapses the browser toolbar, e.g., when changing content in the window. In some embodiments, while the browser toolbar is collapsed, the computer system detects an input interacting with the browser toolbar and, in response to detecting the input interacting with the browser toolbar, the computer system displays an expanded browser toolbar in a form that is different from a respective form of the browser toolbar when collapsed (e.g., the corners of the browser toolbar have different appearance when in collapsed state compared to when in expanded state). In some embodiments, the browser toolbar is a platter that can expand, and, optionally, reveal a number of tabs when expanded. In some embodiments, the browser toolbar in an expanded state includes a number of user interface elements, including: navigation elements (e.g., back button 7046 and forward button 7048 for moving backwards and forward in the sequence of content items or tabs), controls for interaction with the content item (e.g., controls for sharing (e.g., share button 7051 in FIG. 7B), exporting, or downloading one or more content items), search input area or address bar, a refresh button, a button for entering the overview mode, a button for adding/opening a tab, a button for entering a different mode (e.g., a reading mode or an accessibility mode), and/or other controls. In some embodiments, the browser toolbar includes less controls when collapsed than when it is expanded. In some embodiments, collapsing the browser toolbar includes displaying an animation, where the browser toolbar collapses and moves to a different position than its immediately prior position over the course of the animation. In some embodiments, if tabs were displayed in the expanded state of the browser toolbar, the tabs cease to be displayed in the collapsed state. Other groups of controls or user interface elements can cease to be displayed when the browser toolbar is collapsed. For example, in FIG. 7G, in the tab search mode of browser toolbar 7040, in which the browser toolbar is collapsed, sidebar button 7044, back button 7046, forward button 7048, tab overview button 7054, and share button 7051 are not displayed in the browser toolbar 7040 (e.g., are removed from browser toolbar 7040 when transitioning the browser toolbar from an expanded state to a collapsed state). In some embodiments, the browser toolbar is at least partially transparent, which improves visibility of content in the portion of the window that is overlaid by the browser toolbar. Automatically expanding and changing the appearance of the browser toolbar (e.g., displaying additional controls, and/or rounding the corners of the browser toolbar) in response to detecting user interaction with the browser toolbar (e.g., a gaze input and/or selection input) provides visual feedback to the user that improves the user interaction with the device as it informs the user of the changing state of the view of the three-dimensional environment and how it responds to the user's actions, such as gazes, gestures, and other inputs.

In some embodiments, the computer system detects a respective change in the viewpoint of the user and, in response to detecting the respective change, after a predetermined (e.g., non-zero) amount of time has passed, moves the browser toolbar (and, optionally, the content window) in accordance with the respective change in the viewpoint of the user. In some embodiments, the browser toolbar and/or the active window are environment-locked, and thus do not move in response to a change in the viewpoint of the user. However, in some other embodiments, the browser toolbar and/or the active window are viewpoint-locked or point-locked, and exhibit lazy follow behavior. In some embodiments, exhibiting lazy follow behavior includes delaying movement of the browser toolbar and/or the active window when detecting movement of a point of reference to which the browser toolbar and/or the active window are locked. For example, when the point of reference (e.g., a viewpoint of the user) moves, the browser toolbar is moved by the device to remain locked to the point of reference but moves with a delay (e.g., when the point of reference stops moving or slows down, the browser toolbar starts to catch up). In some embodiments, when a browser toolbar and the active window exhibit lazy follow behavior, the device ignores small amounts of movement of the point of reference (e.g., ignoring movement of the point of reference that is below a threshold amount of movement such as movement by 0-5 degrees or movement by 0-25 cm). Exhibiting lazy follow behavior by the browser toolbar and/or the active window provides a user with an opportunity to comfortably move around the physical environment while the view of the three-dimensional environment is not overly sensitive to each slight movement of the user. The delay in movement of the browser toolbar improves responsiveness of the computer system to user movements by avoiding excessively fast adjustments to the position of the browser toolbar, while at the same time ensuring that the browser toolbar and/or active window are within the point of view of the user.

In some embodiments, the browser toolbar (e.g., browser toolbar 7040) is partially transparent. Displaying the browser toolbar as partially transparent improves visibility of the active window (e.g., making portions of the active window below the browser toolbar viewable by the user) and improves the user's context awareness, which improves user safety by helping the user avoid collisions in the physical space.

In some embodiments, in response to detecting the air gesture that meets the fourth gesture criteria and prior to entering the second display mode, the computer system provides an animated transition between the first display mode to the second display mode. Providing an animated transition from the normal browsing mode to the tab overview mode of the browser application provides additional visual feedback to the user that improves the user interaction with the device as it informs the user of the changing state of the view of the three-dimensional environment and how it responds to the user's actions (e.g., gazes, gestures, and other inputs).

In some embodiments, providing the animated transition between the first display mode to the second display mode includes: moving the window vertically in a first direction in the view of the three-dimensional environment and tilting the window towards a respective viewpoint of a user prior to ceasing to display the window, and moving the browser toolbar vertically in a second direction that is opposite of the first direction in the view of the three-dimensional environment. Moving the window up (e.g., vertically in the first direction) and tilting it towards the user (e.g., the window “flies” upward towards the user before it disappears) provides visual feedback to the user that the window is moving out of the scene (e.g., to be replaced with reduced scale representations of webpages associated with open tabs). Such visual feedback improves the user interaction with the device as it informs the user of the changing state of the view of the three-dimensional environment and how it responds to the users' actions (e.g., gazes, gestures, and other inputs).

In some embodiments, aspects/operations of methods 800, 1000, and 1100 may be interchanged, substituted, and/or added between these methods. For example, maintaining the depth difference between the browser toolbar and the content window while changing content in the content window in method 900 is optionally used during scrolling and switching tabs as part of method 800. For brevity, these details are not repeated here.

FIG. 10 is a flow diagram of an exemplary method 1000 for quick switching between tabbed windows in a three-dimensional environment, in accordance with some embodiments. In some embodiments, method 1000 is performed at a computer system (e.g., computer system 101 in FIG. 1) that is in communication with a display generation component (e.g., display generation component 120 in FIGS. 1A, 3, and 4) (e.g., a heads-up display, a head-mounted display (HMD), a display, a touchscreen, a projector, a tablet, a smartphone, etc.) and one or more input devices (e.g., cameras, controllers, touch-sensitive surfaces, joysticks, buttons, etc.). In some embodiments, the method 1000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1000 are, optionally, combined and/or the order of some operations is, optionally, changed.

As described herein, the method 1000 provides an improved gesture mechanism for quick switching of tabs of a browser application in a mixed reality three-dimensional environment. A content item that is active for the browser application is changed in response to an air gesture that includes a hand movement first along a “z” axis (e.g., pushing forward or away from a user) and then along an “x” axis (e.g., laterally, or horizontally). A fast tab switching mode is activated when the movement along the “z” axis satisfies respective gesture criteria (e.g., distance, velocity, configuration of the hand while performing the gesture, gaze direction, hand movement direction and/or other movement criteria). In the fast tab switching mode, content items are scrolled through with a scroll speed determined in accordance with magnitude (e.g., amount and/or speed) of the hand movement, where the speed can optionally be modified by a location of a user's gaze. Accordingly, a user can scroll through more content items in less time while also providing a user with control over the scroll speed (e.g., based on the hand movement magnitude and/or direction of the gaze) without the need to select additional control options or otherwise set the scroll speed though menus navigation and/or selection of user interface elements. The gesture mechanism for quick switching of tabs using hand movements that meet respective criteria, without the need to directly interact with user interface elements, select controls and/or manually set scroll speed, reduces the number, extent, and/or nature of user inputs, and provides additional browsing functionality to a user. Reducing the number of user inputs and providing additional browsing functionality to the user enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently. Further, using mid-air hand movement along two perpendicular axes provides an ergonomically improved mechanism for: activating the fast tab switching mode; efficiently navigating through a large number of content items while allowing a user to conveniently set the scrolling speed through gaze and/or magnitude of the hand movement; disambiguating between user's intent to select a desired content item or continue navigating through the content items; and/or for disambiguating user's intent to move the browser application or to switch to fast tab browsing mode. For example, using mid-air hand movement along two perpendicular axes is ergonomically superior to use of physical handheld devices, which introduce external forces, or other touchless gestures that may impose more strain/stress on the user's hands and/or body. Proving an ergonomically improved gesture mechanism makes the user-system interface more efficient which, additionally, reduces power usage and improves battery life of the system by enabling the user to use the system more quickly and efficiently.

The computer system displays (1002), via the display generation component (e.g., display generation component 120), a first content item (e.g., content window 7030 for webpage “A”) of a plurality of content items (e.g., content items that corresponds to multiple open tabs). In some embodiments, only the first content item is displayed, and the remainder of the content items are hidden from view (e.g., when in a normal browsing mode). In some embodiments, the first content item is a representation of a web page, a document, a note, an email, and/or other content item that includes content such as media content (such as videos and photos, textual content, and/or other visual and/or audio content) in a first region (e.g., a content display region, such as content window 7030). The first content item is overlaying a view of a three-dimensional environment (e.g., content window 7030 is displayed overlaying a view of three-dimensional environment 7000′).

While the first content item is an active content item for an application (e.g., the first content item is displayed in focus in the first region without concurrently displaying other content items that correspond to other tabs (e.g., one content item is displayed at a time in a normal browsing mode)), the computer system detects (1004) a first air gesture that includes movement of a hand (e.g., a hand performing the first air gesture) in a respective direction (e.g., laterally or horizontally) along (e.g., parallel or substantially parallel to) a first axis of movement (e.g., along axis 7202 illustrated in view 7200 in FIG. 7N). For example, at least 50% of the movement is parallel or substantially parallel along the first axis, such that at least half of the movement (e.g., dx²/(dx²+dy²+dz²)>0.5) is along that axis, where dx is the amount of movement along the first axis of movement that is perpendicular to a second axis of movement away from a viewpoint of a user (e.g., in a z direction or along z-axis 7206), such as when the hand is extending further away from the body towards the first content item and/or the browser application, according to the Cartesian xyz-coordinate system.

In some embodiments, the content item is displayed in full size (e.g., rather than at reduced scale). In some embodiments, the application corresponds to a browser application. In some embodiments, the first air gesture includes, prior to detecting the lateral movement of the hand, an air pinch gesture (sometimes called an “inward air pinch”) and movement of the hand forward or further away from the user in the z direction without releasing the air pinch gesture (sometime called an “air push-in gesture”) is detected. In some embodiments, the air pinch gesture involves bringing a finger on either of the user's hand toward, and optionally in contact with, a thumb finger of the same hand. In some embodiments, the first air gesture includes a gaze at a portion in the view of the three-dimensional environment occupied by the first content item (e.g., content window 7030). In some embodiments, the first air gesture includes, after moving the hand in the z direction (e.g., along the second axis), moving the hand horizontally or laterally, such as in a leftward or rightward direction, while the user maintains the air pinch gesture of the first portion of the first air gesture. For example, FIG. 7R illustrates movement of hand 7020 along the x-axis 7202 (e.g., from right to left) in conjunction with maintaining the air pinch gesture performed with hand 7020 (denoted with arrows and state “B”). In some embodiments, the first air gesture ends with releasing of the air pinch (e.g., fingers moving apart after being brought in contact with each other). In some embodiments, a fast tab switching mode is activated in response to detecting a gaze input at an item currently displayed in focus, then an air pinch gesture (e.g., an inward air pinch), and finally an air push gesture while the air pinch is maintained. In some embodiments, a tab is switched in response to the second portion of the input (e.g., in response to the lateral movement. In some embodiments, the tab is selected in accordance with speed, velocity, amount of movement or distance, and/or acceleration of the lateral hand movement (e.g., along x-axis 7202 in view 7200 in FIGS. 7R-7T).

In response to detecting the first air gesture (1006): in accordance with a determination that the first air gesture included movement of the hand in a respective direction along the second axis of movement (e.g., z-axis 7206) that met respective criteria prior to detecting the movement of the hand in the respective direction along the first axis of movement (e.g., x-axis 7202), the computer system switches (1008) from the first content item being the active content item for the application to a second content item of the plurality of content items being the active content item for the application (e.g., active content item is switched from content window 7030 for webpage “A” to content window 7104 for webpage “C” in FIGS. 7N-7V). In some embodiments, when movement of the hand laterally (e.g., along to the first axis of movement) is preceded by movement of the hand further away from a viewpoint of the user (e.g., along the second axis of movement, where the second axis is perpendicular to the first axis), the browser can quickly switch between tabs that correspond to the content items. For example, multiple content items can be displayed in response to the movement of the hand further away from the viewpoint of the user, and the multiple items (including undisplayed content items) can be scrolled or traversed in response to the lateral movement of the hand (e.g., content windows 7030, 7102, 7104, 7106, and 7108 are scrolled through in accordance with movement of hand 7020 along the x-axis 7202 in FIGS. 7S-7U). In some embodiments, the movement of the hand along the second axis of movement (e.g., further away from a user or a viewpoint of a user, such as along z-axis 7206) causes display of the multiple content items (and/or causes the browser application to enter a fast tab switching mode), and the movement of the hand along the first axis (e.g., laterally, such as along x-axis 7202) causes scrolling through the content items, where a respective content item is selected in response to termination of the air gesture (e.g., in response to releasing an air pinch gesture that was maintained during the lateral movement). In some embodiments, a response from a plurality of responses to the first air gesture is determined based at least in part on the hand movement in the direction along the second axis of movement and hand movement in the direction along the first axis of movement. In some embodiments, the plurality of potential responses to the first air gesture include, but are not limited to, activating the fast tab switching mode for efficiently navigating through a large number of content items while allowing a user to conveniently set the scrolling speed through gaze and/or magnitude of the hand movement; disambiguating between user's intent to select a desired content item or continue navigating through the content items; disambiguating user's intent to move the browser application or to switch to fast tab browsing mode; and/or disambiguating user's intent to perform an operation associated with currently active content item and activating the fast tab switching mode.

Switching to the tab switching mode (e.g., transitioning from a normal browsing mode in which one content item is displayed at a time) in response to hand movement in the “z” direction, and then scrolling through the content items in accordance with a lateral movement of the hand reduces the number, extent, and/or nature of inputs necessary to navigate through multiple content items of the same kind, such as web pages, documents, pictures and other content items.

In some embodiments, in response to detecting the first air gesture, in accordance with a determination that the first air gesture did not include movement of the hand in the respective direction along the second axis of movement that met the respective criteria prior to detecting the movement of the hand in the respective direction along the first axis of movement, the computer system moves the application while maintaining the first content item as the active content item for the application. For example, as illustrated in FIG. 7W, which illustrates a transition from FIG. 7O, the browser application (e.g., content window 7030 and/or browser toolbar 7040), are moved in the view of the three-dimensional environment in response to detecting movement of hand 7020 along z-axis 7206 (and optionally along x-axis 7202) that does not meet a respective gesture criteria for activating the fast tab switching mode. In some embodiments, the application (e.g., a browser application) is moved in response to an air pinch gesture detected while a gaze is directed to the first content item and a subsequent lateral hand movement (without releasing the air pinch gesture). For example, the user can move the browser application out of the way (e.g., aside). In some embodiments, even if the lateral hand movement is preceded by movement in the hand away from the viewpoint of the user (e.g., in the z direction or in a direction along to the second axis), if the movement away from the viewpoint of the user is insufficient (e.g., below a threshold amount of movement of the hand in the physical space), then instead of activating a fast tab switching (which would otherwise be activated based on movement of the hand in the direction along to the second axis), the application, including the content item, are moved in accordance with the movement of the hand in the direction along the first axis and/or along the second axis, while the first content item is maintained as active content item. Moving a browser application in the mixed reality three-dimensional environment when a hand movement in the z direction does not meet respective criteria, and activating the fast tab switching mode when the hand movement meets the respective criteria, automatically disambiguates between a user's intent to move the browser application to a new position in the three-dimensional environment or to scroll through the tabs in the fast tab switching mode. Disambiguating between moving the browser application and scrolling through the tabs based on respective gesture criteria allows the user to efficiently interact with the three-dimensional environment (e.g., reducing the number, extent, and/or nature of inputs required to achieve a desired outcome) while providing more control over the mixed reality three-dimensional environment (e.g., a user can manipulate position of the browser application) without cluttering the user interface with additional displayed controls.

In some embodiments, moving the application while maintaining the first content item as the active content item for the application includes moving the first content item further away from a respective viewpoint of the user based on movement of the hand in the respective direction along (e.g., parallel to or substantially parallel to) the second axis of movement (e.g., at least 50% of the movement is parallel or substantially parallel to the second axis of movement). For example, when the portion of the first air gesture that corresponds to movement of the hand in the z direction (e.g., pushing-in while pinching) fails to meet the criteria for activating mode for fast switching of content items, instead of revealing previously undisplayed content items, an active content item (e.g., the first content item) is moved in accordance with the movement of the hand in the physical space. For example, FIG. 7W illustrates that content window 7030 is moved along z-axis 7206 and along x-axis 7202 in accordance with hand movement illustrated in view 7200. Moving a content item in the mixed reality three-dimensional environment in accordance with detected hand movement in the physical space provides additional control to a user over the application and/or the mixed reality three-dimensional environment without cluttering the user interface with additional displayed controls, thereby creating a more efficient human-machine interface.

In some embodiments, moving the application while maintaining the first content item as the active content item for the application includes reducing size of the first content item based on the movement of the hand in the respective direction along the second axis of movement. For example, as content window 7030 is moved further away from the view point of user 7002, size of content window 7030 is reduced from the full size (FIG. 7W). In some embodiments, when the portion of the first air gesture that corresponds to movement of the hand in the z direction (e.g., pushing-in while pinching along z-axis 7206) fails to meet the criteria for activating mode for fast switching of content items, instead of activating the fast switching of items mode, the size of the active content item (e.g., first content item) is reduced as the content item is moved in accordance with the movement of the hand further away from the viewpoint of the user. For example, the further the hand moves the window away from the viewpoint of the user, the smaller the size of the content item becomes. In some embodiments, in response to detecting that the movement of the hand in the z direction has satisfied the respective criteria (e.g., the criteria for switching to fast tab switching), the size of the content item is not further reduced even if the hand continues to move further in the z direction (e.g., any reduction of the size of the content window 7030 is stopped and fast tab switching mode is activated, as illustrated in FIGS. 7P-7Q). In some embodiments, reducing the size of the content item as a user's hand (optionally, while maintaining an air pinch gesture) moves away from the user serves the dual function of providing visual feedback of the movement and/or potential switch to the fast tab switching mode (e.g., tabs that correspond to content items), and freeing up space for more content items that are about to be revealed in response to detecting the movement of the hand in the respective direction along the second axis of movement that meets the respective criteria (e.g., in some embodiments, respective criteria is satisfied if the amount of movement of the hand in the physical space exceeds a predetermined amount of movement). Reducing the size of the content item as a user's hand moves further away from the user serves the dual function of providing visual feedback to the user (e.g., by helping a user to understand the connection between provided hand movement and the device response), and freeing up space in the mixed reality three-dimensional environment (e.g., for previously undisplayed content items).

In some embodiments, the first air gesture includes a gaze input, and switching from the first content item to the second content item being the active content item for the application includes: in response to detecting the hand movement in the direction along the first axis of movement: in accordance with a determination that the gaze input is directed to a first location that is a first distance (e.g., no more than the first distance) away from a location in the three-dimensional environment where the active content item for the application is displayed, scrolling through a plurality of content items with a first scrolling speed; and, in accordance with a determination that the gaze input is directed to a second location that is a second distance (e.g., at least the second distance) away from the location in the three-dimensional environment where the active content item is displayed, scrolling through the plurality of content items with a second scrolling speed, wherein the second distance is greater than the first distance and the second scrolling speed is different than the first scrolling speed (e.g., the second scrolling speed is faster than the first scrolling speed). For example, as illustrated in FIG. 7R, if the gaze of user 7002 is directed at a center of fast tab switcher region 7240 or somewhere along or near central line 7260, then content windows 7030, 7102, 7104, 7106, and 7108 are scrolled with the first speed; and, as illustrated in FIG. 7S, if the gaze of user 7002 is shifted towards left side or edge of fast tab switcher region 7240 while hand 7020 is moving in a leftward direction along the x-axis 7202, then the scrolling speed increases from the first scrolling speed to a second scrolling speed that is faster that the first scrolling speed. The accelerated nature of the scrolling enables users to scroll or traverse a lengthy data set (e.g., list of items) faster and with greater ease. Accelerating or increasing the scroll speed in response to detecting a change in location of a user's gaze, without the need to use the hands and/or interact with user interface elements reduces the number, extent, and/or nature of inputs need from a user and provides an ergonomically improved gesture mechanism for controlling scroll speed of content items in a mixed reality three-dimensional environment, thereby creating a more efficient human-machine interface. In some embodiments, fast tab scrolling (e.g., one where speed of the scrolling can be modified with a gaze input) is enabled when the browser application is in the fast tab switching mode).

In some embodiments, the scrolling speed is modified based on a location of the gaze input relative to a location in the three-dimensional environment where a currently active content item is displayed. For example, if the gaze input is directed at the first content item when the hand movement in the direction along the first axis is detected (e.g., if the gaze of user 7002 is directed at a center of fast tab switcher region 7240 or somewhere along or near central line 7260, as illustrated in FIG. 7R), then scrolling through content items is slower compared to when the gaze input is moved away from the first content item (e.g., away from a central point or line) toward the left or right side of the first content item in the direction along the first axis of movement (e.g., if the gaze of user 7002 is further shifted towards line 7264 (which illustrates a threshold distanced away from central line 7260) while hand 7020 is moving in the leftward direction along the x-axis 7202, as illustrated in FIG. 7S). Modifying the scroll speed based on where location of a gaze is located provides an ergonomically improved gesture mechanism for setting or modifying scroll speed in a mixed reality three-dimensional environment, thereby creating a more efficient human-machine interface.

In some embodiments, when a user gazes towards the left or right away from the first content item but in a direction opposite of the direction of the hand movement along the first axis (e.g., x-axis 7202), then the speed does not increase (e.g., the gaze input does not modify the scrolling speed). In some embodiments, different speed multipliers or acceleration factors are used based on different threshold distances away from the first content item (e.g., away from a central point or line of the content item).

In some embodiments, switching from the first content item being the active content item for the application to the second content item being the active content item for the application further includes selecting the second content item based on magnitude of the movement of the hand in the respective direction along (e.g., parallel to or substantially parallel to) the first axis of movement (e.g., at least 50% of the movement is parallel or substantially parallel to the first axis of movement). For example, as illustrated in FIG. 7V, content window 7104 for webpage “C” is selected to be the active content item for the browser application in accordance with magnitude of hand 7020's movement along x-axis 7202 in FIGS. 7S-7T. In some embodiments, the amount of movement of the hand laterally (e.g., left, or right) in the physical space determines which content is selected. In some embodiments, opened content items that can be browsed through are ordered in a sequence. In some embodiments, the opened content items correspond to tabbed windows. In some embodiments, in response to detecting movement of the hand in the respective direction along the second axis of movement that meets the respective criteria, some or all the opened content item are displayed and/or revealed so that they can be scrolled through in accordance with one or more characteristics of the movement of the hand. For example, the browser application can create a pool or collection of windows that correspond to tabbed content items, where a limited number of the windows are displayed in a viewable region in the mixed reality three-dimensional environment, and more windows from the pool are displayed in the viewable region in accordance with movement of the hand laterally. In some embodiments, the first air gesture comprises a gaze input directed a location occupied by at least a portion of the active content item, an air pinch gesture and a forward movement of the hand away from the viewpoint of the user (e.g., push-in), and then a drag, swoop, or swipe like gesture that laterally (optionally, continuously and/or without interruption) moves (e.g., drags horizontally) the pinched fingers without releasing the pinch. In some embodiments, the air gesture is performed mid-air, e.g., indirectly without contact with the content items, a browser toolbar, or other user selectable interface elements. Content items in the sequence are scrolled in response to and in accordance with the lateral movement of the hand while the pinch gesture is maintained, and the second content item from the sequence of content items is selected based on magnitude of the hand movement in the physical space. In some embodiments, content items are moved from one side to another side in accordance with or based on the direction, amount of movement or distance traveled in the physical space, magnitude, speed, velocity, and/or acceleration of the lateral movement of the hand in physical space, and/or location of a detected gaze input. In some embodiments, upon release of the air pinch, the gesture is completed and a respective tab is selected, and the selected tab becomes the currently active tab. In some embodiments, a release of the air pinch is used as criteria to disambiguate between user's intent to continue navigation through the content items and selecting a desired content item. Determining which content item to select based on the magnitude of a lateral movement of the hand (optionally in combination with other movement and/or gesture criteria, such as location of a user's gaze and a direction of the user's hand movement) in the physical space improves the human-machine interface at least by helping the user to understand the connection between provided inputs and device responses to the inputs in the mixed reality three-dimensional environment, and/or provides an ergonomically improved gesture mechanism for selecting a content item from among the content items available in the browser application.

In some embodiments, switching from the first content item being the active content item for the application to the second content item being the active content item for the application further includes selecting the second content item based on a direction of the movement of the hand along (e.g., parallel to or substantially parallel to) the first axis of movement. For example, content window 7104 for webpage “C” is selected to be the active content item for the browser application in accordance with movement of hand 7020 in a leftward direction along x-axis 7202, as illustrated in FIGS. 7S-7V. In some embodiments, the direction of movement of the hand laterally (e.g., leftward, or rightward) determines which content is selected, optionally, in combination with other movement criteria. For example, if the content item that is currently active is the last one of the sequence prior to detecting the air gesture, and if the air gesture includes movement in a direction that requests to display the next item, optionally, the currently active tab is not switched with another content as the gesture requests to display the next item in the sequence and there is no next content item as the last content item is already displayed. In some embodiments, after the sequence of content items is scrolled to the end, and a request for further scrolling is received in the same direction, the sequence is scrolled from the beginning again (e.g., cycling through the content items). Thus, the direction of the movement determines whether one of the preceding or one of the succeeding content items in the sequence is selected. In some embodiments, content items are moved from one side to another side in accordance with or based on the direction, amount of movement or distance traveled in the physical space, magnitude, speed, velocity, and/or acceleration of the lateral movement, and/or position of the gaze. In some embodiments, upon release of the air pinch, a tab is selected (e.g., the selected tab is a tab that is positioned in a center or a middle slot or spot when the release of the pinch is detected as determined by the magnitude of the lateral movement of the hand), and the selected tab becomes the currently active tab. Determining which content item to select based on the direction of the lateral movement of the hand (optionally, in combination with other movement and/or gesture criteria, such as magnitude of movement and/or location of user's gaze) in the physical space provides an ergonomically improved gesture mechanism for selecting a content item from among multiple content items in the browser application and/or improves the human-machine interface at least by providing a mechanism for selecting a desired content item without the need to select a user interface element or interacting directly with a user interface element.

In some embodiments, prior to detecting movement of the hand in the respective direction along the first axis of movement (e.g., x-axis 7202), the computer system detects movement of the hand in the respective direction along the second axis of movement (e.g., z-axis 7206). In some embodiments, in response to detecting the movement of the hand in the respective direction along the second axis of movement, in accordance with a determination that the movement of the hand in the respective direction along the second axis of movement meets the respective criteria, the computer system displays two or more of the plurality of content items (e.g., while maintaining the first content item as the active content item for the application) (e.g., in an array). For example, in response to detecting that hand 7020 is moved a predetermined amount of distance along z-axis 7206 reaching point 7208 in the coordinate system of the three-dimensional environment (e.g., a Cartesian coordinate system as shown in view 7200 in FIGS. 7N-7P, or another coordinate system such as a radial coordinate system), content windows 7030, 7102, 7104, 7106, and 7108 are displayed (FIGS. 7P-7Q). Content items are switched in response to movement of the hand in the respective direction along the first axis of movement (e.g., x-axis 7202). In some embodiments, the content items correspond to tabbed windows that are open. In some embodiments, the browser application is associated with a group of windows that correspond to tabbed content items, where a limited number of the windows are displayed in a viewable region (e.g., a fast tab switcher region 7240) in the mixed reality three-dimensional environment, and the limited number of windows from the group are replaced (optionally incrementally, e.g., one by one) with additional windows that are revealed in the viewable region in accordance with movement of the hand laterally.

In some embodiments, a first portion of the first air gesture that corresponds to movement of the hand in the direction along the second axis of movement that met respective criteria (e.g., pushing forward or away from the viewpoint of the user along z-axis 7206 while maintaining an air pinch) determines whether fast tab switching mode is activated. In response to detecting the first portion of the first air gesture multiple open items that are opened are displayed in the viewable region for browsing and selecting a target/desired content item. In other words, as soon as the movement in the z direction meets the criteria necessary to switch to fast tab switching mode, the two or more of the plurality of content items are revealed, and the second portion of the air gesture is used to scroll through, traverse, and/or select a desired item. In some embodiments, as the user moves the hand laterally, the tabbed windows that are displayed in the viewable region change. For example, if a user moves the hand in a leftward direction, previously undisplayed windows from the group of windows appear from the right side, and as the user continues to move the hand in the same direction, the windows that appear move from the right side to the left side as other previously undisplayed windows from the group appear. In some embodiments, a user can traverse or scroll through the tabbed windows in a loop, where windows from the group rotate in the viewable region (e.g., fast tab switcher region 7240) until the first air gesture has been completed and/or terminated. Revealing multiple opened content items in response to detecting movement of a hand in the z direction that meets respective gesture criteria performs an operation (e.g., displaying at least a subset of the content items that can be traversed or scrolled through) when a set of conditions has been met (e.g., movement of a hand in the z direction that meets the respective gesture criteria) without requiring further user input, and serves the function of providing visual feedback that the browsing mode has been changed (e.g., from displaying one active content item at a time to concurrently displaying multiple content items that can be scrolled), and/or provides additional control options without cluttering the user interface with additional displayed controls.

In some embodiments, prior to detecting movement of the hand in the respective direction along the first axis of movement (e.g., x-axis 7202), the computer system detects movement of the hand in the respective direction along the second axis of movement (e.g., z-axis 7206). In some embodiments, in response to detecting the movement of the hand in the respective direction along the second axis of movement: in accordance with a determination that the movement of the hand in the respective direction along the second axis of movement meets the respective criteria, the computer system activates a mode for switching content items in response to movement of the hand in the respective direction along the first axis of movement (e.g. sometimes referred to as “the fast tab switching mode”). In some embodiments, a first portion of the first air gesture that corresponds to movement of the hand in the direction along the second axis of movement that met respective criteria (e.g., pushing forward or away from the viewpoint of the user along z-axis 7206 while maintaining an air pinch) determines whether the fast tab switching has been activated. In the fast tab switching mode, multiple content items are displayed, and the second portion of the air gesture is used to select a desired item (optionally, the target content item is included in the multiple content items that are initially displayed or the target content item can subsequently be revealed in response to the second portion of the air gesture corresponding to movement of the hand in the respective direction along the first axis of movement). Using a mid-air hand movement in a “z” direction to switch to a mode for tab switching (e.g., fast browsing) provides an ergonomically improved gesture mechanism for selecting a content item from among multiple content items in the browser application and/or provides additional control options without cluttering the user interface with additional displayed controls. For example, the improved gesture mechanism does not require menu navigation, use of hand-held controllers, or direct interaction with user interface elements, thereby reducing the number, extent, and/or nature of user inputs for activating the tab switching mode and selecting a specific user interface element.

In some embodiments, while detecting the movement of the hand in the respective direction along the second axis of movement, the computer system provides (e.g., continuous) audio feedback that increases in volume as the hand moves further away from the viewpoint of the user and approaches a predetermined threshold, which once met, activates a mode for switching content items in response to movement of the hand in the respective direction along the first axis of movement. In some embodiments, audio feedback is provided during a portion of the first air gesture that corresponds to movement in the z direction. In some embodiments, the portion of the movement in the z direction determines whether (fast) tab switching would be activated or not, based on different criteria, including distance traveled and/or velocity of the movement of the hand. Thus, the audio feedback continuously guides the user until the movement of the hand in the respective direction along the second axis of movement satisfies the respective criteria. For example, in FIG. 7P, audio feedback is provided that increases in volume as the hand movement along z-axis 7206 gets closer to the threshold where the fast tab switching mode is activated, e.g., as hand 7020 gets closer to point 7208. In some embodiments, in accordance with a determination that the fast tab switching mode has been activated, the audio feedback is stopped, thereby indicating that the user has successfully activated the fast tab switching mode. In some embodiments, audio feedback is combined with visual feedback, where the audio output increases in volume as the hand movement gets closer to the threshold and a currently active content item (e.g., the one that is active when the movement of the hand in the z direction) decreases in size as the hand movement gets closer to the threshold. Generating and providing audio output, which increases in volume as a user's hand movement gets closer to a threshold where tab switching can occur, provides improved feedback to a user about a (changing) state of the device and/or assists a user in switching to fast tab switching mode by providing continued and/or guided human-machine interaction process.

In some embodiments, the first air gesture includes a respective selection input (e.g., an air pinch gesture where an index or other finger touches or is brought into contact with a thumb finger of the same hand) that is maintained while the first air gesture is being detected, and, in response to detecting termination (e.g., release of the air pinch gesture) of the respective selection input, the computer system stops the audio feedback. In some embodiments, termination of the selection input corresponds to termination of the first air gesture, and the audio feedback is stopped in response to detecting termination of the first air gesture. Ceasing to provide audio output when the tab selection gesture is complete, provides improved feedback to a user about a state of the device and/or assists a user in switching to a different tab/content item by providing continued and/or guided human-machine interaction process.

In some embodiments, in response to detecting the first air gesture, the computer system determines a response from a plurality of responses to the first air gesture based at least in part on a comparison of velocity of the movement of the hand in the respective direction along the second axis of movement (e.g., movement of the hand forward in the “z” direction or further away from user 7002 along z-axis 7206, while optionally maintaining an pinch gesture) and velocity of the movement of the hand in the respective direction along the first axis of movement (e.g., x-axis 7202), including: in accordance with a determination that that velocity of the movement of the hand in the respective direction along the second axis of movement (e.g., z-axis 7206) is greater than the velocity of the movement of the hand in the respective direction along the first axis (e.g., x-axis 7202) of movement by at least a predetermined amount, activating a mode for switching content items in response to movement of the hand in the respective direction along the first axis of movement (e.g., the fast tab switching mode is activated in FIG. 7Q). In some embodiments, in accordance with a determination that velocity of the movement of the hand in the respective direction along the second axis of movement (e.g., z-axis 7206) is greater than the velocity of the movement of the hand in the direction along the first axis of movement (e.g., x-axis 7202) by at least a predetermined amount, a plurality of content items are displayed while maintaining the first content item as the active content item for the application (e.g., content windows 7102, 7104, 7106, and 7108 are displayed while maintaining content window 7030 as the active window in FIG. 7Q). Determining whether to activate the fast tab switching mode in response to hand movement further away from a viewpoint of a user based at least in part on a comparison of velocity of the movement of the hand in the direction along the “z” axis of movement and the velocity of the movement of the hand in the direction along the “x” axis of movement disambiguates user's intent to scroll content or change the browsing mode while providing tolerance for varying hand or posture performance (e.g., minimizing misidentification of unintentional gestures), thereby reducing the number, extent, and/or nature of inputs necessary to transition to a different browsing mode, and/or provides additional control options without cluttering the user interface with additional displayed controls.

In some embodiments, in response to detecting the first air gesture, the computer system determines a response from a plurality of responses to the first air gesture based at least in part on a comparison of velocity of the movement of the hand in the respective direction along the second axis of movement (e.g., z-axis 7206) and velocity of the movement of the hand in a respective direction along a third axis (e.g., y-axis 7204) of movement perpendicular to the first axis of movement and the second axis of movement, including: in accordance with a determination that that velocity of the movement of the hand in the respective direction along the second axis of movement (e.g., z-axis 7206) is greater than the velocity of the movement of the hand in the direction along the third axis of movement (e.g., y-axis 7204) by at least a predetermined amount, activating a mode for switching content items in response to movement of the hand in the respective direction along the first axis of movement (e.g., fast tab switching mode is activated in FIG. 7Q). In some embodiments, the comparison between the velocity of the hand movement in the respective direction along the second axis of movement (e.g., z-axis 7206) and the velocity of the hand movement in a respective direction along the third axis of movement (e.g., y-axis 7204) disambiguates between horizontal scrolling the content of the content item that is currently active and activating the mode for switching content items. In others, comparing velocity of the movement in the z direction to velocity of the movement in the y direction helps disambiguate between vertical scrolling of the content in the content and activating the mode for switching of content items (e.g., the fast tab switching mode). In some embodiments, in accordance with a determination that velocity of the movement of the hand in the respective direction along the second axis of movement is greater than the velocity of the movement of the hand in the direction along the third axis of movement by at least a predetermined amount, a plurality of content items are displayed while maintaining the first content item as the active content item for the application (e.g., content windows 7102, 7104, 7106, and 7108 are displayed while maintaining content window 7030 as the active window in FIG. 7Q). Determining whether to activate a tab switching mode in response to hand movement further away from a viewpoint of a user based at least in part on a comparison of velocity of the movement of the hand in the direction along the “z” axis of movement (e.g., z-axis 7206) and the velocity of the movement of the hand in the direction along the “y” axis of movement (e.g., y-axis 7204) disambiguates user's intent to scroll content or change the browsing mode while providing tolerance for varying hand or posture performance (e.g., minimizing misidentification of unintentional gestures), thereby reducing the number, extent, and/or nature of inputs necessary to transition to a different browsing experience, and/or provides additional control options without cluttering the user interface with additional displayed controls.

In some embodiments, the predetermined amount corresponds to the velocity of the movement of the hand in the respective direction along the second axis of movement being at least a predefined multiple (e.g., at least 1.5, 2, or another multiple greater than 1) of the velocity of the movement of the hand along the third axis of movement. In some embodiments, the velocity of the hand movement along the second axis of movement equals or is greater than the velocity of the hand in the direction along the third axis of movement multiplied by an integer (e.g., the velocity of the hand movement in the z direction equals 5 times the velocity of the hand movement in the y direction, if any). Activating a tab switching mode in response to hand movement in the “z” direction (e.g., z-axis 7206) that has velocity that exceeds the velocity of the hand movement along the “y” axis of movement (e.g., y-axis 7204) multiplied by a predefined multiple (e.g., greater than 1), disambiguates user's intent to scroll content or change the browsing mode while providing tolerance for varying hand or posture performance, including minimizing misidentification of unintentional gestures, thereby reducing the number, extent, and/or nature of inputs necessary to transition to a different browsing experience, and/or provides additional control options without cluttering the user interface with additional displayed controls.

In some embodiments, the first air gesture includes a first portion that corresponds to a selection input. (e.g., direct, or indirect selection input). In some embodiments, the movement of the hand in the respective direction along to the second axis of movement (e.g., z-axis 7206) begins with or includes a selection input that corresponds to a pinch gesture. For example, FIG. 7N illustrates movement of hand 7020 of user 7002 along z-axis 7206 (e.g., further away from user 7002 in a depthwise direction) while hand 7020 maintains an air pinch gesture (e.g., an index finger and a thumb finger of hand 7020 are in contact), denoted with state “B” and arrows near hand 7020. In some embodiments, the selection input is indirect user input (e.g., an air pinch with one hand, an air pinch performed with two hands (e.g., bimanual), or other air gesture that does not involve direct interaction with a user interface). In some embodiments, the selection input further includes a gaze input. For example, a pinch and a gaze directed at a particular user interface element will cause a selection of the particular user interface element. Using a mid-air hand movement gesture, which includes a beginning portion corresponding to a selection input (e.g., a touchless air pinch gesture) provides an improved gesture mechanism for disambiguating between selecting a specific user interface element and activating a tab switching mode and/or provides additional control options without cluttering the user interface with additional displayed controls. For example, the improved gesture mechanism does not require menu navigation, use of hand-held controllers, or direct interaction with user interface elements, thereby reducing number, extent, and/or nature of user inputs and/or provides an ergonomically improved mechanism for activating the tab switching mode and selecting specific user interface element.

In some embodiments, prior to detecting the movement of the hand in the respective direction along the first axis of movement or the second axis of movement, and in accordance with a determination that the first portion of the first air gesture is stationary, the computer system performs a respective selection operation. In some embodiments, what content or user interface element is selected is determined based on location of a gaze input detected at the time of detection of the selection input (e.g., at the time the pinch gesture is detected). In some embodiments, the user selectable element at which a user is gazing at the time of performing a pinch while the hand remains stationary (e.g., without further movement of the hand in the x-, y-, or z-direction), is the user selectable element that is selected and actions, if any, associated with the user selectable element are performed. For example, the gaze input can be directed to a respective user interface element within the content item (e.g., a link within a webpage, or control within an email), a respective action associated with the respective user interface is performed (e.g., a new web page associated with the selected link is opened, or a new email message is opened in response selecting a menu button for creating a new email). In other examples, the gaze input can be directed at controls in a browser toolbar of the browser application or at other user selectable elements. Disambiguating between activating a tab switching mode and performing a selection operation based on whether the first air gesture is stationary provides an improved gesture mechanism that reduces the number of user inputs necessary to activate the tab switching mode and/or provides additional control options without cluttering the user interface with additional displayed controls.

In some embodiments, in response to detecting the first air gesture: in accordance with a determination that the first air gesture is not preceded by movement of the hand in the respective direction along the second axis of movement (e.g., z-axis 7206), and that movement of the hand in the respective direction along the first axis (e.g., x-axis 7202) is an initial movement of the hand during the first air gesture, the computer system maintains the first content item as the active content item for the application (e.g., forgoing switching from the first content item to the second content item in response to the first air gesture). Maintaining the first content item as the active content item for the application in accordance with a determination that the hand moves laterally first (e.g., without being preceded by movement of the hand in the respective direction along the second axis of movement), disambiguates between activating tab switching mode and performing another operation such as horizontal scrolling, and/or distinguishes from unintentional hand movements.

In some embodiments, in response to detecting the first air gesture: in accordance with a determination that the first air gesture is not preceded by movement of the hand in the respective direction along the second axis of movement (e.g., z-axis 7206), and that movement of the hand in the respective direction along the first axis (e.g., x-axis 7202) is the initial movement of the hand during the first air gesture, the computer system performs an operation in the first content item (e.g., an operation in the application with respect to the first content item). Examples of such operations include, but are not limited to, navigating to an adjacent content item (e.g., previous, or subsequent content item in a sequence of opened content items), selecting a button and/or other control or user interface element, selecting a hyperlink, scrolling through content, controlling media such as playing video and/or audio multimedia content, and/or other operation. Performing an operation in the first content item in accordance with a determination that the hand moves laterally first (e.g., without preceded by movement of the hand in the respective direction along the second axis of movement) disambiguates between activating tab switching mode and performing another operation such as horizontal scrolling or navigating to an adjacent content item and/or provides additional control options without cluttering the user interface with additional displayed controls. For example, the improved gesture mechanism does not require menu navigation, use of hand-held controllers, or direct interaction (e.g., interaction based on touch) with user interface elements, and thereby reduces the number of user inputs for activating the tab switching mode and performing other operations.

In some embodiments, performing the operation in the first content item includes scrolling through content of the first content item, including revealing a previously un-displayed portion of content of the first content item. Scrolling through content of the first content item in accordance with a determination that the hand moves laterally first (e.g., it is not preceded by movement of the hand in the respective direction along the second axis of movement) disambiguates between activating tab switching mode and (horizontal) scrolling of content of the first content item.

In some embodiments, in response to detecting the movement of the hand in the respective direction along the second axis of movement (e.g., z-axis 7206) when the first portion of the first air gesture that corresponds to the selection input is maintained prior to detecting the movement of the hand in the respective direction along the first axis of movement (e.g., x-axis 7202): in accordance with a determination that the movement of the hand in the respective direction along the second axis of movement meets the respective criteria, the computer system displays two or more of the plurality of content items (optionally, while maintaining the first content item as the active content item for the application). For example, content windows 7102, 7104, 7106, and 7108 are displayed while maintaining content window 7030 as the active window in FIG. 7Q. In some embodiments, a first portion of the air gesture that corresponds to movement of the hand in the direction along the second axis of movement that met respective criteria (e.g., pushing forward or away from the viewpoint of the user along z-axis 7206 while maintaining a pinch) determines whether (fast) tab switching is activated. In response to detecting the first portion of the air gesture multiple open items that are opened are displayed for browsing through and selecting a target/desired content item. In other words, as soon as the movement in the z direction meets the criteria necessary to switch to the fast tab switching mode, the multiple open items are revealed, and the second portion of the air gesture is used to select the desired item. Determining whether to display other content items in addition to the currently active content item in accordance with a determination that a user's hand moves in the “z” direction while maintaining the selection input enables activation of tab switching mode without cluttering the user interface with additional displayed controls, and without the need for menu navigation, use of hand-held controllers, and/or direct (or touch-based) interaction with user interface elements.

In some embodiments, in response to detecting the movement of the hand in the respective direction along the first axis of movement, the computer system scrolls through the plurality of content items in accordance with the movement of the hand in the respective direction along the first axis of movement (e.g., x-axis 7202), wherein the second content item is selected in response to detecting release of the selection input (e.g., when the pinch gesture is released, the content item that is in the center (e.g., a virtual slot or position in fast tab switcher region 7240 that was previously occupied by the first content item prior the detecting the lateral movement) or that is most closely located to the center is selected (e.g., where “scrolling through” is understood to mean scrolling through at least a subset or two or more of the plurality of content items)). Scrolling through content items based on or in accordance with a mid-air (or touchless) lateral movement of the hand provides an ergonomically improved gesture mechanism for selecting a content item from among multiple content items in a browser application and/or provides additional control options without cluttering the user interface with additional displayed controls. For example, the improved gesture mechanism does not require menu navigation, use of hand-held controllers, or direct interaction with user interface elements, thereby reducing the number of user inputs needed to select different content item.

In some embodiments, the computer system provides an audible sound (e.g., a tick) each time a new content item is displayed in a location (e.g., a virtual slot or respective position in fast tab switcher region 7240 that is centrally located relative to other content items in the sequence of content items that are opened) in the view of the three-dimensional environment that was previously occupied by the first content item (e.g., content window 7030) prior to detecting the first air gesture. For example, in FIGS. 7S-7U, there are two audible sounds that are generated, e.g., one for content window 7102 that takes the place of content window 7030 in the center position of fast tab switcher region 7240, and one for content window 7104 that takes the place of content window 7102 in the center position of fast tab switcher region 7240. In some embodiments, each time another content item replaces the content item that is currently in focus and/or displayed in a center slot of an array of content items that is displayed in the fast tab switching mode, an audible tick sound is provided to indicate to the user that the currently active content item has been switched and/or that the navigation progresses. In some embodiments, when the first gesture is terminated (e.g., upon release of a pinch gesture). Generating an audible sound whenever a different content item is displayed or moved into a respective central position in the set of content items (e.g., in the middle relative to other content items that are ordered in a sequence) provides improved feedback to a user about a (changing) state of the device and/or indicates to the user that the currently active content item has been switched and/or that the navigation progresses.

In some embodiments, the computer system provides an audible sound (e.g., a tick) when a content item (e.g., a content item corresponding to a tab of a browser application) is moved, in accordance with the scrolling through the content items, into a respective position previously occupied by another content item of the plurality of content items in accordance with the scrolling. For example, in FIGS. 7S-7U, there are two audible sounds that are generated for each content item that is navigated through, e.g., one for content window 7102 and one for content window 7104. In some embodiments, each content item navigated is an open content item associated with a tab in the application, and a clicking sound is provided each time that a tab has been browsed through. Generating an audible sound when a different content item is navigated through provides improved feedback to a user about a (changing) state of the device and/or indicates to the user that the currently active content item has been switched and/or that the navigation progresses.

In some embodiments, in response to detecting the movement of the hand in the respective direction along the first axis of movement (e.g., x-axis 7202), the computer system scrolls through the plurality of content items, wherein: in accordance with a determination that the movement of the hand is in a first direction, the scrolling is in a first scrolling direction; and, in accordance with a determination that the movement of the hand is in a second direction, the scrolling is in a second scrolling direction that is different from the first scrolling direction (e.g., in accordance with the direction and amount of movement of the lateral movement of the hand) (e.g., where “scrolling through” is understood to mean scrolling through at least a subset or two or more of the plurality of content items). For example, when user 7002 moves hand 7020 along x-axis 7202 in a leftward direction in FIG. 7T, as illustrated in view 7200, content windows 7102, 7104, 7109, 7030, 7106, and 7108 are scrolled through in the leftward direction, and if user 7002 moves hand 7020 along x-axis 7202 in a rightward direction, content windows 7102, 7104, 7109, 7030, 7106, and 7108 are scrolled through in the rightward direction. Scrolling through content items based on or in accordance with a direction of a mid-air lateral movement of a user's hand provides an ergonomically improved gesture mechanism for selecting a content item from among multiple content items in a browser application and/or provides additional control options without cluttering the user interface with additional displayed controls. For example, the improved gesture mechanism does not require menu navigation, use of hand-held controllers, or direct interaction with user interface elements, thereby reducing the number of user inputs needed to select different content item.

In some embodiments, in response to detecting the movement of the hand in the respective direction along the first axis of movement, the computer system scrolls through the plurality of content items, wherein: in accordance with a determination that the movement of the hand has a first magnitude (e.g., amount of movement and/or speed), the scrolling has a first scrolling magnitude (e.g., amount of movement and/or speed); and, in accordance with a determination that the movement of the hand has a second magnitude (e.g., amount of movement and/or speed), the scrolling has a second scrolling magnitude (e.g., amount and/or speed) that is different from the first scrolling magnitude. For example, when user 7002 moves hand 7020 along x-axis 7202 in in FIG. 7T with a first velocity, content windows 7102, 7104, 7109, 7030, 7106, and 7108 are scrolled through with a first speed, and if user 7002 moves hand 7020 along x-axis 7202 in a second velocity (e.g., different from the first velocity), content windows 7102, 7104, 7109, 7030, 7106, and 7108 are scrolled through with a second speed. Scrolling through content items based on or in accordance with a magnitude of a mid-air lateral movement of a user's hand provides an ergonomically improved gesture mechanism for selecting a content item from among multiple content items in a browser application and/or provides additional control options without cluttering the user interface with additional displayed controls. For example, the improved gesture mechanism does not require menu navigation, use of hand-held controllers, or direct interaction with user interface elements, thereby reducing the number of user inputs needed to select different content item.

In some embodiments, in response to detecting termination of the selection input, the computer system selects the second content item to be active for the application, wherein the second content item is selected from the plurality of content items (e.g., other content items opened in the browser application). In some embodiments, the plurality of content items are displayed in response to detecting the movement of the hand away from the viewpoint of the user (e.g., movement of hand 7020 along z-axis 7206 that satisfies a respective gesture criteria for activating the fast tab switching mode in FIG. 7N-Q). In some embodiments, additional opened content items that were previously un-displayed are revealed in accordance with a scrolling input (e.g., lateral movement of hand 7020 along x-axis 7202 while the air pinch gesture is maintained in FIGS. 7R-7U). In some embodiments, the second content item is selected from the set that is originally displayed in response to the movement away from the viewpoint of the user or from a different set of opened items that are further revealed in response to one or more scrolling inputs that include movement of the hand laterally. Determining which content item to select from among multiple content items in response to detecting termination of a selection input (optionally, in combination with other movement and/or gesture criteria, such as magnitude and direction of movement and location of user's gaze) provides an ergonomically improved gesture mechanism for selecting a content item from among multiple content items in the browser application and/or improves the human-machine interface at least by providing a mechanism for selecting a desired content item without the need to interact directly with a user interface element.

In some embodiments, the second content item is selected in accordance with a determination that the second content item was in focus when termination of the selection input is detected. For example, as illustrated in FIG. 7U, the termination of the selection input is detected when content window 7104 is in focus and displayed at the center position of fast tab switcher region 7240, and, as illustrated in FIG. 7V, content window 7104 is selected to be the currently active content window for the browser application. In some embodiments, the first content item that was active and in focus prior to switching to the second content item occupied a center (e.g., virtual) spot among other slots for other content items in a sequence of ordered content items that are opened but not in focus, and therefore, not in the center. In some embodiments, the respective content item that is currently displayed and/or located in the slot for the active content item (e.g., the center), when the termination of the selection input is detected (e.g., a release of the pinch), is the content item that is selected as the active content item. For example, if content item “X” is in the middle or center position among a sequence of content items (e.g., among an array or one-dimensional gird, e.g., 1×N) when the end of the first air gesture is detected, content item “X” is selected as the active content item. Selecting a content item that is in focus when termination of a selection input is detected provides an ergonomically improved gesture mechanism for selecting a content item from among multiple content items in the browser application and/or improves the human-machine interface at least by providing a mechanism for selecting a desired content item without the need to interact directly with a user interface element.

In some embodiments, the second content item is selected as the active content item for the application in accordance with a determination that movement of the hand in a third direction (e.g., in a z direction towards the view point of the user) along the second axis of movement is detected, wherein the third direction is opposite of the respective direction along the second axis of movement (e.g., the movement of the hand in the third direction is analogous to liftoff of a contact, but implemented by lifting the hand back toward a viewpoint of the user). In some embodiments, a respective content item that is in focus is selected by moving the hand back towards the user or in a direction towards the viewpoint of the user. For example, instead of releasing the pinch gesture, the hand can be moved back towards the viewpoint of the user (e.g., backwards in the z dimension, provided there was a movement forward in the z dimension was previously detected). In other words, the content item that is in the center (e.g., at the slot that was previously occupied by the first content item prior the detecting the lateral movement) is selected in response to detecting movement of the hand in the z direction towards the user (e.g., as opposed to away from the user). For example, if user 7002's hand in FIG. 7U is moved along z-axis 7206 towards user 7002, content window 7104 is selected to be currently active for the browser application. Determining which content item to select from among multiple content items in response to detecting movement of a user's hand towards a user (e.g., towards a user's viewpoint or body as opposed to away from the user's viewpoint or body) provides an ergonomically improved gesture mechanism for selecting a content item from among multiple content items in the browser application and/or improves the human-machine interface at least by providing a mechanism for selecting a desired content item without the need to directly interact with a user interface element.

In some embodiments, the first content item corresponds to a first tab (e.g., content of the first tab) and the second content item corresponds to a second tab (e.g., content of the second tab) of the application (e.g., which is a browser application). Selecting an open tab in response to detecting lateral movement of a user's hand that is preceded by movement of the user's hand in the “z” direction provides an ergonomically improved gesture mechanism for selecting an open tab from among multiple open tabs in the browser application and/or improves the human-machine interface at least by providing a mechanism for selecting a desired tab without the need to directly interact with a user interface element.

In some embodiments, prior to detecting movement of the hand in the respective direction along the first axis of movement (e.g., x-axis 7202), the computer system detects movement of the hand in the respective direction along the second axis of movement (e.g., z-axis 7206). In some embodiments, in response to detecting the movement of the hand in the respective direction along the second axis of movement (e.g., z-axis 7206): in accordance with a determination that the movement of the hand in the respective direction along the second axis of movement meets the respective criteria, the computer system concurrently displays portions of (or, optionally, all of) two or more of the plurality of content items, wherein the two or more of the plurality of content items correspond to a plurality of tabs of the application. For example, in response to detecting that hand 7020 is moved a predetermined amount of distance along z-axis 7206 reaching point 7208 in the coordinate system of the three-dimensional environment (e.g., a Cartesian coordinate system as shown in view 7200 in FIG. 7P, or another coordinate system such as a radial coordinate system), content windows 7030, 7102, 7104, 7106, and 7108 are displayed (FIGS. 7P-7Q). Revealing multiple opened tabs in response to detecting movement of a hand in the z direction that meets a respective gesture criteria performs an operation (e.g., displaying at least a subset of the content items that can be traversed or scrolled through) when a set of conditions has been met (e.g., movement of a hand in the z direction that meets the respective gesture criteria) without requiring further user input, thereby providing additional control options without cluttering the user interface with additional displayed controls.

In some embodiments, concurrently displaying two or more of the plurality of content items includes displaying a respective source indication for each content item of the two or more of the plurality of content items. In some embodiments, the respective source indication is displayed near the respective content item with which it is associated. For example, the source indication can be below a bottom edge or above a top edge of the content item. For example, window grabbers 7030a, 7102a, 7204a, 7106a, and 7108a in addition to serving a function to move respective windows, the window grabs can include source identifying information of the respective windows (FIG. 7Q). In some embodiments, if the content items are webpages, a respective source indication can correspond to the URL address, the name of the web page, a logo associated with the webpage, and/or similar source identifier. In some embodiments, if the content item is a document, the source identifier can correspond to a title of the document. Revealing multiple opened content items and displaying indications of the sources of their content in response to detecting movement of a hand in the z direction that meets a respective gesture criteria performs an operation (e.g., displaying at least a subset of the content items and indication of the sources of their content) when a set of conditions has been met (e.g., movement of a hand in the z direction that meets the respective gesture criteria) without requiring further user input, serves the function of providing visual feedback that the browsing mode has been changed (e.g., from displaying one active content item at a time to concurrently displaying multiple content items and their source indicator that can be scrolled), and/or provides additional control options without cluttering the user interface with additional displayed controls.

In some embodiments, the first content item is a first webpage (e.g., content window 7030 for webpage “A” in FIG. 7N) and the second content item is a second webpage (e.g., content window 7104 for webpage “C” in FIG. 7V). In some embodiments, content items are webpages, and the application is a web browser application. Switching to a (fast) tab switching mode in response to hand movement in the “z” direction, and then scrolling through the webpages in accordance with a lateral movement of the hand reduces the number, extent, and/or nature of inputs necessary to navigate through multiple web pages.

In some embodiments, the computer system displays, via the display generation component, a browser toolbar for the application, the browser toolbar including a selectable user interface element for adding a new tab that when selected opens a tab for a respective new content item (e.g., browser toolbar 7040 includes tab button 7052 for adding a new tab in FIG. 7N). In some embodiments, the application is a browser application and a browser toolbar for the browser application is concurrently displayed with the active content item (e.g., optionally the browser toolbar is hidden while fast tab switching mode is activate and/or while scrolling through the content items). In some embodiments, the browser toolbar includes one or more controls or selectable user interface elements, such as navigation controls, an address bar or a search bar (e.g., for providing identifying information that can be used by the browser application for locating desired content), a control for opening or adding new tabs, a control for sharing content, a control for showing all currently opened tabs, a control for closing all tabs, a control associated with each tab for closing the associated tab, and/or a refresh control to update displayed content. Displaying an affordance to add or open a new tab (optionally in a browser toolbar) provides visual feedback indicating how additional tabs can be added in response to user input, and reduces the number of inputs needed to do so.

In some embodiments, the computer system displays, via the display generation component, a browser toolbar for the application, the browser toolbar including an interface element for searching content items (e.g., search field 7082 or address bar 7042). In some embodiments, the browser toolbar includes one or more controls or selectable user interface elements, including an address bar or a search bar (e.g., for providing identifying information that can be used by the browser application for locating desired content (e.g., on the internet, or within the plurality of content items (e.g., open tabs))). Displaying user interface for searching open tabs (optionally in a browser toolbar) provides visual feedback indicating how open tabs can be found (in addition to scrolling), and reduces the number of inputs needed to do so.

In some embodiments, activating the mode for switching content items includes displaying, in a virtual region of the three-dimensional environment, two or more of the plurality of content items, wherein the virtual region is positioned in the three-dimensional environment based at least partially on a location of the first content item prior to detecting the first air gesture. For example, in FIG. 7Q, content windows 7030, 7102, 7104, 7106, and 7108 are displayed in fast tab switcher region 7240, and fast tab switcher region 7240 is positioned in the view of the three-dimensional environment 7000′ based at least partially on a location of content window 7030 prior to detecting the movement of hand 7020 along z-axis 7206 (e.g., prior to detecting the gesture that activated the fast tab switching mode). In some embodiments, the virtual region corresponds to a fast tab switcher region in the view of the three-dimensional environment that includes a grid of content items, where the grid can include one or more dimensions. For example, in some embodiments, the content items are displayed in an array (e.g., a 1×N grid). In some embodiments, the content items are displayed in a 2D grid, such as an N×M grid, where N and M are both greater than or equal to 2, depending on the number of content items that are currently opened and the browsing mode that is currently activate. For example, if the fast tab switching mode is active, in some embodiments, the content items are displayed in an array (e.g., not all open content items are visible if the number of items exceed the number of items that can fit in the virtual region 7240 in FIG. 7Q), whereas if a mode for displaying an overview of all currently open items is active, reduced scale representations of the content items are displayed in a grid which all currently content items are displayed (e.g., grid 7045 in FIG. 7G). Positioning a fast tab switcher region based on where an active window was located provides visual feedback about a state of the device (e.g., indicating that the browser application is switched from normal browsing mode to fast tab switching mode).

In some embodiments, while the two or more of the plurality of content items are displayed in the virtual region and while the mode for switching content items is activated, a respective location of the virtual region in the three-dimensional environment remains fixed. For example, in FIG. 7G, the fast tab switcher region 7240, including content windows 7030, 7102, 7104, 7106, and 7108 displayed in the fast tab switcher region 7240, cannot be repositioned or moved to a different location in the view of the three-dimensional environment 7000′. In some embodiments, once the mode for fast tab switching is activated, the location of the content items (e.g., as displayed within the borders of the designated virtual region), cannot be repositioned, sometimes called being “world locked.” Maintaining the fast tab switcher region at a fixed position while displaying and/or scrolling through content items helps a user stay focused on browsing content items while maintaining an uncluttered view of the three-dimensional environment.

In some embodiments, prior to detecting the first air gesture, the computer system displays a first user interface element for selecting the first content item (e.g., window grabber 7030a for selecting and moving content window 7030 in FIG. 7Q). For example, when in normal mode, a window grabber is displayed near the window, where a user can reach out and grab with a hand the window grabber and move the window while holding onto the window grabber. In some embodiments, in response to the detecting the first air gesture, the computer system ceases to display the first user interface element. In some embodiments, the window grabber is hidden when the overview mode is active. In some embodiments, after selecting the first content item, the first content item is moved to a new location in the three-dimensional environment in accordance with movement of the hand during the first air gesture. Hiding an affordance for grabbing (or otherwise selecting) and moving a content item when the fast tab switching mode is active, provides visual feedback about a state of the device (e.g., indicating that the browser application is switched from normal browsing mode to fast tab switching mode).

In some embodiments, prior to switching focus away from the first content item, the computer system detects termination of the first air gesture (e.g., an air depinch gesture, or a release of an air pinch gesture). For example, in FIG. 7S, if termination of the air pinch gesture is detected when content window 7030 has shifted slightly away from central line 7260 but before content window 7030 has been replaced with content window 7102 at the center position in the fast tab switcher region 7240, then content window 7030 snaps back automatically to the central position in the fast tab switcher region 7240, without switching to another content item. In some embodiments, in response to detecting termination of the first air gesture, the computer system automatically moves (e.g., by snapping) the first content item back to a location the first content item was in before detecting the movement of the hand in the respective direction along the first axis of movement. Automatically snapping a content item back to its original position when the focus has not been moved to another content item in response to a lateral movement of the hand, provides visual feedback to a user indicating that the hand movement is insufficient to change focus to another content item.

In some embodiments, prior to detecting the movement of the hand in the respective direction along the first axis of movement (e.g., x-axis 7202) and while the first content item is the active content item for the application (e.g., content window 7030 in FIG. 7S), the computer system detects a user input directed at the first content item (e.g., an air pinch gesture selecting the first content item or an air pinch and pull gesture that pulls the first content item towards the user or the user's viewpoint). In some embodiments, in response to detecting the user input directed at the first content item, the computer system moves (e.g., by snapping) the first content item back to a respective location the first content item was in before detecting the user input directed at the first content item (e.g., moves back to center as illustrated in FIG. 7R). When a user interacts with a content item (e.g., in response to an air pinch or an air pinch and pull gesture), the content item is snapped back to its original position (e.g., in response to a release of an air pinch gesture), thereby providing visual feedback to a user indicating that an air gesture that is used to interact with the content item cannot cause movement of the content item to a different position and/or also providing a continued and/or guided human-machine interaction process.

In some embodiments, aspects/operations of methods 800, 900, and 1100 may be interchanged with, substituted for, and/or added to these methods. For example, the fast tab switching mode described in relation to method 1000 can be used in combination with the tab navigation and tab overview techniques described in relation to method 800. For brevity, these details are not repeated here.

FIG. 11 is a flow diagram of an exemplary method 1100 for viewing an overview of multiple content items of the same kind in a three-dimensional environment while reducing visual prominence of remaining portions of the view of the three-dimensional environment, in accordance with some embodiments. In some embodiments, method 1100 is performed at a computer system (e.g., computer system 101 in FIG. 1) that is in communication with a display generation component (e.g., display generation component 120 in FIGS. 1A, 3, and 4) (e.g., a heads-up display, a head-mounted display (HMID), a display, a touchscreen, a projector, a tablet, a smartphone, etc.) and one or more input devices (e.g., cameras, controllers, touch-sensitive surfaces, joysticks, buttons, etc.). In some embodiments, the method 1100 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1100 are, optionally, combined and/or the order of some operations is, optionally, changed.

As described herein, the method 1100 provides an improved mechanism for viewing an overview of multiple content items of the same kind (e.g., webpages, images, documents) in a mixed reality three-dimensional environment in response to a contactless air gesture. An overview mode or a fast tab switching mode is activated in response to an air gesture (optionally combined with a gaze input), where content items are visible in the three-dimensional environment as reduced scale representations and prominence of other portions of the mixed-reality three-dimensional environment is reduced, thereby allowing a user to focus on viewing and/or exploring the content items (e.g., reducing unrelated distractions in the mixed-reality three-dimensional environment). The air gesture mechanism allows a user to switch to a different browsing or viewing mode without the need to navigate menus, to use of hand-held controllers, or to directly interact with user interface elements, thereby providing an ergonomically improved gesture mechanism and reducing the number, extent, and/or nature of user inputs needed to activate the overview mode (e.g., switch from viewing one content item at a time to viewing multiple content items at the same time).

While a view of a three-dimensional environment is visible via the display generation component, the computer system displays (1102) a first content item (e.g., the first content item is a representation of a web page, a document, a note, an email, and/or other content item that includes content such as media content, such as videos and photos, textual content, and/or other visual and/or audio content) of a plurality of content items at a first size in a first region in the view of the three-dimensional environment. In some embodiments, real world and/or virtual content are visible via the display generation component in the view of the three-dimensional environment. In some embodiments, the first region displays a currently active web page, document, note, and/or other types of content that can be browsed in a browser application. In some embodiments, the first content item is concurrently displayed with a browser toolbar that includes plurality of opened tabs that correspond to the plurality of content items. In some embodiments, the browser toolbar and the first content item appear to float in the three-dimensional environment. In some embodiments, the browser toolbar and the first content item are separated. In some embodiments, the browser toolbar includes a number of controls, including a search address field.

While the first content item is displayed in the first region at the first size, the computer system detects (1104) a first gesture (e.g., air gesture). In some embodiments, the air gesture includes a gaze at a selectable user interface element and a pinch gesture with one hand. In some embodiments, the air gesture includes a gaze at a portion in the first region and a pinch gesture with two hands. In some embodiments, the air gesture includes a gaze at a portion in the first region and a pinch and push forward gesture with one hand. In some embodiments, the user input includes performing a pinch gesture with each hand.

In response to detecting the first gesture (1106): the computer system concurrently displays (1108) the first content item and a first set of one or more content items of the plurality of content items. The first content item and the first set of one or more content items are displayed as reduced scale representations. For example, in response to detecting the air pinch gesture while the gaze of user 7002 is directed at tab overview button 7054, the tab overview mode is activated and reduced scale representations of webpages “A”-“F” 7070-7080 are displayed in place of content window 7030 (FIGS. 7F-7G). In another example, in response to detecting that hand 7020 is moved along z-axis 7206 and satisfies a respective gesture criteria, the fast tab switching mode is activated and content windows 7030, 7102, 7104, 7106, and 7108 for webpages “A”, “B”, “C”, “Z”, and “Y” are displayed at reduced scale (FIGS. 7P-7Q) In some embodiments, the plurality of content items, including the first set of one or more content items, are not visible prior to detecting the air gesture when the first content item is displayed in the first region. In some embodiments, in response to the air gesture, one or more content items that were previously not displayed (e.g., open tabs that were hidden from display) are revealed as the first content item shrinks in response to the first air gesture. In some embodiments, the first content item also moves in a z direction. For example, the computer system concurrently shrinks and moves the first content item (content window 7030) forward in the z direction further away from user 7002 in accordance with movement of hand 7020 along z-axis 7206, as illustrated in FIGS. 7N-7Q.

In addition, in response to detecting the first gesture (1106): the computer system visually deemphasizes (1110) one or more portions of the view of the three-dimensional environment. The one or more portions of the view of the three-dimensional environment that are visually deemphasized are visible concurrently with the first content item and the first set of one or more content items. In some embodiments, as the first set of content items are revealed and the first content item is displayed at a reduced size, a view of the three-dimensional environment around the displayed content items is blurred, dimmed, displayed with reduced brightness and/or transparency and other ways to reduce the prominence of the surrounding three-dimensional environment. For example, the view of the three-dimensional environment 7000′ in FIG. 7G is dimmed, blurred or hidden while reduced scale representations of “A”-“F” 7070-7080 remain visible and prominently displayed (not illustrated in FIG. 7G). In another example, as illustrated in FIGS. 7X-7Y (e.g., FIGS. 7Y1-7Y3), portions of the view of the three-dimensional environment 7000′ that are not occupied by content windows 7030, 7102, 7104, 7106, and 7108, and corresponding window grabbers 7030a, 7102a, 7204a, 7106a, and 7108a are dimmed, blurred, darkened, hidden or otherwise visually deemphasized. In some embodiments, visually deemphasizing the surrounding the three-dimensional environment provides visual feedback indicating, for example, entering the tab overview mode or the fast tab switching mode in which multiple content items are concurrently displayed and can be quickly browsed and switched. In some embodiments, in the tab overview mode or the fast tab switching mode, the user can quickly and efficiently switch between different tabs in response to an air gesture, e.g., in contrast to a normal browsing mode.

In some embodiments, visually deemphasizing one or more portions of the view of the three-dimensional environment includes: reducing a visual prominence of a respective portion of the view of the three-dimensional environment that is visible before the first gesture is detected. For example, representations (or optical view) of walls 7004′, 7006′, and 7008′, representation (or optical view) of physical object 7014′ and any unoccupied free space in the representation (or optical view) of the three-dimensional environment 7000′ is darkened or blurred (as illustrated in FIG. 7X) or hidden from the representation (or optical view) of the three-dimensional environment 7000′ (as illustrated in FIG. 7Y (e.g., FIGS. 7Y1-7Y3)). In some embodiments, portions of the view of the three-dimensional environment around or not occupied by displayed content items are blurred, dimmed, displayed with reduced brightness and/or transparency, and/or other ways to reduce the prominence of the three-dimensional environment surrounding the displayed content items so that the user can focus on locating a desired content items as opposed to being distracted with the surrounding environment. Reducing visual prominence of portions of the mixed-reality three-dimensional environment that are not occupied by displayed content items (e.g., deemphasizing passthrough portions of the mixed-reality three-dimensional environment) allows a user to focus on viewing and/or exploring the content items by reducing unrelated visual content in the mixed-reality three-dimensional environment that would otherwise be potentially distracting to the user and/or provides visual feedback to a user indicating change of state of the electronic device (e.g., transitioning from one mode to viewing content to an overview mode).

In some embodiments, reducing the visual prominence of the respective portion of the view of the three-dimensional environment includes one or more of blurring, darkening, or hiding the respective portion of the view of the three-dimensional environment. Blurring, darkening, and/or hiding portions of the mixed-reality three-dimensional environment that are not occupied by displayed content items (e.g., deemphasizing passthrough portions of the mixed-reality three-dimensional environment) allows a user to focus on viewing and/or exploring the content items by reducing the visibility of unrelated visual content (potential distractions) in the mixed-reality three-dimensional environment and/or provides visual feedback to a user indicating change of state of the electronic device (e.g., transitioning from one mode to viewing content to an overview mode).

In some embodiments, at least a portion of the three-dimensional environment is visible after the first gesture is detected. For example, representations (or optical view) of walls 7004′, 7006′, and 7008′, and representation (or optical view) of physical object 7014′ remain visible even when their visual prominence is reduced (FIG. 7X). Reducing visual prominence without completely hiding portions of the mixed-reality three-dimensional environment that are not occupied by displayed content items (e.g., deemphasizing passthrough portions of the mixed-reality three-dimensional environment) allows a user to focus on viewing and/or exploring the content items by reducing the visibility of unrelated visual content (potential distractions) in the mixed-reality three-dimensional environment while also maintaining visibility of the surrounding environment and/or provides visual feedback to a user indicating change of state of the electronic device (e.g., transitioning from one mode to viewing content to an overview mode).

In some embodiments, in response to detecting the first gesture, the computer system activates an overview mode in which currently opened content items are concurrently displayed for selection. In some embodiments, currently opened content items correspond to a respective open tab that can be selected. In some embodiments, in the overview mode, a user can glance at multiple open tabs at the same time without the need to scroll through them. In some embodiments, the opened content items are displayed as reduced scale representations. For example, in response to detecting the air pinch gesture while the gaze of user 7002 is directed at tab overview button 7054, the tab overview mode is activated and reduced scale representations of webpages “A”-“F” 7070-7080 are displayed in place of content window 7030 (FIGS. 7F-7G). Activating an overview mode in response to an air gesture (optionally combined with a gaze input), where multiple content items are concurrently visible in the three-dimensional environment (e.g., as reduced scale representations) provides an efficient human-machine interaction allowing a user to switch to a different browsing or viewing mode without the need to navigate menus, use hand-held controllers, or directly interact with user interface elements, thereby providing an ergonomically improved gesture mechanism and reducing the number, extent, and/or nature of user inputs needed to activate the overview mode (e.g., switch from viewing one content item at a time to viewing multiple content items).

In some embodiments, the respective content items of the plurality of content items correspond to respective webpages. In some embodiments, the tabs correspond to documents, emails, notes, photos, applications and/or other visual and/or audio content. A browser toolbar (“chrome”) of a browser application includes a plurality of tabs corresponding to two or more of the webpages (e.g., two or more of the plurality of content items). In some embodiments, the browser is an application for searching, exploring and navigating content, including, but not limited to, web pages, notes, emails, documents. The browser toolbar (e.g., browser toolbar 7040) is a graphical user interface that includes controls for navigating and locating the content, including, but not limited to, user interface element for entering identifying information that can be used by the browser application to locate desired content, a control for opening new tabs, a control for sharing content, a control for showing all currently open tabs, a control for closing a set of multiple tabs or all tabs, a control associated with each tab for closing the associated tab, a refresh control to update displayed content, and other controls. Tabs are used for changing a content item that is in focus (by selecting a different tab in response to a direct or indirect gesture). The browser toolbar (e.g., browser toolbar 7040 in FIGS. 7B and 7N) is concurrently displayed with the first content item (e.g., content window 7030). In some embodiments, at least some of the tabs are visible in the browser toolbar (and can be selected) when the browser toolbar is in an expanded state. In some embodiments, the number of visible tabs depends on factors such as the number of opened tabs, the size of a tab, and the size of the toolbar, and/or the size of the display. In some embodiments, a browser application includes a first region (e.g., content display region) in the graphical user interface dedicated for displaying browsed content, and another region (e.g., toolbar display region) for displaying the browser toolbar. In some embodiments, in addition to browsing, navigation, and searching of content, the browser application can be used to perform other functions, such as marking content as favorite, opening a new tab, reviewing browsing history, activating different browsing modes (e.g., the tab overview mode). In some embodiments, the browser toolbar includes one or more controls that correspond to the one or more of the functions provided by the browser application.

In some embodiments, the first gesture includes an air pinch gesture with one hand of a user and a push movement of the hand away from a viewpoint of the user while the air pinch gesture is maintained. For example, hand 7020 is moved along z-axis 7206 in a direction further away from user 7002 while an air pinch gesture is maintained (denoted with arrows near hand 7020 and stated “B” in FIGS. 7N-7P). In some embodiments, the air gesture corresponds to an air two-finger pinch (e.g., a thumb brought in contact with or towards another finger of the same hand) performed with one hand and a push movement of the same hand performed while the two-finger pinch is maintained (e.g., a one-handed air pinch and air push gesture). In some embodiments, the air pinch-and-push gesture is combined with a gaze input at area in the view of the three-dimensional environment that is occupied by a user selectable element for entering overview mode or otherwise displaying all currently opened items. In some embodiments, an air pinch-and-push gesture can be used to activate the fast tab switching and the tab overview mode. In some embodiments, disambiguation between activating the tab overview mode and the fast tab switching mode is determined based on or more criteria of the movement of the hand away from the viewpoint of the user (e.g., moved in the z direction). For example, if the hand moves further away from the viewpoint of the user by a first predetermined amount, the fast tab switching mode can be activated in which content items can be scrolled through in response to lateral movement of the hand. On the other hand, if the hand continues to move even further away from the viewpoint of the user by a second predetermined amount, the overview mode is activated in which all opened content items are concurrently displayed. Thus, in some embodiments, the portion of the gesture that corresponds to the movement of the hand in the z direction helps disambiguate between the two modes. In other embodiments, this and other movement criteria can be used such as velocity of the movement, direction, magnitude, and other criteria. In some embodiments, it thus is possible for a user to efficiently switch from fast tab switching mode (e.g., see method 1000) to the tab overview mode. In some embodiments, if the hand moves backward in the z-direction towards the viewpoint of the user, the computer can switch from the overview mode back to the fast tab switching mode, and finally back to the normal browsing mode, e.g., depending on the distance/velocity and other gesture criteria of the movement of the hand in the z direction. Activating an overview mode in response to an air pinch-and-push gesture (optionally combined with a gaze input), where multiple content items are concurrently visible in the three-dimensional environment (e.g., as reduced scale representations) provides an efficient human-machine interaction allowing a user to switch to a different browsing or viewing mode without the need to navigate menus, use hand-held controllers, or directly interact with user interface elements, thereby providing an ergonomically improved gesture mechanism and reducing the number, extent, and/or nature of user inputs needed to activate the overview mode (e.g., switch from viewing one content item at a time to viewing multiple content items).

In some embodiments, the first gesture includes a change in distance between a first hand of a user and a second hand of the user while the first hand of the user and the second hand of the user are performing an air gesture (e.g., a two-handed air pinch gesture). In some embodiments, the pinch gesture performed with the two hands of the user (e.g., a two-handed air pinch gesture) is combined with a gaze input at area in the view of the three-dimensional environment). Activating an overview mode in response to a two-handed air pinch gesture (optionally combined with a gaze input), where multiple content items are concurrently visible in the three-dimensional environment (e.g., as reduced scale representations) provides an efficient human-machine interaction allowing a user to switch to a different browsing or viewing mode without the need to navigate menus, use hand-held controllers, or directly interact with user interface elements, thereby providing an ergonomically improved gesture mechanism and reducing the number, extent, and/or nature of user inputs needed to activate the overview mode (e.g., switch from viewing one content item at a time to viewing multiple content items).

In some embodiments, the first gesture includes a first two-finger air pinch gesture with one hand of a user that is followed by a second two-finger air pinch gesture with the same hand. In some embodiments, the air gesture that activates the overview (or expose) mode is a double air pinch gesture which corresponds to repeating the same two-finger pinch gesture twice (e.g., consecutively without undue delay so that the computer system can detect that both repetitions of the two-finger pinch are part of the same air gesture). In some embodiments, in accordance with a determination that the first two-finger air pinch and the second two finger air pinch gesture are both detected within a predetermined time threshold, the overview mode is activated; and in accordance with a determination that the first two-finger air pinch and the second two-finger air pinch gesture are detected outside the predetermined time threshold (e.g., the second two-finger air pinch gesture is delayed or detected after the predetermined time threshold has passed), a different operation is performed (e.g., selecting a link or playing a video). For example, if the second two-finger air pinch gesture is delayed or detected after the predetermined time threshold has passed, then the first two-finger air pinch and the second two-finger air pinch gesture are detected as separate inputs (e.g., separate selection inputs). Activating an overview mode in response to double air pinch gesture (optionally combined with a gaze input), where multiple content items are concurrently visible in the three-dimensional environment (e.g., as reduced scale representations) provides an efficient human-machine interaction allowing a user to switch to a different browsing or viewing mode without the need to navigate menus, use hand-held controllers, or directly interact with user interface elements, thereby providing an ergonomically improved gesture mechanism and reducing the number, extent, and/or nature of user inputs needed to activate the overview mode (e.g., switch from viewing one content item at a time to viewing multiple content items).

In some embodiments, a respective scale of the representations of the plurality of content items, including the first content item, is based at least in part on a number of the plurality of content items that are concurrently displayed. For example, the more content items are opened, the smaller the scale of the representations of the content items, so that all content items can fit within the field of view of the user such that one glance without unnecessary head movements is sufficient to provide overview of all currently opened content items. For example, the scale of representations 7070-7080 in FIG. 7G can be reduced if there are more open webpages to display in the overview mode. Where the content items in the overview mode are displayed as reduced scale representations, the scale is based on the number of content items that are displayed, thereby maximizing the number of content items that can be displayed at the same time without unduly reducing the size of the content items.

In some embodiments, the computer system detects a second gesture (e.g., an air pinch gesture followed by a drag input, where the air pinch gesture can be a single-finger air pinch gesture (e.g., a thumb in contact with one other finger of the same hand) or multiple-finger air pinch gesture (e.g., a thumb in contact with one two or more other finger of the same hand). In response to detecting the second gesture, the computer system scrolls through the plurality of content items, including displaying one or more previously un-displayed content items of the plurality of content items. For example, content windows 7030, 7102-7104, 7106, and 7108 displayed in FIGS. 7X-Y are scrolled in response to moving hand 7020 laterally while hand 7020 maintains the air pinch gesture. In some embodiments, scrolling through the content items in response to the second gesture can be based on or performed in accordance with location, direction, and/or magnitude of the second gesture. Scrolling content items in the overview mode (FIG. 7G) or the fast tab switching mode (FIGS. 7X-7Y (e.g., FIGS. 7Y1-7Y3)) in response to an air gesture without the need to navigate menus, use hand-held controllers, or directly interact with user interface elements, provides an ergonomically improved gesture mechanism and reduces the number, extent, and/or nature of user inputs needed to browse through a large number of content items.

In some embodiments, concurrently displaying the first content item and the first set of one or more content items of the plurality of content items includes concurrently displaying all currently opened content items. In some embodiments, in the overview mode (FIG. 7F), all currently opened items (e.g., of the plurality of content items) are concurrently displayed, such that all currently opened items are visible at the same time and the content items cannot be scrolled (e.g., since there are no opened content items that are not displayed, there is no need for scrolling to reveal additional content items). Activating an overview mode in response to an air gesture (optionally combined with a gaze input), where all currently opened content items are concurrently visible in the three-dimensional environment (e.g., as reduced scale representations) provides an efficient human-machine interaction allowing a user to switch to a different browsing or viewing mode without the need to navigate menus, use hand-held controllers, or directly interact with user interface elements, thereby providing an ergonomically improved gesture mechanism and reducing the number, extent, and/or nature of user inputs needed to activate the overview mode (e.g., switch from viewing one content item at a time to viewing multiple content items).

In some embodiments, the computer system detects a third gesture (e.g., a selection gesture, such as an air pinch gesture optionally combined with a gaze input). In some embodiments, in response to detecting the third gesture, the computer system selects a respective content item of the plurality of content items and moves the respective content item from a first location to a second location in the view of the three-dimensional environment. For example, webpage “F” 7080 in FIG. 7G can be selected via an air pinch gesture while a gaze input is directed at webpage “F” 7080, and can be dropped (via releasing the air pinch gesture) at a location outside grid 7045, thereby creating a separate instance of the browser application that includes a content window for webpage “F” (not illustrated in FIG. 7G). In some embodiments, the third gesture is an air gesture that corresponds to a drag and drop operation. For example, a respective content item can be selected in response to a gaze input directed at the respective (e.g., target) content item and a pinch gesture (e.g., a one hand pinch gesture with two fingers). In some embodiments, while maintaining the pinch gesture (e.g., without releasing the fingers, such as maintaining contact between the two fingers), further input is receiving moving the content item (e.g., a window representing content of the content item) from its current location to a new location. In some embodiments, the content item is moved to the new location in response to release of the pinch gesture. In some embodiments, the content item can be dropped over another window, thereby creating a group of content items (e.g., a group of two windows that correspond to representations of content of the content items). In some embodiments, the content item can be moved to the side. In some embodiments, the content item can be dismissed if it is moved beyond predetermined amount from a field of view of one or more cameras capturing the three-dimensional environment. Where in the overview mode, multiple open content items are concurrently displayed, the content items can be dragged and dropped (optionally instantiating another user interface for the browser application) in response to an air gesture. Dragging and dropping content items displayed in the overview mode in response to an air gesture without the need to navigate menus, use hand-held controllers, or directly interact with user interface elements, provides an ergonomically improved gesture mechanism and reduces the number, extent, and/or nature of user inputs needed to browse through a large number of content items.

In some embodiments, each of the plurality of content items corresponds to a webpage, and the computer system displays one or more representations of one or more webpage groups concurrently with the plurality of content items. In some embodiments, the content items are open webpages each associated with a corresponding tab for tabbed browsing, and the application is a web browser application. In some embodiments, webpages that are open can be grouped together in response to user input or automatically in response to certain condition being met for automatically grouping opened tabs. In some embodiments, webpage groups, if any, as well as the plurality of open webpages are displayed in response to activating the overview mode. In some embodiments, in the overview mode, open content items (e.g., webpages) are grouped (e.g., automatically according to a predetermined criteria or in response to a user input, such as input creating group of tabs) and displayed in respective group representations. Displaying multiple open webpages in webpage groups (optionally while in the overview mode) in response to an air gesture (e.g., an air gesture activating the overview mode, or a different air gesture directed at a user interface element for displaying webpage groups) without the need to navigate menus, use hand-held controllers, or directly interact with user interface elements, provides an ergonomically improved gesture mechanism and reducing the number, extent, and/or nature of user inputs needed to needed to view and/or browser though multiple open items.

In some embodiments, each of the plurality of content items corresponds to a webpage. In some embodiments, the computer system detects a fourth gesture (e.g., a selection gesture, such as an air pinch gesture optionally combined with a gaze input) and, in response to detecting the fourth gesture, displays one or more representations of one or more webpage groups without concurrently displaying content items, of the plurality of content items, not included in the one or more webpage groups. In some embodiments, webpage groups, if any, are displayed in response to selection input of a user selectable affordance that causes display of webpage groups. In some embodiments, the affordance for displaying the webpage groups is visible only if there are any webpage groups. In some embodiments, the input that triggers displaying the webpage groups includes a gaze input directed at the user selectable affordance for displaying webpage groups and an air gesture, such as a pinch gesture (e.g., a two-finger pinch with one hand where two fingers such as thumb and index or thumb and middle finger touch each other tips). In some embodiments, the representations of all webpage groups are displayed, optionally, without concurrently displaying other content items. In some embodiments, a representation of a webpage group can include reduced scale representations of each webpage in the group. In some embodiments, a webpage from the webpage group can be selected directly in response to gaze at the reduced scale representation of window and a pinch gesture. In some embodiments, the air gesture can be direct input, where the user can select the webpage or the webpage group by directly contacting or interacting the representation of the webpage or the webpage group. Displaying multiple open webpages in webpage groups (optionally while in the overview mode) in response to an air gesture directed at a user interface element for displaying webpage groups without the need to navigate menus, use hand-held controllers, or directly interact with user interface elements, provides an ergonomically improved gesture mechanism and reducing the number, extent, and/or nature of user inputs needed to view and/or browser though multiple open items.

In some embodiments, each of the plurality of content items corresponds to a webpage. In some embodiments, the computer system displays the browser toolbar that includes a plurality of user selectable controls, including navigation controls and a search input area. In some embodiments, in response to detecting the first gesture, the computer system collapses the browser toolbar, including ceasing to display the plurality of user selectable controls while maintaining display of the search input area. In some embodiments, in response to activating the overview mode, a state of the browser toolbar is changed from displaying one set of controls and/or information, such as information displaying a URL address of a currently active webpage, to displaying another set of controls and/or information (e.g., the browser toolbar is transformed to a user interface for search and/or filtering webpages). For example, in response to the air pinch gesture while the gaze of user 7002 is directed at tab overview button 7054, in addition to activating the tab overview mode, browser toolbar 7040 dynamically changes, including replacing address bar 7042 for entering a web page address with a search field 7082 for searching currently open webpages and tabs (FIG. 7G). Changing state of the browser toolbar (by displaying set of controls or user interface elements for searching or filtering open webpages) in response to activating the overview mode (in response to an air gesture) provides a different input mechanism for searching multiple open webpages without the need to navigate menus, use hand-held controllers, or directly interact with user interface elements, thereby providing an ergonomically improved gesture mechanism and reducing the number, extent, and/or nature of user inputs needed to view and/or browser though multiple open items.

In some embodiments, a first subset of the content items concurrently displayed as reduced scale representations are displayed angled (e.g., tilted) relative to a respective viewpoint of the user (e.g., while a second subset of the content items concurrently displayed as reduced scale representations are displayed so as to directly face the viewpoint of the user). For example, webpage “A” 7070 and webpage “D” 7076 on the left side (or first column in grid 7045), and webpage “C” 7074 and webpage “F” 7080 on the right side (or last column in grid 7045) are displayed angled towards user 7002, as illustrated in side view 7024 in FIG. 7G. In some embodiments, the content items concurrently displayed as reduced scale representations are displayed in a grid (e.g., grid 7045). In some embodiments, the first subset of the content items concurrently displayed as reduced scale representations corresponds to reduced scale representations that are displayed at lefthand and righthand sides (e.g., laterally opposite edges) of the grid (e.g., first and last columns in the grid). In some embodiments, displaying the reduced scale representations tilted relative to the viewpoint of the user includes displaying portions of the representations at an angle towards or away from the user. For example, content items in a middle column are displayed front facing the user (e.g., they are not displayed at an angle), whereas content items displayed at the end columns are displayed at an angle towards or away from the viewpoint of the user, where the angle is greater than or less than zero. In some embodiments, displaying content items at an angle allows the user to see more content items without the need to rotate his or her head. Displaying content items that are located at a left and right edges angled relative to a user (or a user's viewpoint) provides improved visual feedback to the user while also utilizing (e.g., increasing) the potions of the three-dimensional environment that are visible.

In some embodiments, the computer system displays the browser toolbar that includes a user selectable affordance for creating a new tab (e.g., tab button (e.g., control) 7052 in FIG. 7G). In some embodiments, the browser toolbar corresponds to a graphical user interface element that includes navigation controls, address or search bar, a refresh control, a control for opening new tabs, a control for sharing content, a control for showing all currently opened tabs, etc. In some embodiments, while the computer system displays the browser toolbar, the computer system receives a fourth gesture selecting the affordance for creating a new tab. In response to receiving the fourth gesture, the computer system creates a new tab and displays a new content item as the active item for the browser application, the new content item associated with the new tab. In some embodiments, when the application is in normal mode (e.g., when one content item is displayed at a time), optionally, a browser toolbar is displayed concurrently with the currently active content item that is displayed at a full-size (e.g., regular size representation as opposed reduced scale). In some embodiments, the browser toolbar includes a number of tabs each corresponding to an open content item. In some embodiments, in response to creating a new window, a new tab is included in the browser toolbar that is, optionally, also displayed (e.g., within the browser toolbar or optionally, near the content item itself). Providing a control or other user interface element for opening or creating a new tab, provides a different input mechanism for creating new tabs, without the need to navigate menus, or use hand-held controllers, thereby reducing the number, extent, and/or nature of user inputs needed to view and/or browser though multiple open items.

In some embodiments, the computer system displays the browser toolbar, including concurrently displaying the plurality of tabs corresponding to the two or more of the plurality of content items. In some embodiments, the computer system detects a selection input selecting a tab displayed in the browser toolbar from the plurality of tabs. In some embodiments, in response to detecting the selection input, and while maintaining the selection input, the computer system moves the selected tab away from the browser toolbar. In some embodiments, the selection input is indirect input. For example, the selection can correspond to a gaze at a target tab and a pinch gesture. In some embodiments, the selection input is direct input and includes the user using their hand to grab and move the tab while holding it in mid-air. In some embodiments, in response to detecting termination of the selection input (e.g., release of the pinch gesture or a drop of the selected tab), the computer system creates a new window having content of a content item corresponding to the selected tab. For example, user 7002 can grab tab 7062 from browser toolbar 7040 in FIG. 7C and create a new content window for webpage “B” associated with tab “B” 7062. In some embodiments, the selected tab is visually separated from the plurality of tabs in the browser toolbar such that the selected tab is not navigated in response to a request for scrolling through the plurality of tabs included in the browser toolbar. In some embodiments, a new window is created in response to a user dragging a tab from the browser toolbar (e.g., the browser toolbar can correspond to a platter user interface element) and dropping it somewhere in the view of the three-dimensional environment (e.g., sufficiently away from the browser toolbar and/or any content item). In some embodiments, when a new window is created in such a way, a new instance of the browser application is created, and a new instance of the browser toolbar is associated with the new window. Dragging a tab out of a browser toolbar in response to air gesture to create a new window (with content of the selected tab) without the need to navigate menus, use hand-held controllers, or directly interact with user interface elements, provides an ergonomically improved gesture mechanism and reduces the number, extent, and/or nature of user inputs needed to open a new window in the browser application based on an existing tab.

In some embodiments, the computer system detects a first input selecting a first window representing a first target content item from the plurality of content items, wherein the first input is performed with a first respective hand. In some embodiments, in response to detecting the first input, the computer system selects the first window. In some embodiments, the first input selecting the first window is a direct input, where a user can grab a window (e.g., by selecting a user interface element that corresponds to a window grabber) with a first hand (e.g., a left hand). In some embodiments, the first input is indirect input in which the user does not interact directly with a user interface element. For example, first input can correspond to a gaze input at the first window a pinch gesture with one hand (e.g., left hand). In some embodiments, while the first input selecting the first window is maintained (e.g., if direct input, while the user is still holding the window grabber with a hand, or, if indirect, while the user is still pinching mid-air (e.g., before release of the pinch that would result in termination of the selection input)), the computer system detects a second input selecting a second window representing a second target content item from the plurality of content items, wherein the second input is performed with a second respective hand different from the first respective hand. In some embodiments, the second input selecting the second window is a direct input in which, for example, the user grabs the window grabber associated with the second window with a second hand (e.g., right hand), different from the first hand. In some embodiments, the second input is indirect input in which the user does not interact directly with a user interface element. For example, second input can correspond to a gaze input at the first window a pinch gesture with the second hand (e.g., left hand). In some embodiments, while the first input and the second input are maintained, the computer system detects a change in distance between the first window and the second window such that the first window and the second window are combined in one window group representation that includes the first window and the second window. In some embodiments, the window group representation can be dragged and dropped such that the windows in the group are moved together as part of moving the window group representation. Using two hands and corresponding air gestures to move and group windows together without the need to navigate menus or use hand-held controllers, provides an ergonomically improved gesture mechanism and reduces the number, extent, and/or nature of user inputs needed to create a group out of existing content items.

In some embodiments, activating the overview mode includes displaying, in a virtual region of the three-dimensional environment (e.g., a tab overview region), two or more of the plurality of content items, wherein the virtual region is positioned in the three-dimensional environment based at least partially on a location of the first content item prior to detecting the first gesture. In some embodiments, grid 7045 or fast tab switcher region 7240 are positioned based on where the active item was located prior to entering the overview mode or the fast tab switching mode, respectively. In some embodiments, visual feedback is provided when switching from normal mode, in which a currently active item is displayed in a central region, to the overview mode, in which all opened items are displayed in non-overlapping manner so that their content is visible. In some embodiments, the visual feedback includes an animation, where windows appear to move radially away from the center of the currently active window to respective positions that can be aligned (e.g., in a grid). In some embodiments, while the windows progressively move, their sizes grows until they take their respective positions, and the sizes of the currently active content items shrinks. Displaying the virtual region/grid in a location where the active item was located prior to entering the overview mode, provides improved visual feedback to a user and maintains the view of the three-dimensional environment organized and uncluttered.

In some embodiments, while the two or more of the plurality of content items are displayed in the virtual region and while the overview mode is activate or the fast tab switching mode is active, the location of the virtual region (e.g., grid 7045 or fast tab switcher region 7240) remains fixed. In some embodiments, once the overview mode is activated, the location of the content items (e.g., as displayed within the borders of the designated virtual region), cannot be repositioned. Maintaining the tab overview region at fixed position (e.g., the tab overview region is world locked) while displaying and/or scrolling through the content items helps a user stay focused on browsing content items while maintaining an uncluttered three-dimensional environment.

In some embodiments, a size of the virtual region is based on a number of content items displayed within the virtual region. For example, the more content items are opened the more windows are going to be displayed, and the designated window would take up more space for more windows, respectively. Increasing the size of the tab overview region commensurate with the number of open content items that are displayed in the tab overview region improves utilization of available space in the view of the three-dimensional environment.

In some embodiments, while in the overview mode, a vertical extent of the virtual region is within a same range of vertical extent values for a variety of different numbers of content items concurrently displayed within the virtual region (e.g., the vertical extent of the virtual region does not change based on a number of the plurality of content items). In some embodiments, even though the designated virtual region is extended in accordance with an increasing number of opened content items, the method for allocating virtual space for displaying the content items minimize changes in the vertical extent of the virtual region to avoid the user having to move their head up and down in order to see items in top or bottom row(s) of the grid. Increasing the size of the tab overview region commensurate with the number of open content items without increasing the vertical extent of the tab overview region improves utilization of available space in the view of the three-dimensional environment while maintaining an uncluttered view of three-dimensional environment.

In some embodiments, prior to detecting the first gesture, the computer system displays a first user interface element for selecting the first content item. For example, when in normal mode, a window grabber is displayed near the window, where a user can reach out and grab with a hand the window grab and move the window while holding onto the window grabber. In some embodiments, in response to detecting the first gesture, the computer system ceases to display the first user interface element. In some embodiments, the window grabber is hidden when the overview mode is active. Hiding a window grabber user interface element in response to activating the overview mode maintains an uncluttered view of three-dimensional environment, thereby improving user interaction with the three-dimensional environment.

In some embodiments, aspects/operations of methods 800, 900, and 1000 may be interchanged with, substituted for, and/or added to these methods. For example, reducing visual prominence of portions of the view of the three-dimensional environment that are not occupied by content items described in method 1100 can be used in the tab overview mode described in method 800 and the fast tab switching mode described in method 1000. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

1. A method comprising:
at a computer system that is in communication with a display generation component and one or more input devices:
concurrently displaying, via the display generation component, a browser toolbar, for a browser that includes a plurality of tabs and a window including first content associated with a first tab of the plurality of tabs, wherein the browser toolbar and the window are overlaying a view of a three-dimensional environment;
while displaying the browser toolbar and the window that includes the first content overlaying the view of the three-dimensional environment, detecting a first air gesture that meets first gesture criteria, the first air gesture comprising a gaze input directed at a location in the view of the three-dimensional environment that is occupied by the browser toolbar and a hand movement; and
in response to detecting the first air gesture that meets the first gesture criteria, displaying second content in the window, the second content associated with a second tab of the plurality of tabs.

2. The method of claim 1, wherein a first set of tabs are displayed prior detecting the first air gesture that meets the first gesture criteria.

3. The method of claim 1, further comprising:
while displaying the browser toolbar and the window, without displaying the plurality of tabs, detecting a first user input interacting with the browser toolbar; and
in response to detecting the first user input interacting with the browser toolbar, displaying a first set of tabs of the plurality of tabs.

4. The method of claim 3, further comprising:
in response to detecting the first user input interacting with the browser toolbar, expanding the browser toolbar, including displaying the first set of tabs in the expanded browser toolbar.

5. The method of claim 4, further comprising:
prior to detecting the first user input interacting with the browser toolbar, displaying the browser toolbar in a collapsed state at a first distance from a viewpoint of a user; and
in response to detecting the first user input interacting with the browser toolbar, displaying an expanded browser toolbar, including displaying the first set of tabs in the expanded browser toolbar, at a second distance from the viewpoint of the user, wherein:
the first distance has a respective difference in depth from the second distance;
the respective difference in depth is greater than zero; and
the first distance is greater than the second distance.

6. The method of claim 3, wherein the first user input interacting with the browser toolbar comprises a respective gaze input directed at a location in the view of the three-dimensional environment that is occupied by the browser toolbar.

7. The method of claim 3, wherein the first user input interacting with the browser toolbar comprises a respective gaze input directed to a location in the view of the three-dimensional environment that is occupied by the browser toolbar, and the method further comprises, in response to detecting the gaze input directed to the location that is occupied by the browser toolbar:
in accordance with a determination that gaze input meets a duration threshold, displaying the first set of tabs of the plurality of tabs; and
in accordance with a determination that the gaze input does not meet the duration threshold, maintaining display of the browser toolbar and the window without displaying the first set of tabs of the plurality of tabs.

8. The method of claim 3, wherein
the first user input interacting with the browser toolbar comprises a respective gaze input directed to a location in the view of the three-dimensional environment that is occupied by the browser toolbar;
and the method further comprises:
in response to detecting the respective gaze input directed to the location in the view of the three-dimensional environment that is occupied by the browser toolbar:
in accordance with a determination that a hand is in a ready state, displaying the first set of tabs of the plurality of tabs; and
in accordance with a determination that no hand is in the ready state, maintaining displaying the browser toolbar and the window without displaying the first set of tabs of the plurality of tabs.

9. The method of claim 3, wherein the first user input interacting with the browser toolbar comprises a respective gaze input and a respective hand movement selecting a control displayed in the browser toolbar.

10. The method of claim 3, further comprising:
detecting a second user input different from the first user input; and
in response to detecting the second user input, ceasing to display the first set of tabs of the plurality of tabs.

11. The method of claim 10, wherein the browser toolbar is expanded while the second user input is detected, and the method includes:
collapsing the browser toolbar in response to the second user input, including ceasing to display the first set of tabs that are displayed in the expanded browser toolbar.

12. The method of claim 10, wherein the second user input selects a tab of the first set of tabs that are displayed.

13. The method of claim 10, wherein the second user input includes transitioning a hand from a state in which the hand is engaged to a state in which the hand is no longer engaged.

14. The method of claim 10, wherein the second user input includes moving a direction of a gaze away from a location in the three-dimensional environment occupied by the browser toolbar to a location outside the browser toolbar.

15. The method of claim 3, further comprising:
while displaying the browser toolbar and the first set of tabs of the plurality of tabs, detecting a gaze input that is directed to a location outside of the browser toolbar; and
in response to detecting that the gaze input is directed to a location outside of the browser toolbar:
in accordance with a determination that the gaze input is directed at the location outside the browser toolbar for more than a predetermined amount of time, ceasing to display the first set of tabs; and
in accordance with a determination that the gaze input is directed at the location outside the browser toolbar for less than a predetermined amount of time, maintaining display of the first set of tabs.

16. The method of claim 15, further comprising:
in response to detecting that gaze input is directed to the location outside of the browser toolbar:
in accordance with a determination that the gaze input is directed at the location outside the browser toolbar for less than a predetermined amount of time and that the location outside the browser toolbar is a location within a predetermined region in the window that displays the first content or the second content, ceasing to display the first set of tabs without delay.

17. The method of claim 3, further comprising:
prior to detecting the first user input interacting with the browser toolbar, displaying the browser toolbar at a first distance from a viewpoint of a user; and
in response to detecting the first user input interacting with the browser toolbar, displaying the first set of tabs of the plurality of tabs at a second distance from the viewpoint of the user, wherein:
the first distance has a respective difference in depth from the second distance;
the respective difference in depth is greater than zero; and
the first distance is greater than the second distance.

18. The method of claim 3, wherein displaying the first set of tabs of the plurality of tabs in response to detecting the first user input interacting with the browser toolbar includes:
displaying the first set of tabs overlaying at least a portion of the window that displays the first content or the second content, wherein:
the window is displayed at a first distance from the viewpoint of a user;
the first set of tabs are displayed at a second distance from a viewpoint of the user;
the first distance has a respective difference in depth from the second distance; and
the first distance is greater than the second distance.

19. The method of claim 3, further comprising:
while displaying the first set of tabs at a first distance from a viewpoint of a user, detecting a second user input different from the first user input, the second user input including a gaze input directed at a third tab of the first set of tabs and a hand in a first state that corresponds to a ready state;
in response to detecting the second user input, displaying the third tab at a second distance from the viewpoint of the user, wherein:
the first distance is greater than the second distance, and
the first distance has a respective difference in depth from the second distance; and
while displaying the third tab at the second distance from the viewpoint of the user, detecting a third user input different from the second user input, the third user input selecting the third tab of the first set of tabs; and
in response to the third user input selecting the third tab of the first set of tabs, displaying the third tab at the first distance from the viewpoint of the user.

20. The method of claim 3, wherein the first user input interacting with the browser toolbar is detected while displaying the window including the first content or the second content at a first distance from a viewpoint of a user, and the method includes:
in response to detecting the first user input interacting with the browser toolbar, while displaying the first set of tabs, dimming the window, and moving the window in a direction away from the viewpoint of the user.

21. The method of claim 1, wherein the plurality of tabs are ordered in a sequence, and the method includes:
while the second tab is selected, detecting a second air gesture that meets second gesture criteria, the second air gesture comprising a second gaze input and a swipe gesture performed with a hand;
in response to detecting the second air gesture, scrolling through one or more tabs of the plurality of tabs in sequence, including selecting a third tab of the plurality of tabs in the sequence.

22. The method of claim 21, wherein the second gaze input or third gaze input is directed at a location in the view of the three-dimensional environment that is occupied by the browser toolbar.

23. The method of claim 21, wherein the second gaze input or third gaze input is directed at a location in the view of the three-dimensional environment that is occupied by a search field of the browser toolbar.

24. The method of claim 1, wherein the plurality of tabs are ordered in a sequence, and the method includes:
while a third tab is selected in the sequence of tabs, detecting a third air gesture that meets third gesture criteria, the third air gesture comprising a third gaze input and a swipe gesture performed with a hand;
in response to detecting the third air gesture, selecting a tab adjacent to the third tab in the sequence of the plurality of tabs.

25. The method of claim 1, wherein the plurality of tabs are ordered in a sequence, and the method includes:
while the second tab is selected, detecting a fourth air gesture that meets fourth gesture criteria, the fourth air gesture comprising a fourth gaze input and a swipe gesture performed with a hand;
in response to detecting the fourth air gesture:
in accordance with a determination that the fourth gaze input is directed at a location in the view of the three-dimensional environment that is occupied by the browser toolbar, scrolling through one or more tabs of the plurality of tabs in the sequence, including selecting a third tab of the plurality of tabs in the sequence;
in accordance with a determination that the fourth gaze input is directed at a location in the view of the three-dimensional environment that is occupied by the window that displays the second content associated with the second tab, displaying in the window a portion of the second content that was not displayed previously.

26. The method of claim 1, further comprising:
detecting a second air gesture that meets second gesture criteria, the second air gesture comprising a gaze input directed at a location in the three-dimensional environment where a third tab of the plurality of tabs is displayed, and a pinch gesture; and
in response to detecting the second air gesture that meets second gesture criteria, selecting the third tab of the plurality of tabs.

27. The method of claim 1, further comprising:
while displaying a fourth tab of the plurality of tabs at a first distance from a viewpoint of a user, detecting a second air gesture that meets third gesture criteria, the second air gesture comprising a second hand movement, including a first portion and a second portion, wherein:
the first portion corresponds to selecting the fourth tab; and
the second portion corresponds to moving the selected fourth tab to a second distance from the viewpoint of the user, wherein:
the first distance is greater than the second distance, and
the first distance has a respective difference in depth from the second distance; and
in response to detecting the second air gesture that meets the third gesture criteria, displaying a new window that includes content associated with the fourth tab of the plurality of tabs.

28. The method of claim 1, further comprising:
prior to detecting the first air gesture that meets the first gesture criteria:
displaying a representation of the first tab to a left side of the browser toolbar, and a representation of the second tab on a right side of the browser toolbar.

29. A computer-readable storage medium storing one or more programs configured to be executed by one or more processors of a computer system that is in communication with a display generation component and one or more input devices, the one or more programs including instructions for:
concurrently displaying, via the display generation component, a browser toolbar, for a browser that includes a plurality of tabs and a window including first content associated with a first tab of the plurality of tabs, wherein the browser toolbar and the window are overlaying a view of a three-dimensional environment;
while displaying the browser toolbar and the window that includes the first content overlaying the view of the three-dimensional environment, detecting a first air gesture that meets first gesture criteria, the air gesture comprising a gaze input directed at a location in the view of the three-dimensional environment that is occupied by the browser toolbar and a hand movement; and
in response to detecting the first air gesture that meets the first gesture criteria, displaying second content in the window, the second content associated with a second tab of the plurality of tabs.

30. A computer system that is in communication with a display generation component and one or more input devices, the computer system comprising:
one or more processors; and
memory storing one or more programs configured to be executed by the one or more processors, the one or more programs including instructions for:
concurrently displaying, via the display generation component, a browser toolbar, for a browser that includes a plurality of tabs and a window including first content associated with a first tab of the plurality of tabs, wherein the browser toolbar and the window are overlaying a view of a three-dimensional environment;
while displaying the browser toolbar and the window that includes the first content overlaying the view of the three-dimensional environment, detecting a first air gesture that meets first gesture criteria, the air gesture comprising a gaze input directed at a location in the view of the three-dimensional environment that is occupied by the browser toolbar and a hand movement; and
in response to detecting the first air gesture that meets the first gesture criteria, displaying second content in the window, the second content associated with a second tab of the plurality of tabs.

31-122. (canceled)
